(19) United States
(12) Patent Application Publication
(10) Pub. No.: US 2026/0256045 A1
(43) Pub. Date: Sep. 3, 2026

(54) SEED TREATMENT DISPENSERS

(71) Applicant: Indigo Ag, Inc., Charlestown, MA (US)

(72) Inventors: Jonathan GIEBEL, Acton, MA (US); Kevin CALZIA, Maynard, MA (US); Tao XU, Woburn, MA (US); Corey NIKKEL, West Des Moines, IA (US); Trudi A. BAKER, Topsfield, MA (US); Bruce CALDWELL, Columbus, OH (US); Jon MOYER, Columbus, OH (US); Jane FIFE, Columbus, OH (US); Chris KOENIG, Columbus, OH (US); Matt SELLS, Columbus, OH (US); Erika BRAUN, Columbus, OH (US); Samuel RIEKERT, Columbus, OH (US); James H. CINK, Wake Forest, NC (US)

(21) Appl. No.: 19/163,052

(22) PCT Filed: Mar. 6, 2024
(86) PCT No.: PCT/US2024/018574

§ 371 Date: Sep. 8, 2025

Related U.S. Application Data
(60) Provisional application No. 63/488,710, filed on Mar. 6, 2023.
(60) Provisional application No. 63/520,321, filed on Aug. 17, 2023.
(60) Provisional application No. 63/603,566, filed on Nov. 28, 2023.

(51) Int. Cl. A01C 1/06

(52) U.S. Cl. CPC A01C 1/06

(57) ABSTRACT

A seed treatment dispenser system is described herein. The seed treatment dispenser includes a seed treatment reservoir storing seed treatment that can be applied to seeds when or prior to planting the seeds. The seed treatment dispenser system includes an activation mechanism that, when activated, controls a release of the seed treatment from the seed treatment reservoir. The activation mechanism can be mechanical, for instance producing a release of seed treatment in response to pressure caused by seeds flowing through a seed container. The activation mechanism can be electronic, for instance controlling seed treatment release in response to detecting a movement of seeds or in response to a proximity of seeds. The activation mechanism may activate in response to a force applied or input provided by a user, for instance in response to pressure produced by the activation mechanism being applied directly to the seed treatment reservoir.

### CROSS-REFERENCE TO RELATED APPLICATIONS

This application claims priority to U.S. Provisional Application No. 63/488,710, filed on Mar. 6, 2023; U.S. Provisional Application No. 63/520,321, filed on Aug. 17, 2023; and U.S. Provisional Application No. 63/603,566, filed on Nov. 28, 2023; each of which is hereby incorporated by reference in its entirety.

### BACKGROUND

Various seed treatments are applied to agricultural seeds prior to planting; however, present processes require farmers to apply seed treatments individually at the time of planting or require treatments to be applied to seeds prior to distribution. In one example, manual application of treatments immediately before planting requires farmers to open individual seed storage containers and empty one or more buckets or bags of seed treatments into each seed storage container or seed hopper. This is a time-consuming process and requires the farmer to carefully track which treatments have been applied to which seed storage bin. In the example of where treatments are applied to seeds prior to distribution, the treated seeds may be stored for many months or years in environments with variable temperature and humidity. Many seed treatments lose efficacy over prolonged storage periods. Additionally, market conditions and regional environmental conditions vary from one growing season to the next, such that the combinations of seed and seed treatments may no longer be optimal for conditions at the time of planting. The seed treatment dispensers described herein enable one or more seed treatments to be stably stored with seed storage containers for extended periods of time.

### BRIEF DESCRIPTION OF THE DRAWINGS

FIG. 1A is a vertical sectional view of the front of a seed storage container configured to dispense seeds, showing an exemplary center mounted seed treatment dispenser having a manual activation system. The front side is the side of the seed storage container from which the slide gate is activated.

FIG. 1B is a vertical sectional view of the side of a seed storage container configured to dispense seeds, showing an exemplary center mounted seed treatment dispenser having a manual activation system.

FIG. 1C is a vertical sectional view of a seed storage container configured for transportation of the empty seed storage container, showing an exemplary center mounted seed treatment dispenser having a manual activation system.

FIG. 1D is a fragmentary perspective view of an exemplary center mounted seed treatment dispenser centrally mounted in a seed storage container configured to dispense seeds.

FIG. 2A is a top vertical sectional view of the side of a seed storage container configured to dispense seeds, showing an exemplary center mounted seed treatment dispenser having an automatic activation system, wherein the treatment dispenser has not been activated.

FIG. 2B is a vertical sectional view of the front of a seed storage container configured to dispense seeds, showing an exemplary center mounted seed treatment dispenser having an automatic activation system, wherein the treatment dispenser has been activated.

FIG. 2C is a vertical sectional view of the side of a seed storage container configured to dispense seeds, showing an exemplary center mounted seed treatment.

FIG. 2D is a vertical sectional view of the side of a seed storage container configured to dispense seeds, showing an exemplary center mounted seed treatment.

FIG. 2E is a bottom perspective view of an exemplary center mounted seed treatment dispenser having an automatic activation system, wherein the treatment dispenser has been activated.

FIG. 2F is a fragmentary perspective view of an exemplary center mounted seed treatment dispenser centrally mounted in a seed storage container configured to dispense seeds, wherein the treatment dispenser has not been activated.

FIG. 2G is a vertical sectional view of the front of a seed storage container configured to dispense seeds, showing an exemplary center mounted seed treatment dispenser having an automatic activation system, wherein the treatment dispenser has not been activated.

FIG. 2H is a vertical section of an exemplary seed treatment dispenser having an automatic activation system, wherein the treatment dispenser has not been activated.

FIG. 2I shows a vertical cross-sectional view of a plunger unit for a seed treatment dispenser.

FIG. 2J shows a vertical cross-sectional view of an exemplary seed treatment dispenser having a lid to a seed treatment reservoir that is not integral to the activation mechanism.

FIG. 2K shows a vertical cross-sectional view of an exemplary seed treatment dispenser wherein an exterior surface of a plunger unit forms an exterior surface of a seed treatment dispenser.

FIG. 2L shows a vertical cross-sectional view of an exemplary seed treatment dispenser having a lid to a seed treatment reservoir that is integral to the activation mechanism; in this view the seed treatment dispenser has not been activated.

FIG. 2M shows a vertical cross-sectional view of an exemplary seed treatment dispenser having a lid to a seed treatment reservoir that is integral to the activation mechanism; in this view the seed treatment dispenser has been activated.

FIG. 2N shows a vertical cross-sectional view of an exemplary seed treatment dispenser having a tether; in this view the seed treatment dispenser has been activated.

FIG. 2O shows a vertical cross-sectional view of an exemplary seed treatment dispenser having a lid to a seed treatment reservoir that is not integral to the activation mechanism, and a handle. In this view the seed treatment dispenser has not been activated.

FIG. 2P shows a vertical cross-sectional view of an exemplary seed treatment dispenser having a lid to a seed treatment reservoir that is not integral to the activation mechanism, and a handle. In this view the seed treatment dispenser has been activated.

FIG. 2Q shows a vertical cross-sectional view of an exemplary seed treatment dispenser having a lid to a seed treatment reservoir that is integral to the activation mechanism, a handle, and a tether. In this view the seed treatment dispenser has not been activated.

FIG. 2R shows a vertical cross-sectional view of an exemplary seed treatment dispenser having a lid to a seed treatment reservoir that is integral to the activation mechanism, and a handle. In this view the seed treatment dispenser has been activated.

FIG. 2S shows a vertical cross-sectional view of an exemplary seed treatment dispenser having a lid to a seed treatment reservoir that is integral to the activation mechanism, and a handle connected to a seal and to the activation mechanism. In this view the seed treatment dispenser has not been activated.

FIG. 2T shows a vertical cross-sectional view of the exemplary seed treatment dispenser of FIG. 2S in an activated state.

FIG. 2U shows a vertical cross-sectional view of an exemplary seed treatment dispenser having a lid to a seed treatment reservoir that is integral to the activation mechanism, and a handle connected to a plurality of seals and to the activation mechanism. In this view the seed treatment dispenser has not been activated.

FIG. 2V shows a vertical cross-sectional view of an exemplary seed treatment dispenser having a lid to a seed treatment reservoir that is integral to the activation mechanism, and a handle connected to the activation mechanism is also connected to a plurality of seals sloping downward towards the lid covering the opening through which a seed treatment is dispensed. In this view the seed treatment dispenser has been activated.

FIG. 2W shows a vertical cross-sectional view of an exemplary seed treatment dispenser having a lid to a seed treatment reservoir that is integral to the activation mechanism, as well as a handle connected by a tether to the activation mechanism.

FIG. 2X shows a horizontal cross-sectional view of a horizontal cross section of an exemplary rod of a centrally located handle attached to vertically orient seals.

FIG. 2Y shows a horizontal cross-sectional view of an exemplary seed treatment dispenser having a hollow tube shape.

FIG. 2Z shows a horizontal cross-sectional view of an exemplary rod of a centrally located handle attached to vertically orient seals wherein the rod and seals are located within a tube-shaped treatment dispenser to create four seed treatment reservoirs.

FIG. 3A is a vertical sectional view of the front of a seed storage container configured to dispense seeds, showing an exemplary center mounted seed treatment dispenser.

FIG. 3B is a vertical sectional view of the side of a seed storage container configured to dispense seeds from the center of the storage container, showing an exemplary center mounted seed treatment dispenser having a manual activation system, wherein the treatment dispenser has been activated.

FIG. 3C is a vertical sectional view of the side of a seed storage container configured to dispense seeds from the top of the storage container, showing an exemplary center mounted seed treatment dispenser having a manual activation system, wherein the treatment dispenser has been activated.

FIG. 4A is a vertical sectional view of the side of a seed storage container configured to dispense seeds, showing an exemplary spherical center mounted seed treatment dispenser having an automatic activation system, wherein the treatment dispenser has not been activated.

FIG. 4B is a vertical sectional view of the front of a seed storage container configured to dispense seeds, showing an exemplary spherical center mounted seed treatment dispenser having an automatic activation system, wherein the treatment dispenser has not been activated.

FIG. 4C is a fragmentary perspective view of a seed treatment dispenser having a spherical automatic activation system, wherein the treatment dispenser has not been activated.

FIG. 4D is a vertical sectional view of the side of a seed storage container configured to dispense seeds, showing an exemplary center mounted seed treatment dispenser with sloped upper surfaces, having an automatic activation system, wherein the treatment dispenser has not been activated.

FIG. 4E is a vertical sectional view of the front of a seed storage container configured to dispense seeds, showing an exemplary center mounted seed treatment dispenser with sloped upper surfaces, having an automatic activation system, wherein the treatment dispenser has not been activated.

FIG. 4F is a fragmentary perspective view of a seed treatment dispenser with sloped upper surfaces, having an automatic activation system, wherein the treatment dispenser has not been activated.

FIG. 5A is a vertical sectional view of the front of a seed storage container configured to dispense seeds having manual activation systems, showing exemplary side mounted seed treatment dispensers.

FIG. 5B is a vertical sectional view of the side of a seed storage container configured to dispense seeds having manual activation systems, showing exemplary side mounted seed treatment dispensers.

FIG. 5C is a top perspective sectional view of a seed storage container configured to dispense seeds having a manual activation system, showing exemplary side mounted seed treatment dispensers.

FIG. 5D is a cross sectional view of a seed storage container configured to dispense seeds having a manual activation system, showing exemplary side mounted seed treatment dispensers.

FIG. 6A is a vertical sectional view of the front of a seed storage container configured to store and dispense seeds having a manual activation system, showing exemplary tubal top mounted seed storage and treatment dispensers.

FIG. 6B is a vertical sectional view of the side of a seed storage container configured to store and dispense seeds having a manual activation system, showing exemplary tubal top mounted seed storage and treatment dispensers.

FIG. 6C is a cross sectional view of a seed storage container configured to store and dispense seeds having a manual activation system, showing exemplary tubal top mounted seed storage and treatment dispensers.

FIG. 6D is a vertical sectional view of the front of a seed storage container configured to store and dispense seeds having a manual activation system, showing exemplary tubal center mounted seed storage and treatment dispensers.

FIG. 6E is a vertical sectional view of the side of a seed storage container configured to store and dispense seeds having a manual activation system, showing exemplary tubal center mounted seed storage and treatment dispensers.

FIG. 6F is a cross sectional view of a seed storage container configured to store and dispense seeds having a manual activation system, showing exemplary tubal center mounted seed storage and treatment dispensers.

FIG. 7A is a vertical sectional view of a seed storage container configured to dispense seeds, showing exemplary seed treatment dispensers.

FIG. 7B is a top/bottom perspective view of a seed storage container configured to dispense seeds, showing exemplary seed treatment dispensers.

FIG. 7C is a fragmentary top/bottom perspective view of a seed storage container configured to dispense seeds, showing exemplary seed treatment dispensers.

FIG. 8A is a vertical sectional view of a seed storage container configured to dispense seeds showing an exemplary center, bottom-mounted seed treatment dispenser.

FIG. 8B is a bottom perspective view of a seed storage container configured to dispense seeds showing an exemplary bottom-mounted exemplary seed treatment dispenser.

FIG. 8C is a bottom perspective view of an exemplary bottom-mounted seed treatment dispenser mounted having an automatic activation system that is attached to a seed storage container and has been partially activated by the opening of the slide gate.

FIG. 8D is a vertical perspective view of an exemplary seed treatment dispenser having an automatic activation system that has been activated with seed flowing through it.

FIG. 9A is a vertical sectional view of a seed storage container configured to dispense seeds, an exemplary seed treatment dispenser.

FIG. 9B is a bottom perspective view of a seed storage container configured to dispense seeds showing an exemplary bottom-mounted seed treatment dispenser having an automatic activation system.

FIG. 9C is a bottom perspective view of an exemplary bottom-mounted seed treatment dispenser with rolling dispensers that is mounted to a seed storage container that has been activated by the opening of the slide gate.

FIG. 9D is a vertical perspective view of an exemplary seed treatment dispenser having an automatic activation system with rolling dispensers that has been activated with seed flowing through it.

FIG. 10A is a vertical sectional view of a seed storage container dispensing seeds into an external seed treatment dispenser below it having an automatic activation system.

FIG. 10B is a top perspective angle view of an exemplary seed treatment dispenser having an automatic activation system that is external to the seed storage container, that has been activated by seed flowing through it.

FIG. 11A is an angled vertical sectional view of the side of a seed storage container configured to dispense seeds, showing an exemplary top mounted seed treatment dispenser having an automatic activation system wherein the treatment dispenser has not been activated.

FIG. 11B is an angled vertical sectional view of the side of a seed storage container configured to dispense seeds, showing an exemplary top mounted seed treatment dispenser having an automatic activation system wherein the treatment dispenser has been activated.

FIG. 12A is an angled vertical sectional view of the partial side of a seed storage container configured to dispense seeds, showing an exemplary mounted seed treatment dispenser having an automatic activation system wherein the treatment dispenser has not been activated.

FIG. 12B is an angled vertical sectional view of the partial side of a seed storage container configured to dispense seeds, showing an exemplary mounted seed treatment dispenser having an automatic activation system wherein the treatment dispenser has been activated.

FIG. 12C is an angled vertical sectional view of the partial side of a seed storage container configured to dispense seeds, showing an exemplary mounted seed treatment dispenser having an automatic activation system wherein the treatment dispenser has been activated.

FIG. 12D is an angled top, vertical sectional view of the partial side of a seed storage container configured to dispense seeds, showing an exemplary top mounted seed treatment dispenser having an automatic activation system wherein the treatment dispenser has not been activated.

FIG. 13A is an angled vertical sectional partial view of the side of a seed storage container configured to dispense seeds, showing an exemplary side mounted, seed treatment dispenser having an automatic activation system wherein the treatment dispenser has not been activated.

FIG. 13B is an angled view of an exemplary side mounted, seed treatment dispenser having an automatic activation system wherein the treatment dispenser has been activated.

FIG. 14A is an angled vertical sectional partial view of the side of a seed storage container configured to dispense seeds, showing an exemplary top mounted seed treatment dispenser having an automatic activation system wherein the treatment dispenser has been partially activated.

FIG. 14B is an angled vertical sectional partial view of the side of a seed storage container configured to dispense seeds, showing an exemplary top mounted seed treatment dispenser having an automatic activation system wherein the treatment dispenser has been partially activated.

FIG. 15 shows an example in which a seed treatment dispenser may have both a manual and an automatic activation mechanism, as shown by the manual activation pull cord 202 connected to handle 203, and automatic activation mechanism 211. In some embodiments, the manual or automatic activation mechanism pulls on a cord wrapped around a cartridge causing the seed treatment reservoir to spin (e.g., similar to a top or salad spinner) propelling the seed treatment across the seed surface.

FIG. 16A is a vertical sectional view of the side of a seed storage container configured to dispense seeds, showing an exemplary center mounted seed treatment dispenser having a two-stage automatic activation system wherein the treatment dispenser has not been activated.

FIG. 16B is a vertical sectional partial view of the side of a seed storage container configured to dispense seeds, showing an exemplary center mounted seed treatment dispenser having a two-stage automatic activation system wherein the treatment dispenser has not been activated.

FIG. 17A is a bottom sectional perspective view of a seed storage container configured to dispense seeds showing an exemplary bottom-mounted seed treatment dispenser having an automatic activation system that has been activated.

FIG. 17B is a vertical sectional view of an exemplary bottom-mounted seed treatment dispenser having an automatic activation system that has been activated.

FIG. 17C is a bottom sectional perspective view of the side of a seed storage container configured to dispense seeds showing an exemplary bottom-mounted seed treatment dispenser having an automatic activation system that has been activated by opening of the slide gate of the seed storage container.

FIG. 18A is a side perspective view of an exemplary bottom-mounted seed treatment dispenser having an automatic activation system that has been activated by fully opening the slide gate of the seed storage container.

FIG. 18B is a side perspective view of an exemplary bottom-mounted seed treatment dispenser having an automatic activation system that has not been activated as the slide gate of the seed storage container is only partially open.

FIG. 19A is a vertical sectional view of the side of a seed storage container configured to dispense seeds showing an exemplary bottom-mounted seed treatment dispenser having an automatic activation system that has not been activated as the slide gate of the seed storage container is closed.

FIG. 19B is a vertical sectional view of the side of a seed storage container configured to dispense seeds showing an exemplary bottom-mounted seed treatment dispenser having an automatic activation system that has been activated as the slide gate of the seed storage container is open.

FIG. 20A is a bottom sectional perspective view of a seed storage container configured to dispense seeds showing an exemplary bottom-mounted seed treatment dispenser with rolling dispensers having an automatic activation system.

FIG. 20B is a top perspective view of an exemplary bottom-mounted seed treatment dispenser having an automatic activation system with rolling dispensers.

FIG. 21A is a vertical angled, sectional view of the side of a seed storage container configured to dispense seeds showing an exemplary side-mounted seed treatment dispenser having an automatic activation system with a connector to the slide gate that has not been activated as the slide gate of the seed storage container is closed.

FIG. 21B is a vertical sectional view of the side of a seed storage container configured to dispense seeds showing an exemplary side-mounted seed treatment dispenser having an automatic activation system with a connector to the slide gate that has not been activated as the slide gate of the seed storage container is closed.

FIG. 22A is a side angle view of an exemplary side-mounted seed treatment dispenser.

FIG. 22B is a vertical sectional view of the individual components of an exemplary side-mounted seed treatment dispenser with the individual components of the activation arm, seed treatment reservoir, outer housing container with safety clip and the activator.

FIG. 23A is a top view of a side mounted seed treatment dispenser.

FIG. 23B is a cross-sectional side view of an exemplary side mounted seed treatment dispenser showing the sharp edge teeth to cut the foil of the inner container.

FIG. 23C is a side view of an exemplary side-mounted seed treatment dispenser.

FIG. 23D is a back view of an exemplary side-mounted seed treatment dispenser.

FIG. 24 is a is a cross-sectional side view of an exemplary side mounted seed treatment dispenser.

FIG. 25 is a is a cross-sectional side view of an exemplary side mounted seed treatment dispenser that can also be mounted on a corner of two sides.

FIG. 26A is a top view of an exemplary corner mounted seed treatment dispenser.

FIG. 26B is a top angle view of an exemplary corner mounted seed treatment dispenser.

FIG. 26C is a side view of an exemplary corner mounted seed treatment dispenser.

FIG. 26D is a side view of an exemplary corner mounted seed treatment dispenser.

FIG. 26E is a top angle view of a sharp edge designed to cut the material of the inner container.

FIG. 27A is an angled side view of an exemplary center mounted seed treatment dispenser and its activator.

FIG. 27B is an angled side view of the individual components of an exemplary center mounted seed treatment dispenser of the activation cap, seed treatment reservoir, and outer housing container with hanger.

FIG. 28 is a cross-sectional side view of an exemplary center mounted seed treatment dispenser showing the sharp edge teeth to cut the material of the seed treatment dispenser, with the activator below it.

FIG. 29A is a top view of an exemplary center mounted seed treatment dispenser.

FIG. 29B is a side view of an exemplary center mounted seed treatment dispenser.

FIG. 29C is a different side view of an exemplary center mounted seed treatment dispenser showing the safety clip.

FIG. 30A is an angled top view of an exemplary center mounted seed treatment dispenser.

FIG. 30B is an angled side view of the individual components of an exemplary center mounted seed treatment dispenser of the activation cap, the seed treatment reservoir, safety clip and outer container with hanger.

FIG. 31A is a top view of an exemplary center mounted seed treatment dispenser.

FIG. 31B is a side view of an exemplary center mounted seed treatment dispenser showing the safety clip.

FIG. 31C is a cross sectional side view of an exemplary center mounted seed treatment dispenser, showing the sharp edge to cut the material of the inner container.

FIG. 31D is a different side view of an exemplary center mounted seed treatment dispenser.

FIG. 32 is a cross-sectional side view of an exemplary center mounted seed treatment dispenser showing the safety clip.

FIG. 33 is a vertical sectional view of the individual components of an exemplary center-mounted seed treatment dispenser with the individual components of the activation arm, seed treatment reservoir, outer housing container with safety clip and the activator.

FIG. 34A is a top angled perspective view of an exemplary bottom mounted seed treatment dispenser.

FIG. 34B is a top sectional perspective view of the individual components of an exemplary bottom mounted seed treatment dispenser showing the seed treatment reservoir, the frame and the activator.

FIG. 35A is showing an angled cross-sectional perspective view of an exemplary bottom mounted seed treatment dispenser.

FIG. 35B is showing a top angled sectional perspective view of the individual components of an exemplary bottom mounted seed treatment dispenser.

FIG. 36 is showing exemplary results comparing the distribution on seeds of microbial products dispersed from various seed treatment dispensers to manual application consisting of evenly sprinkling flowable powder on top of a seed storage container full of seed. Seed treatment dispensers tested included a mid-mounted dispenser secured to the center support structure of the seed storage container (“Middle”), a top-mounted dispenser located at the top of the seed storage container mounted in a corner (“Top corner”), a top-mounted dispenser located at the top of the seed storage container mounted in the middle of a long side of the container (“Top long side”), a top-mounted dispenser located at the top of the seed storage container mounted in the middle of a short side of the container (“Top short side”), two top-mounted dispensers one located at the top of the seed storage container mounted in the middle of a short side of the container and one mounted in the middle of the long side of the container and concurrent manual application of evenly sprinkling flowable powder on top of a seed storage container full of seed (“Trifecta”). An additional manual method was tested consisting of evenly sprinkling of the flowable powder on top of seed at three time points during filing of the seed storage container-after the seed storage container was filled one third full of seed, two-thirds full of seed, and on top of the seed storage container full of seed (“Parfait”). Different transfer methods were tested-samples were collected as seed was dispensed from the application seed storage container (“T1”), samples were collected from a second seed storage container into which the application seed storage container was dispensed (“T2”), samples were collected from the auger of a bulk tender into which the application seed storage container was dispensed (“T3”), samples were collected from the auger of a box tender into which the application seed storage container was dispensed (“T4”). The “application seed storage container” refers to the seed storage container into which the seed treatment is first dispensed.

FIG. 37 is showing exemplary results comparing the distribution on seeds of microbial products dispersed from various seed treatment dispensers to manual application consisting of evenly sprinkling flowable powder on top of a seed storage container full of seed. Seed treatment dispensers tested included a 1 inch diameter tubular container mounted along the slanted bottom of the seed storage container (“Bottom”), a top-mounted dispenser located at the top of the seed storage container mounted in a corner manually activated by a long string (“Top corner long string”) or a short string (“Top corner short string”), a top-mounted dispenser located at the top of the seed storage container mounted in the middle of a short side of the container manually activated by a long string (“Top short side long string”) or a short string (“Top short side short string”). Different transfer methods were tested-samples were collected as seed was dispensed from the application seed storage container (“T1”), samples were collected from a second seed storage container into which the application seed storage container was dispensed (“T2”), samples were collected from the auger of a bulk tender into which the application seed storage container was dispensed (“T3”), samples were collected from the auger of a box tender into which the application seed storage container was dispensed (“T4”). The “application seed storage container” refers to the seed storage container into which the seed treatment is first dispensed.

FIG. 38 is a cross sectional side view of an exemplary top mounted seed treatment dispenser showing a removable seed treatment reservoir installed over a sharp edge for piercing the seal covering the opening in the seed treatment reservoir through which seed treatment is dispensed.

FIG. 39A is a cross sectional side view of an exemplary top mounted seed treatment dispenser showing a removable seed treatment reservoir installed and a foldable activation arm shown in an extended state. In this figure the seed treatment dispenser also has a lid covering the opening of the seed treatment dispenser through which seed treatment is dispensed; the cover is shown in the closed position.

FIG. 39B is a cross sectional side view of an exemplary top mounted seed treatment dispenser showing a removable seed treatment reservoir installed and a foldable activation arm shown in an extended state. In this figure the seed treatment dispenser also has a lid covering the opening of the seed treatment dispenser through which seed treatment is dispensed; the cover is shown in the open position. In this figure the mechanism for activation of the lid covering the opening of the seed treatment dispenser through which seed treatment is dispensed is also shown.

FIG. 40A is a cross sectional side view of an exemplary top mounted seed treatment dispenser showing a removable seed treatment reservoir installed and a foldable activation arm shown in an extended state. In this figure the seed treatment dispenser is shown attached to a seed storage container with a lid.

FIG. 40B is a cross sectional side view of an exemplary top mounted seed treatment dispenser showing a removable seed treatment reservoir installed and a foldable activation arm shown in the extended state. In this figure the seed treatment dispenser also has a lid covering the opening of the seed treatment dispenser through which seed treatment is dispensed; the cover is shown in the open position. In this figure the mechanism for activation of the lid covering the opening of the seed treatment dispenser through which seed treatment is dispensed is also shown.

FIG. 41 shows an angled top view of a seed treatment dispenser and fastener, where the fastener is attached to a foldable activation arm shown in a folded state suitable for storage or shipment.

FIG. 42A shows a partial sectional view of a seed treatment dispenser showing a detailed view of a mechanism for activation of a lid covering the opening of the seed treatment dispenser through which seed treatment is dispensed. In this view, the seed treatment dispenser shows compressed springs and spring plate.

FIG. 42B shows a partial sectional view of a seed treatment dispenser showing a detailed view of the seed treatment dispenser and fastener installed in a seed storage container with lid. In this view, the seed treatment dispenser contains a seed treatment reservoir.

FIG. 43 shows a side view of a seed treatment dispenser, comprising an optional cover for the low side wall of the seed treatment dispenser.

FIG. 44 shows a side view of a seed treatment dispenser, comprising an optional cover for the low side wall of the seed treatment dispenser, and an activation mechanism comprising an activation arm attached to an anchor.

FIG. 45A shows an angled top view of a seed treatment dispenser wherein the inner wall of the seed treatment dispenser comprises an optional integrated catch.

FIG. 45B shows an enlarged side view of a section of wall of a seed treatment dispenser comprising an optional integrated catch.

FIG. 46A shows a top view of a seed treatment dispenser configured for use with a removable seed treatment reservoir, shown in an activated position without the seed treatment reservoir. This figure shows a seed treatment dispenser having two optional integrated catches on the inner walls.

FIG. 46B shows an enlarged top view of a seed treatment dispenser configured for use with a removable seed treatment reservoir, shown without the seed treatment reservoir installed. This figure shows an example of a seed treatment dispenser having curved walls wherein the curved walls create a channel fitting the corresponding shape of the corner of a spring plate upon which the removeable seed treatment reservoir may be placed. In this example the outer edge of the corner of a spring plate is raised creating a barrier to prevent an installed removeable seed treatment reservoir from sliding out of alignment.

FIG. 47A shows a side view of the outer surface of a seed treatment reservoir.

FIG. 47B shows an angled top side view of a seed treatment reservoir.

### DETAILED DESCRIPTION

As used herein, the term “exemplary” is used in the sense of “example,” rather than “ideal.” Moreover, the terms “a” and “an” herein do not denote a limitation of quantity, but rather denote the presence of one or more of the referenced items.

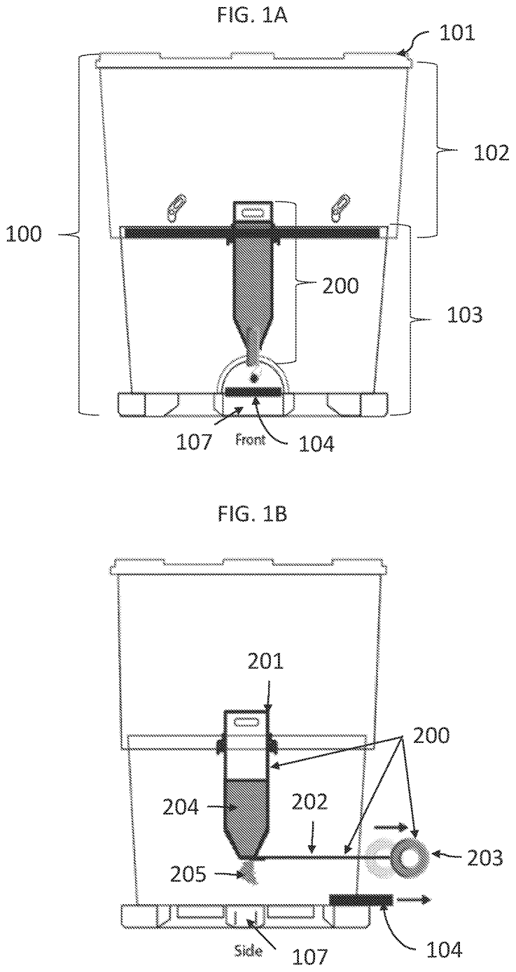

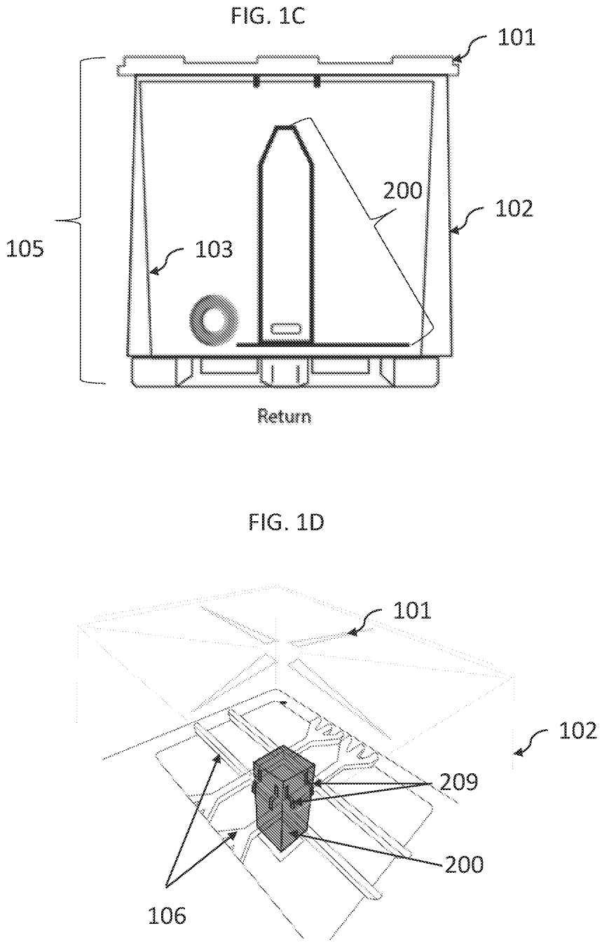

Turing now to the drawings, a seed storage container configured to dispense seeds 100 is illustrated in FIG. 1A. The seed storage container includes a lid 101, a removeable upper segment 102, and a lower base segment 103 comprising a slide gate 104 covering the opening through which seed is dispensed 107 when the slide gate is in the open, fully extended, position. Also displayed in FIG. 1A is a novel seed treatment dispenser 200.

FIG. 1B shows further details of the seed treatment dispenser 200 shown in FIG. 1A. The seed treatment dispenser 200 is an exemplary center mounted seed treatment dispenser having a manual activation system. The seed treatment dispenser 200 comprises a seed treatment reservoir 201, a manual activation pull cord, rod, or slide 202, and a manual activation pull handle 203. The seed treatment reservoir is filled with a seed treatment to dispense 204. In some embodiments, the seed treatment is a liquid or a solid (for example, a powder, granule, particulate, or pellet). A seed treatment is any composition, liquid or flowable solid, that is desired to be added to seed prior to planting. Non-limiting examples of seed treatments include fertilizers, micronutrients, seed lubricants, insecticides, fungicides, herbicides, enzymes, flowability enhancers, biostimulant, living biological treatments, or non-living biological treatments such as a metabolite or by-product of a biological organism (e.g. a growth medium, such as a fermentation broth). In some embodiments, a seed treatment reservoir is divided into one or more compartments each containing one or more seed treatment or activation indicator. In some embodiments, an activation indicator is a composition capable of detection on the seed dispensed from the seed storage container, for example a colored compound. In some embodiments, the activation indicator is loaded into the seed treatment reservoir such that the activation indicator is dispensed concurrently with one or more seed treatment. In some embodiments, the activation indicator is loaded into the seed treatment reservoir such that the activation indicator is dispensed after one or more seed treatment, such that detection of the activation indicator on the dispensed seed verifies that all the one or more seed treatments have been dispensed. FIG. 1B also illustrates the slide gate 104 in the fully open position suitable for dispensing seeds from the seed storage container through the opening 107.

In some embodiments, the volume of the seed treatment reservoir is 18 cubic feet or less, for example: less than 3 cubic feet, between 0.001 cubic feet and 18 cubic feet, between 3 cubic feet and 0.01 cubic feet, between 2-3 cubic feet, between 2-1 cubic feet, between 1-0.5 cubic feet, between 0.5-0.05 cubic feet, between 0.05-0.01 cubic feet, etc. In some embodiments, the volume of the seed treatment reservoir is at least 5 volumetric ounces, between 10-300 volumetric ounces, between 10-25 volumetric ounces, between 15-30 volumetric ounces, at least 20 volumetric ounces, between 15-30 volumetric ounces, between 30-50 volumetric ounces, between 30-80 volumetric ounces, at least 50 volumetric ounces, between 45-75 volumetric ounces, at least 70 volumetric ounces, between 80-200 volumetric ounces, at least 100 volumetric ounces, between 10-200 volumetric ounces, or at least 200 ounces. In some embodiments, the seed treatment reservoir is divided into one or more compartments, wherein the one or more compartments are capable of holding at least the equivalent of 10 volumetric ounces of seed treatment or activation indicator.

A seed treatment dispenser can be constructed out of a number of materials or combination of materials. Walls of a seed treatment dispenser and lids may be constructed out of plastic, metal, or nylon or other durable materials. For example, activation mechanisms including activation arms may be constructed out of metal (e.g. steel or aluminum) or structural foam. Fasteners may be constructed out of plastic, metal (for example steel, optionally powder coated, for applications where strong, thin material is required), or nylon or other durable materials. Cutting edges may be constructed out a material capable of holding a cutting edge, for example, metal or polycarbonate. Push plates, alternately referred to as spring plates, may be made out of a rigid material such as metal, acetal plastic, nylon or other rigid materials.

A seed treatment reservoir can be constructed out of a number of materials suitable for storing a liquid or solid (e.g., powder) seed treatment. A seed treatment may be directly in contact with the seed treatment reservoir, or a seed treatment may be located within a secondary container (such as a metallized polyester and linear low density polyethylene bag) within the seed treatment reservoir. A seed treatment reservoir may be constructed from a pliable or rigid material. A seed treatment reservoir may be integral to a seed treatment dispenser, or a seed treatment reservoir may be removable from a seed treatment dispenser. In some embodiments, the seed treatment dispenser is reusable. In some embodiments, a reusable seed treatment dispenser comprises a reusable seed treatment reservoir (for example, a reusable seed treatment reservoir integral to the seed treatment dispenser, or a reusable and removeable seed treatment reservoir).

In some embodiments, seed treatment reservoirs comprise a moisture barrier, reduced gas exchange (for example, oxygen transmission), block (partially or fully) UV and light transmission, are impact resistant, and/or tear resistant. In some embodiments, a seed treatment reservoir comprises at least one exterior surface between 0.025-10 mm in thickness. In some embodiments, a seed treatment reservoir comprises an exterior surface having an average thickness of between 0.025-10 mm. In some embodiments, a seed treatment reservoir comprises an exterior surface having a nearly uniform thickness (e.g. variation in thickness of plus or minus 5 mm or less, variation in thickness of plus or minus 1 mm or less, variation in thickness of plus or minus 0.5 mm or less, variation in thickness of plus or minus 0.05 mm or less, variation in thickness of plus or minus 0.5 mm or less, variation in thickness of plus or minus 0.05 mm or less, variation in thickness of plus or minus 0.005 mm or less, variation in thickness of plus or minus 0.001 mm or less). In some embodiments, a seed treatment reservoir comprises an exterior surface having a nearly uniform thickness except for one or more support regions comprising thicker or more rigid material (where the material of the support region may be the same or different from the material comprising the remainder of the walls). In some embodiments, a seed treatment reservoir comprises an exterior surface having a nearly uniform thickness except for one or more regions having one or more significantly thinner region, for example engineered to break when force is applied.

In some designs the walls of the seed treatment reservoir are optimally of sufficient rigidity as to not buckle when activated, for example where a seed treatment reservoir is activated by application of force to a surface opposite from an opening through which the seed treatment is dispensed that pushes the opening against a cutting edge and the seed treatment is dispensed by gravity. In some embodiments a wall of a seed treatment reservoir designed to resist deformation (e.g. compression or buckling) are 1-2 mm or 1.5-1.8 mm in thickness. In some designs the walls of the seed treatment reservoir are optimally of flexible and will deform (e.g. compress or buckle) when activated, for example where a seed treatment reservoir is activated by application of force to a surface opposite from an opening through which the seed treatment is dispensed that pushes the opening against a cutting edge and the seed treatment is dispensed the collapse of the walls of the seed treatment reservoir pushing the seed treatment. In some embodiments, designs where the collapse of the seed treatment reservoir aids release of the seed treatment the interior dimensions of the seed treatment reservoir increase along the dimension of the seed treatment reservoir from the surface of the seed treatment reservoir to which force is applied and the opening through which the seed treatment is dispensed.

In some embodiments, the seed treatment reservoir comprises one or more polyesters, polyethylene (for example, high density polyethylene (HDPE), polystyrene, polyamides (nylon), polyacrylonitrile butadiene (ABS), polylactic acid, aluminum (e.g., foils or sheet), stainless steel, silicone, polylactic acid (PLA), bio-composite (for example, bio-composites comprising polylactic acid and microcrystalline cellulose, polylactic acid and cellulose nanocrystal, gelatin, etc.), and combinations thereof. In some embodiments, the seed treatment reservoir comprises one or more layers, for example an adhesive laminated material having high oxygen and moisture barrier properties. Examples of the seed treatment reservoir comprising multiple layers include metallized polyester and linear low-density polyethylene, polyester, aluminum foil, and linear low-density polyethylene.

In some embodiments, the seed treatment reservoir acts as a moisture barrier having a moisture vapor transmission rate (MVTR) of 0.2 g per 100 sq. inches per 24 hours, or lower. In some embodiments, the seed treatment reservoir is constructed from a material having a moisture vapor transmission rate (MVTR) 0.2 g per 100 sq. inches per 24 hours, or lower. In some embodiments, the seed treatment reservoir acts as a moisture barrier having a moisture vapor transmission rate (MVTR) of 0.02 g per 100 sq. inches per 24 hours, or lower. In some embodiments, the seed treatment reservoir is constructed from a material having a moisture vapor transmission rate (MVTR) 0.02 g per 100 sq. inches per 24 hours, or lower. In some embodiments, the seed treatment reservoir has a moisture vapor transmission rate (MVTR) of between 0.002 g per 100 sq. inches per 24 hours and 0.2 g per 100 sq. inches per 24 hours. In some embodiments, the seed treatment reservoir is constructed from a material having a moisture vapor transmission rate (MVTR) of between 0.002 g per 100 sq. inches per 24 hours and 0.2 g per 100 sq. inches per 24 hours.

In some embodiments, the seed treatment reservoir has an oxygen transmission rate (OTR) of between 0.0001-1 cubic centimeters per 100 sq. inches per 24 hours. In some embodiments, the seed treatment reservoir is constructed from a material having an oxygen transmission rate of between 0.0001-1 cubic centimeters per 100 sq. inches per 24 hours. In some embodiments, the seed treatment reservoir has an oxygen transmission rate (OTR) of between 0.0005-0.06 cubic centimeters per 100 sq. inches per 24 hours. In some embodiments, the seed treatment reservoir is constructed from a material having an oxygen transmission rate of between 0.0005-0.06 cubic centimeters per 100 sq. inches per 24 hours. In some embodiments, the seed treatment reservoir has an oxygen transmission rate (OTR) of 0.06 cubic centimeters per 100 sq. inches per 24 hours, or lower. In some embodiments, the seed treatment reservoir is constructed from a material having an oxygen transmission rate of 0.06 cubic centimeters per 100 sq. inches per 24 hours, or lower. In some embodiments, the seed treatment reservoir has an oxygen transmission rate (OTR) of less than 0.001 cubic centimeters per 100 sq. inches per 24 hours. In some embodiments, the seed treatment reservoir is constructed from a material having an oxygen transmission rate of less than 0.001 cubic centimeters per 100 sq. inches per 24 hours. OTR values described herein are measured at 65% relative humidity and 20 degrees Celsius.

An empty seed storage container configured for transportation or storage 105 is shown in FIG. 1C. When an empty seed storage container is configured for transportation or storage the removable upper segment 102 of the seed storage container is inverted relative to its position when the seed storage container is configured to dispense seeds, and the removable upper segment 102 of the seed storage container is positioned over the base segment 103 of the seed storage container, the lid 101 is positioned over the inverted upper segment 102 of the seed storage container. FIG. 1C shows an example of how the empty seed treatment dispenser 200 can be stored within the empty seed storage container configured for transportation or storage.

FIG. 1D shows a perspective view of the interior of a seed storage container configured to dispense seeds. This interior view shows the lid 101, and a segment of the walls of the removable upper segment of the seed storage container 102, and the interior central support structure 106, and a seed treatment dispenser 200 positioned at the center of the interior central support structure 106. A seed treatment dispenser 200 positioned at the center of the interior central support structure 106 may be friction fit such that the outer dimensions of the upper portion of the seed dispenser is wider than and opening between the central support structure 106; alternately the seed treatment dispenser 200 positioned at the center of the interior central support structure 106 may be secured to the center support structure by fasteners 209 such as clips or hooks.

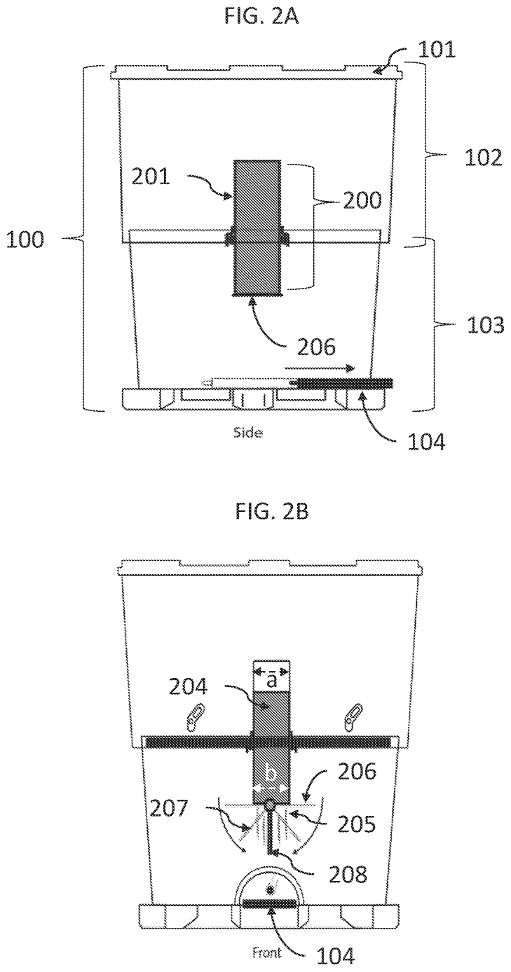

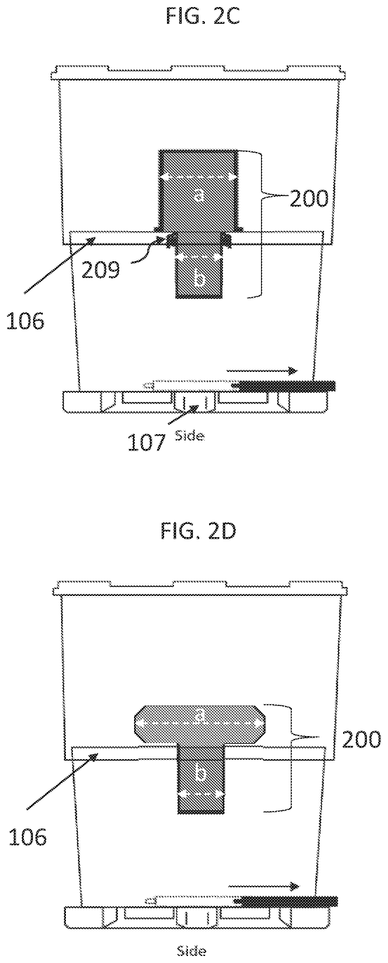

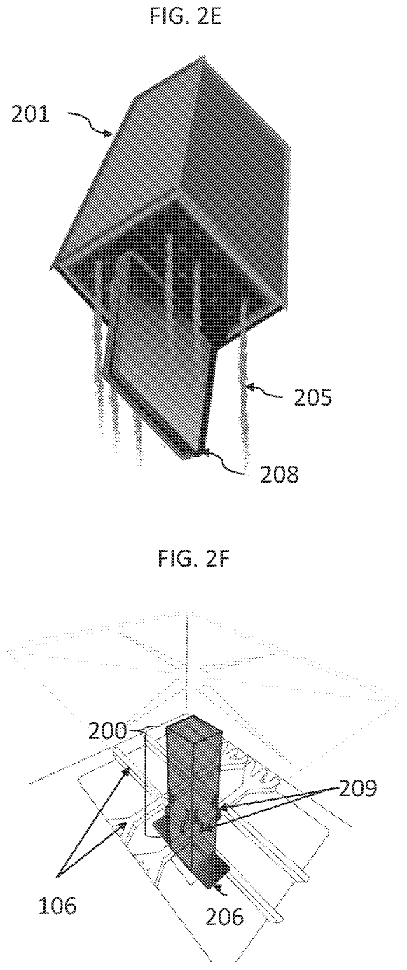

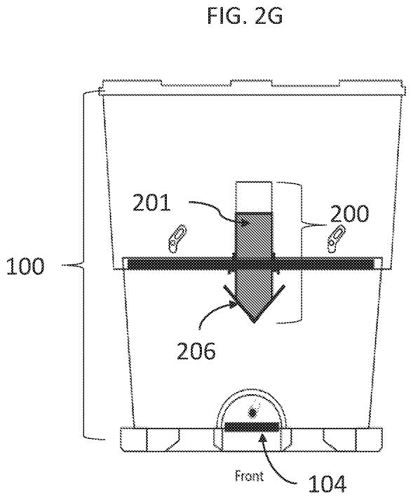

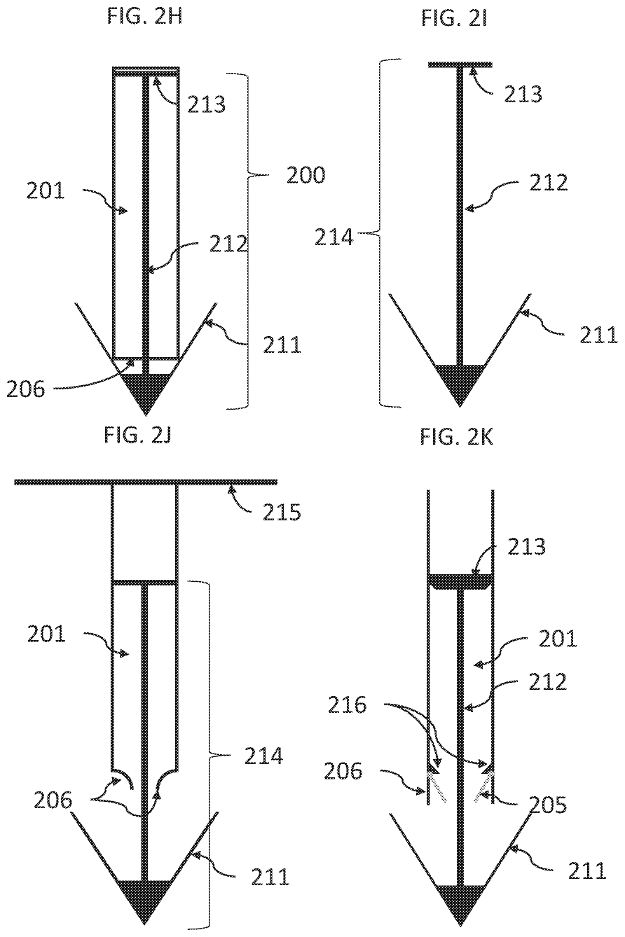

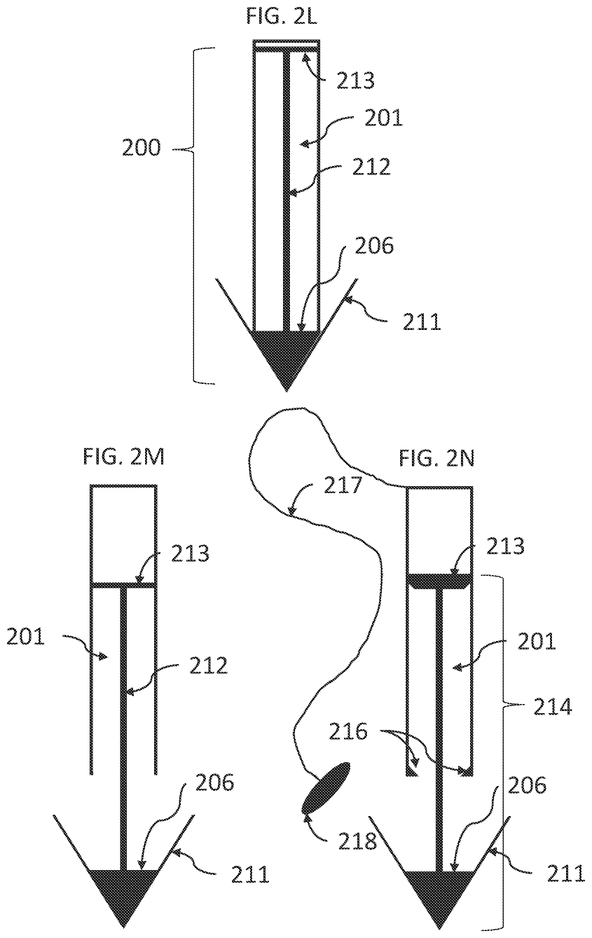

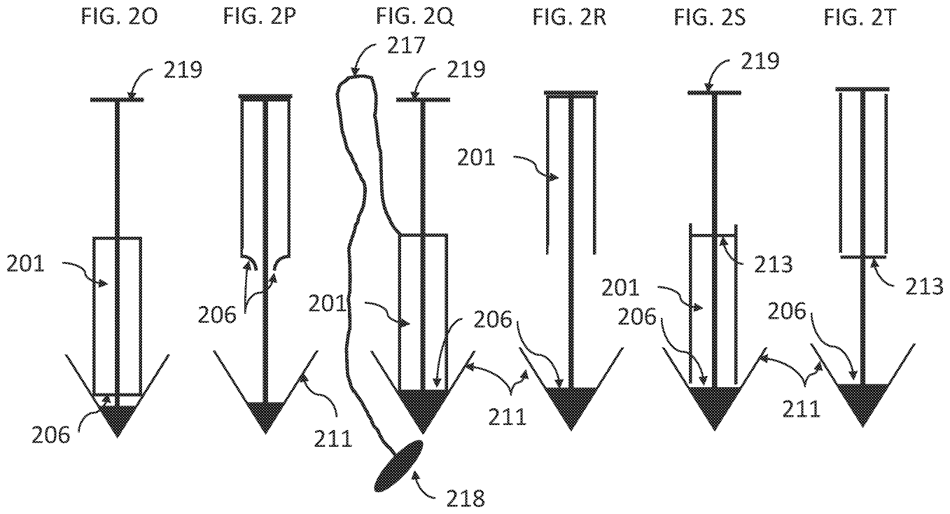

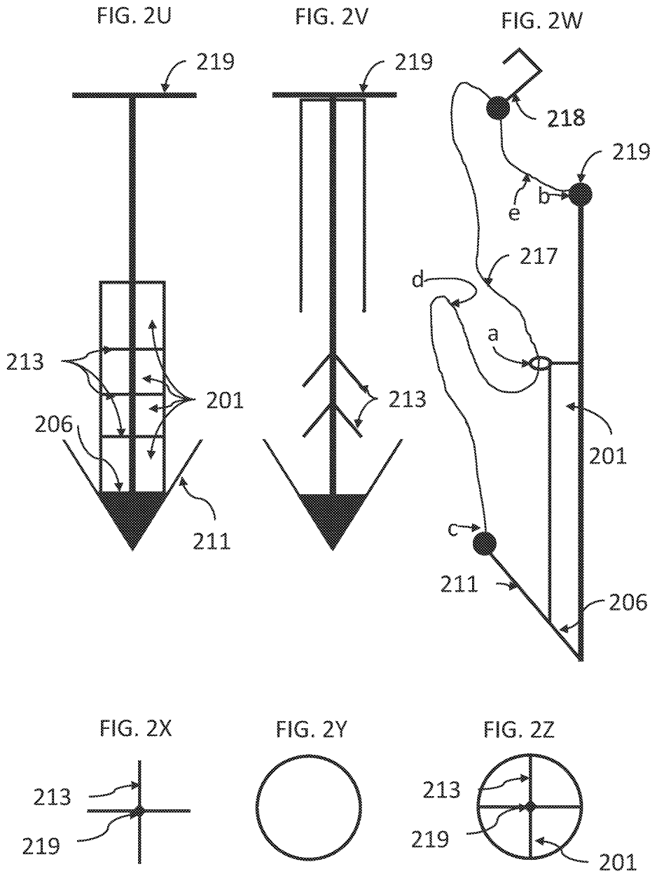

FIG. 2A shows a side sectional view of an exemplary seed storage container configured to dispense seeds 100, the seed storage container includes a lid 101, a removeable upper segment 102, a lower base segment 103 comprising a slide gate 104 covering the exit through which seed is dispensed when the slide gate is in the open, fully extended, position as shown here. Also displayed in FIG. 2A is a novel seed treatment dispenser 200, the seed treatment dispenser 200 is an exemplary center mounted seed treatment dispenser having an automatic activation system. The seed treatment dispenser 200 comprises a seed treatment reservoir 201, and a lid in a closed (non-activated) position 206 fully covering the opening through which seed treatment is dispensed. In some embodiments, the lid in a closed (non-activated) position 206 extends beyond the outer dimension of the seed treatment reservoir (for example, as shown in FIG. 2B). In some embodiments the lid in a closed (non-activated) position 206 extends beyond the outer dimension of the seed treatment reservoir in at least one dimension.

FIG. 2B shows further details of the seed treatment dispenser 200 shown in FIG. 2A. FIG. 2B shows an example of a seed treatment dispenser wherein the lid covering the opening through which seed treatment is dispensed extends beyond the outer dimension of the seed treatment reservoir in at least one dimension approximately co-planar with the bottom surface of the seed storage container (as is shown by the grey line numbered 206). The grey line numbered 207 shows the lid in a partially open (partially activated position) such that the lid partially obstructs the opening through which seed treatment is dispensed. The black line numbered 208 shows the lid in a fully open (fully activated position) such that the lid minimally obstructs the opening through which seed treatment is dispensed. The lid covering the opening through which seed treatment is dispensed may comprise one or more segments capable of covering the opening through which seed treatments are dispensed. The lid shown in FIG. 2B comprises two segments each covering one half of the opening through which seed treatments are dispensed, wherein the two halves are joined by a hinge bisected opening. FIG. 2B shows seed treatment dispensed from the seed treatment dispenser 205. In some embodiments, the progression of grey lines from the closed position (see 206) to the partially opened position (see 207) to the fully open position (see 208) is actuated by the downward pressure of seeds within the seed storage container caused by the opening of the slide gate 104. The dashed line indicated by the character “a” in FIG. 2B represents the outer dimension of the top region of the seed treatment reservoir. The dashed line indicated by the character “b” in FIG. 2B represents the outer dimension of the bottom region of the seed treatment reservoir. As used herein, and unless context clearly indicates otherwise, the top region of an object is any region located above the bottom region of the object when the object is oriented for use. As used herein, and unless context clearly indicates otherwise, the bottom region of an object is any region located below the top region of the object when the object is oriented for use. For example, when the object is a seed treatment dispenser, the seed treatment dispenser is oriented for use when it is oriented for dispensing seed treatments. In some embodiments, at least one outer dimension of an upper region of a seed treatment reservoir is wider than the widest outer dimension of a lower region of the seed treatment reservoir.

FIG. 2C shows a side sectional view of an exemplary seed storage container configured to dispense seeds with a centrally positioned seed treatment dispenser 200 having an upper outer dimension marked “a” that is wider than the widest outer dimension of the bottom region of the seed treatment dispenser marked “b”. Also shown in FIG. 2C is a fastener 209 securing the seed treatment dispenser to the interior central support structure 106. In some embodiments the fastener is a flange, hook, screw, clasp, clip, slot fastener, or similar mechanical mechanism; a fastener can also be an adhesive or a combination or an adhesive and a mechanical attachment mechanism. In some embodiments, a fastener secures the seed dispenser: to an internal central support structure of a seed storage container, to an interior or exterior of a side wall of the upper segment of a seed storage container, to an interior or exterior of a side wall of the base segment of a seed storage container, to an interior or exterior surface of the slide gate of a seed storage container, to an exterior surface of the base segment (for example, in or under the opening 107 through which seed is dispensed from the seed storage container).

FIG. 2D shows a side sectional view of an exemplary seed storage container configured to dispense seeds with a centrally positioned seed treatment dispenser 200 having an upper outer dimension marked “a” that is wider than the widest outer dimension of the bottom region of the seed treatment dispenser marked “b”. FIG. 2D illustrates an example of a seed treatment dispenser 200 supported by, but not mechanically attached to the interior central support structure of a seed storage container.

FIG. 2E shows a bottom perspective view of an exemplary seed treatment dispenser 200, wherein the treatment dispenser has been activated. In this example, seed treatment released from seed treatment dispenser flows through perforations 210 of the seed treatment reservoir 201. Seed treatment is released when the lid covering openings through which seed treatment is dispensed is in the open (fully activated position) 208. A lid may cover one or more openings through which seed treatment is dispensed. In some embodiments, the lid covers a single opening through which seed treatment is dispensed. In some embodiments, the lid covers multiple openings. In some embodiments, a single lid covers openings through which more than one seed treatment is dispensed. In some examples a plurality of seed treatments are dispensed concurrently, in some examples seed treatments are dispensed sequentially.

FIG. 2F shows a fragmentary perspective view of an exemplary center mounted seed treatment dispenser connected by fasteners 209 that are hooked over the internal central support structure 106 of a seed storage container configured to dispense seeds. FIG. 2F shows an example of an automatic activation system in the non-activated position. FIG. 2F shows an example of an automatic activation system comprising a lid 206 covering the opening through which seed treatment is dispensed, where the lid comprises the widest dimension of the seed treatment dispenser 200. In this example seed treatment is released from the seed treatment reservoir automatically by the downward force of flowing seeds on the portions of the lid 206 which extend beyond the widest dimension of the seed treatment reservoir. In some embodiments, the portion of the lid extending beyond the widest dimension of the seed treatment reservoir is perforated to allow seed treatment to pass through.

FIG. 2G shows a side sectional view of an exemplary seed storage container 100 configured to dispense seeds with a centrally positioned seed treatment dispenser 200. FIG. 2G shows an example of an automatic activation system comprising a lid 206 covering the opening through which seed treatment is dispensed, where the lid comprises the widest dimension of the seed treatment dispenser 200. In this example, opening the slide gate 104 results in dispensing of seeds from the seed storage container as well as automatic dispensing of seed treatment from the seed treatment reservoir, as the reservoir is opened automatically by the downward force of flowing seeds on the portions of the lid 206 which extend beyond the widest dimension of the seed dispenser. In this example, the bottom of the seed treatment dispenser is pointed to allow for easier insertion of the seed treatment dispenser after seeds have been loaded into the seed storage container 100. The lids 206 shown in FIG. 2B and FIG. 2F-2G are integral to the automatic activation mechanism. In these examples the segment of the lid extending beyond the outer dimension of the seed treatment dispenser acts as a level capable of being actuated by the downward flow of seeds being dispensed from the seed storage container.

FIGS. 2H, 2J-2T show examples of seed treatment dispensers that can be centrally mounted within a seed treatment container, for example using optional hook fasteners, can be tethered to a side lid of a seed treatment box (for example, with a pliable tether such as abrasion resistant rope) or can be inserted into a seed storage container filled without seed without being secured to the seed storage container.

FIG. 2H shows a seed treatment dispenser 200 in an inactivated state. The seed treatment dispenser 200 comprises a seed treatment reservoir 201 which may contain one or more compartments for storage of one or more seed treatments. The seed treatment reservoir 201 is enclosed by a lid 206. In some embodiments, the seed treatment dispenser also contains a plunger which comprises a connection to an activation mechanism 211. In some embodiments, the plunger comprises a rod 212 connecting an activation mechanism 211 and a seal 213. In some embodiments, the plunger comprises an integral (one piece) rod 212, activation mechanism 211, and a seal 213. In other embodiments, one or more of the activation mechanisms 211 and seal 213 can be removed from the connector rod, to enable filling the seed reservoir or substituting activation mechanisms adapted for a different seed type. An optionally removable activation mechanism 211 or seal 213 may be connected to the rod 212 by a mechanical mechanism, such as a catch, latch, screw, hook, slot fastener, clip, etc.

In some embodiments, the activation mechanism 211 and lid 206 are separate components of the seed treatment dispenser (for example, see FIG. 2H, 2J, 2K). In some embodiments, the activation mechanism 211 is integral to the lid 206 (for example, see FIG. 2L-N). A lid may be constructed out of a pliable material (for example, see the deflection of the lid shown in FIG. 2J in the closed position and FIG. 2J where the lids 206 are made of a pliable material that is deflected while seed treatment is being dispensed. In some embodiments, one or more lids are constructed of a stiff material (for example, see the lids of FIG. 2K in the fully open 206 and partially open 205 positions). In some embodiments, a pliable material is bendable between 20 degrees Fahrenheit and 120 degrees Fahrenheit. In some embodiments, a pliable material will deflect when approximately 22 N are applied to an edge of the material. In some embodiments, a rigid or stiff material is bendable between 20 degrees Fahrenheit and 120 degrees Fahrenheit. In some embodiments, rigid or stiff material will not deflect when approximately 22 N are applied to an edge of the material.

FIG. 2I shows an exemplary plunger unit 214, comprising an activation mechanism 211 (for example, one or more flanges, cones, or cupped shapes having at least one surface against which the force of flowing seed may be applied while a seed storage container is being dispensed), a connector rod 212 (which may be stiff or pliable), and a seal 213. As used to describe a component of a plunger unit 214, a seal comprises a surface having an area substantially perpendicular to the direction of flow of a seed treatment while dispensed, and smaller than the inner dimension of a seed treatment reservoir, capable of pushing or pulling seed treatment toward an opening through which seed treatment is dispensed. FIG. 2K shows an example of a seal 213 having a surface shape complementary to one or more stoppers 216. Optionally, one or more stoppers 216 are positioned within the seed treatment reservoir 201 such that the seal 213 of a plunger unit 214 will not be pulled out of the seed treatment dispenser after the seed treatment is fully released.

Optionally, the top surface of the seal of a plunger unit forms an exterior surface of a seed treatment dispenser (for example, see FIG. 2K). In other examples the seal remains inside the seed treatment dispenser (for example, see FIG. 2H and FIG. 2J) at least while the seed treatment dispenser is in an inactivated state.

FIG. 2J shows an example of a fin having a sufficient surface area oriented perpendicular to the direction of flow of seed from the seed storage container to slow downward movement of the attached seed treatment reservoir relative to the plunger mechanism 214. In some embodiments, a self-activating seed treatment dispenser having a large upper fin is installed in a filled seed storage container such that the activation mechanism is fully submerged in the seed and the fin 215 is above the surface level of the seed.

The lids 206 shown in FIG. 2L-2W are integral to the automatic activation mechanism 211. In these examples, an upper surface of the automatic activation mechanism 211, when in an inactivated state, fully covers an opening of the seed treatment reservoir through which seed treatment is dispensed when the seed treatment dispenser is in an activated state. FIG. 2M and FIG. 2N show an example of seed treatment dispensers in a partially activated state, wherein the seed treatment dispensers have lids 206 integral to the automatic activation mechanism 211. FIG. 2N shows an example of a seal of a plunger unit wherein the bottom surface of the seal has a complementary shape to one or more stoppers 216 situated within the seed treatment reservoir 201, wherein stoppers are positioned to prevent the plunger unit 214 from being pulled out of the seed treatment reservoir after the seed treatment dispenser is fully activated.

FIG. 2N also shows an example of an abrasion resistant tether (optionally, a pliable or stiff tether), attached to a surface of the seed treatment dispenser (for example, a tether may be connected to an exterior wall, preferably an upper region, of a seed treatment reservoir). In some embodiments, a tether has sufficient length to allow the seed treatment dispenser to be laid on the top seed surface (e.g., and not submerged in seed) and the tether to extend beyond the outer edge of the filled seed storage container. In some embodiments, the tether is connected to one or more surface of the seed treatment dispenser (for example, and exterior wall of a seed treatment reservoir). In some embodiments, the tether comprises a slip-resistant rubberized or plasticized outer layer. In some embodiments, the tether is sufficiently thin to allow a seed lid to be secured on the seed storage container when the tether is extending over the side the container. In some embodiments, a tether extending over the edge of a seed storage container is held in position by the secured lid of the seed treatment box. In some embodiments, a tether extending over the edge of a seed storage container is held in position by a hook or stopper, wherein the hook fits over the edge of the seed storage container securing the seed treatment dispenser to the seed storage container. In some embodiments, the hook fits securely under a secured lid of the seed treatment container. In some embodiments, the tether extends between the seed treatment dispenser and a stopper 218, wherein the seed treatment dispenser may be positioned inside the seed storage container (for example, laid horizontally over seed within a filled seed storage container) and the stopper connected to the tether is positioned beyond the outer edge of the seed storage container. The stopper may be any size or shape (e.g., 6 inches or less in its largest dimension, less than 9 cubic inches in volume and less than 4 inches at its largest diameter, etc.) such that the stopper cannot be pulled between a lid and the wall of a seed dispenser container to which the lid is secured. In some embodiments, the tether comprises webbing and/or rope.

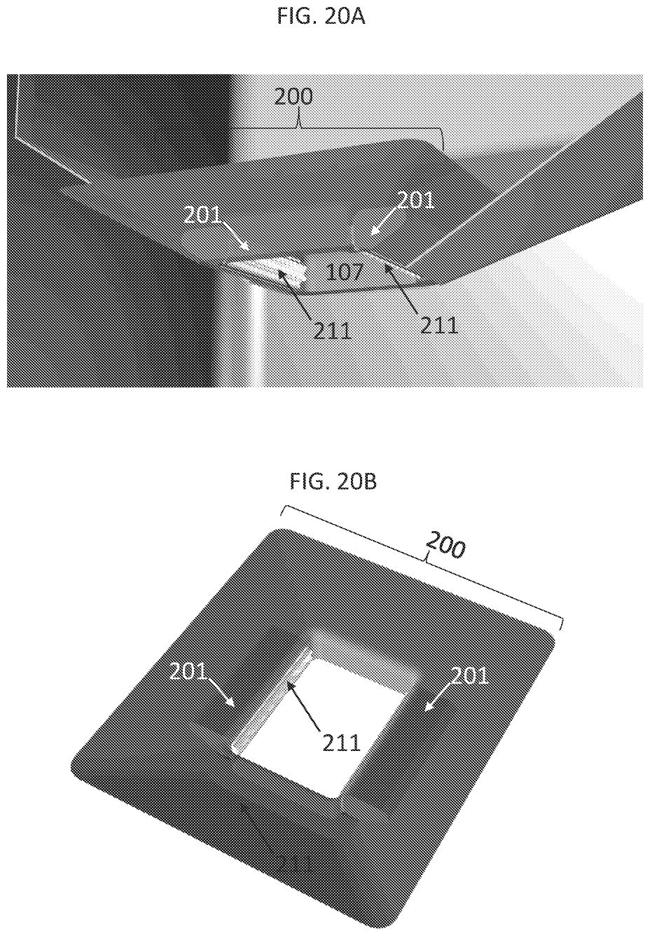

The seed treatment dispensers in FIGS. 20-2W can be inserted into a seed storage container filled with seeds and removed from the filled seed storage container without damaging the loaded seed treatment. The ability to move inactivated seed treatment dispensers between seed storage containers allows greater flexibility in inventory management. The user does not need to take any action to activate the seed treatment dispenser after the dispenser has been inserted in the filled seed storage container. The lid 206 may be integral to a surface of the activation mechanism (as shown in FIG. 2Q-2T) or one or more lids 206 may be separate (as shown in FIG. 20 and FIG. 2P). In some embodiments, the seed treatment dispenser has a handle 219 comprising a region suited to pushing (e.g., a t-bar, ergonomic handle, disk, ball, etc.) and a rigid connector extending through the seed treatment reservoir. In some embodiments, the handle is permanently connected to the activation mechanism and/or lid. In some embodiments, the handle is connected to the activation mechanism and/or lid via a removable connection (for example, a screw, latch, hook, or snap mechanism). In some embodiments, the handle may be used to push the seed treatment dispenser into seeds in a loaded seed storage container (e.g., to submerge the activation mechanism, at least partially, in the seed(s)). In some embodiments, the solid handle connects to a lid covering an opening through which seed treatment is dispensed. In some embodiments the handle may be used to pull a seed treatment dispenser out of seed in a loaded seed storage container without activating the seed treatment dispenser.

FIG. 2Q shows an exemplary seed treatment dispenser comprising a handle 219 connected to an activation mechanism 211 having an upper surface acting as a lid 206, a tether connected to an exterior side wall of a seed treatment reservoir 201, and a stopper.

FIG. 2S shows an exemplary seed treatment dispenser comprising a handle 219 connected to an activation mechanism 211 having an upper surface acting as a lid 206, wherein the handle is also connected to a seal 113 oriented substantially perpendicular to the direction of flow of a seed treatment treating being dispensed from the seed treatment reservoir, and smaller than the inner dimension of a seed treatment reservoir, wherein the seal is capable of pushing or pulling seed treatment toward an opening through which seed treatment is dispensed. In some embodiments, such as illustrated in FIGS. 2S and 2T, the seal may comprise an exterior surface of the seed treatment reservoir. In some embodiments, a handle may extend through a seed treatment reservoir, and may transect (for example, bisect) one or more exterior surfaces of a seed treatment reservoir and/or a seal. In some embodiments, a handle may be integral with one or more exterior surfaces of a seed treatment reservoir and/or a seal.

FIGS. 2U and 2V show exemplary seed treatment dispensers comprising more than one seed treatment reservoir. In FIG. 2U a seed treatment dispenser comprising multiple treatment reservoirs where the seed treatment reservoirs are divided by multiple seals 213 attached to a handle 219, wherein the handle is also attached to lid 206 and activation mechanism 211. In some embodiments, the internal seals form one or more walls of a sealed seed treatment reservoir. For example, the seed treatment dispenser may comprise a hollow shape (e.g., a tube) oriented in a vertical direction, and the tube may be completely transected by one or more horizontally oriented seal, wherein the space between the one or more seals and the exterior walls of the tube each comprises a seed treatment reservoir, and the interior of each seed treatment reservoir is completely separated from all other reservoirs. In some embodiments, complete isolation means that flow of seed treatments, flow of gases, and/or flow of moisture between reservoirs is substantially or completely blocked. In some embodiments, a single seed treatment is loaded into more than one reservoir. In some embodiments, a different type of seed treatment or indicator is loaded into each seed reservoir of a seed treatment dispenser comprising multiple seed reservoirs. In some embodiments, a handle may be a rod running vertically through one or more seed treatment reservoirs. In some embodiments, a handle may be a rod running vertically through one or more seed treatment reservoirs, and the handle may be attached to one or more seals. In some embodiments, a seed treatment reservoir is completed transected by one or more horizontally oriented seal fully covering the cross section of the seed treatment reservoir (for example, a single seed treatment reservoir may be completely transected by a seal to create two seed treatment reservoirs). In some embodiments, a seed treatment reservoir is incompletely transected by one or more horizontally oriented divider, each of which only partially covers the cross section of the seed treatment reservoir. Where a seed treatment reservoir is incompletely transected by one or more divider, the rate at which a seed treatment is dispensed from the seed treatment dispenser may be controlled. In some embodiments, the dividers or seals may be oriented in a direction perpendicular to the direction of flow of a seed treatment out of a seed treatment reservoir. In some embodiments, the dividers or seals may be oriented in a direction pointing down toward the lid covering the opening through which a seed treatment is dispensed (for example see seals 213 of FIG. 2V). The dividers may have perforations allowing the seed treatment to pass through the dividers, or the dividers may be a solid surface through which seed treatment cannot pass. In some embodiments, one or more dividers are perforated so that seed treatment may pass through the one or more dividers and the one or more dividers point upward away from the lid covering the opening through which seed treatment is dispensed.

FIG. 2W shows a cross section of an exemplary seed treatment dispenser in which a handle 219 comprises a sphere connected to a stiff rod which is immovably fixed to the seed treatment reservoir either directly (e.g. the rod is integral to a wall of a seed treatment reservoir) or indirectly (e.g. the rod is attached to a lid or activation mechanism) to facilitate pushing the seed treatment dispenser into a loaded seed storage container. In some embodiments, a tether 217 is connected to one or more positions on the seed treatment dispenser (for example, points a, b, and c shown in FIG. 2W). In some embodiments, the tether is connected at each end to the seed treatment dispenser (for example see points b and c in FIG. 2W). In some embodiments, the tether is connected at each end to the seed treatment dispenser and the tether runs through (e.g., without binding) an opening on the seed treatment dispenser (for example see point a in FIG. 2W). In some embodiments, an exemplary seed treatment dispenser has a tether connected to both i) an upper region of a seed treatment dispenser or a handle and ii) to an activation mechanism, wherein the tether is connected to the activation mechanism such that pressure on the tether exerted in the direction of the upper region of the seed treatment dispenser (when the seed treatment dispenser is in a position from which seed treatment is dispensed) secures the lid in a position covering the opening through which seed treatment is dispensed (for example, see point “c” in FIG. 2W). FIG. 2W shows an exemplary seed treatment dispenser comprising a tether having a first region “e” connected at one end to a surface of the seed treatment dispenser or a handle attached thereto (for example, attached at point “b” to handle 219) and also attached to a hook 218 (note the hook at 218 optionally fits over the edge of a seed storage container or alternately the hook at 218 could be replaced by or connected to a stopper capable from preventing the tether from being pulled into the seed storage container if the stoper extends beyond the sides of the seed storage container and the tether connecting the stopper to a seed treatment dispenser located inside the seed storage container, wherein the tether passes under a lid attached to the seed storage container). In some embodiments, the seed treatment dispenser comprises a tether having a second region (for example, the region “d” marked in FIG. 2W) connected at one end to a surface of an activation mechanism 211, wherein the activation mechanism is capable of being triggered automatically by the force of seeds being dispensed from a seed treatment container and the connection of the tether and activation mechanism is positioned such that pressure applied to the tether in the direction of the top region of the seed treatment dispenser ensures the lid is kept closed over the opening through which seed treatment can be dispensed, and connected at the other end to a hook or stopper (for example 218 in FIG. 2W). In some embodiments, a seed treatment dispenser is connected to a tether having both a first and second region. In some embodiments, the color, shape, size, or texture of the first and second region are different. In some embodiments, a seed treatment dispenser is connected to a tether having both a first and second region, wherein the first and second region are separated by a brightly colored hook or stopper such that the brightly colored hook or stopper is easily observed from the outside of a seed container containing a seed treatment dispenser when the hook is engaged with the side of the seed storage container, or the stopper is secured by tether running under the lid of a seed storage container.

FIGS. 2X through 2Z show a top (or bottom) view of a horizontal cross section of a rod of a centrally located handle attached to vertically orient seals (FIG. 2X), a top (or bottom) view of a horizontal cross section of a seed treatment dispenser having a hollow tube shape (FIG. 2Y), and a top (or bottom) view of a horizontal cross section of a rod of a centrally located handle attached to vertically orient seals wherein the rod and seals are located within a tube-shaped treatment dispenser to create four seed treatment reservoirs (for example, as shown by 201, in FIG. 2Z).

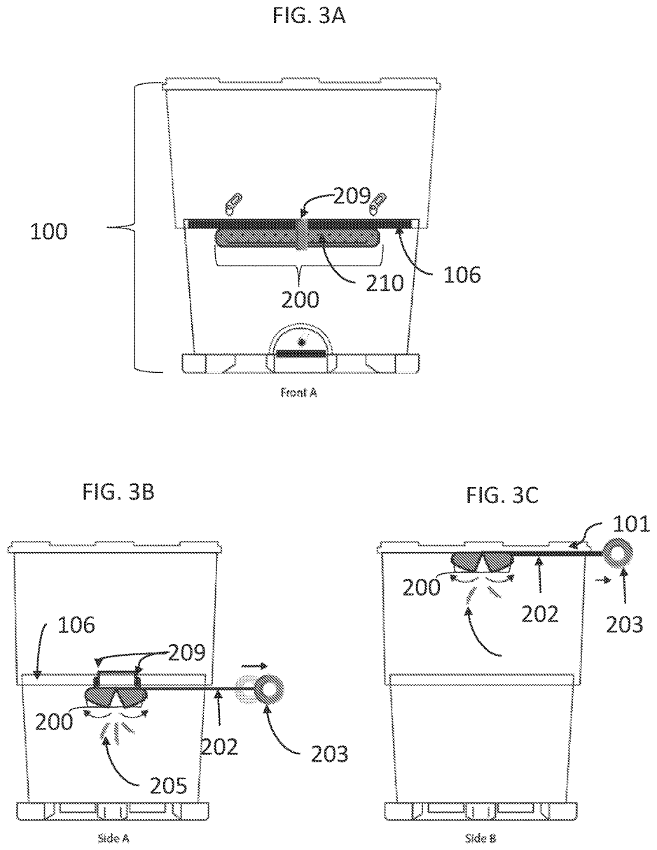

FIG. 3A shows a sectional view of a seed storage container 100 with an internally mounted seed treatment dispenser 200. In this example the seed treatment dispenser 200 is mounted by a fastener 209 to the internal central support structure 106. In some embodiments the seed treatment reservoir contains perforations 210 to the exterior through which the seed treatment is dispensed for example, upon manual activation by removing a covering (e.g., a covering over the exterior of the seed treatment dispenser, or a covering within the interior of the seed treatment reservoir). In some embodiments, manual activation of a seed treatment device comprises pulling a cord resulting in the ripping or slicing of a pouch (for example, a metallized polyester and linear low density polyethylene bag) containing seed treatment. Where seed treatment is contained in a disposable container such as a bag, it is desirable for the container to be located inside perforated seed treatment reservoir having holes large enough for seed treatment to flow out but small enough that the container to remain inside the seed treatment reservoir (for example, where the perforations are 1 square inch in size or less).

FIG. 3B shows a sectional view of a seed storage container with an internally mounted seed treatment dispenser 200. In this example the seed treatment dispenser 200 is mounted by fasteners 209 to the internal central support structure 106. This exemplary seed treatment dispenser is shown in an activated state as shown by the open position of the two halves of the dispenser shown in grey 200, and the flow of seed treatment 205 out of the activated dispenser. The seed treatment dispenser is activated by extending a manual activation pull cord 202 from the handle 203 positioned outside of the seed storage container.

FIG. 3C shows a sectional view of a seed storage container with an internally mounted seed treatment dispenser 200. In this example the seed treatment dispenser 200 is fastened to the lid of the seed storage container. The seed treatment dispenser is shown in an activated position. This lid mounted seed treatment dispenser is activated by pulling the manual activation pull cord 202, wherein the pull cord fits beneath the fastened lid 101 and may be extended by pulling the handle 203.

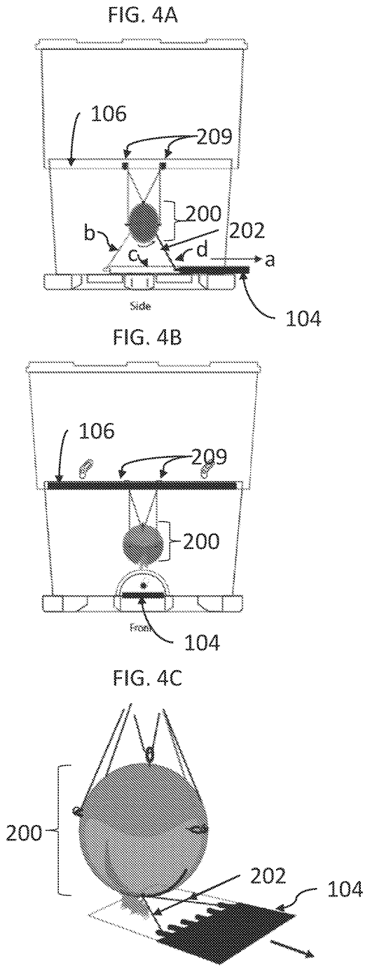

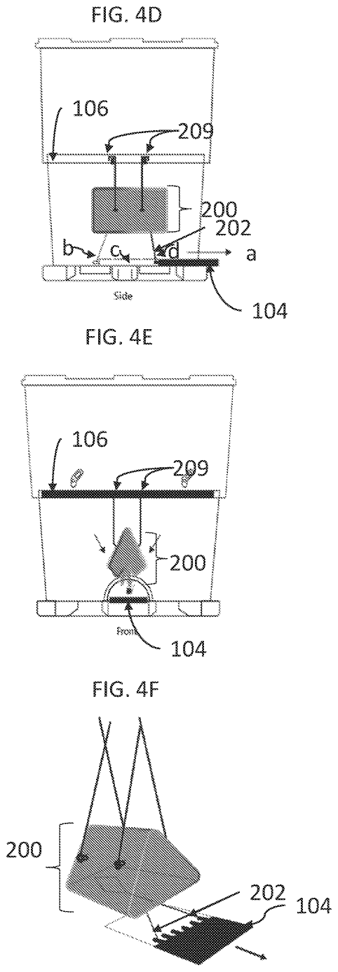

FIG. 4A shows a sectional view of a seed storage container with an internally mounted seed treatment dispenser 200. In this example the seed treatment dispenser 200 is connected to the interior central support structure 106 by fasteners 209. This centrally mounted seed treatment dispenser is activated when a user pulls the slide gate 104 in direction “a” to release seeds from the seed storage container. The action of opening the slide gate of the seed storage container pulls on the pull cord or rod 202 which connects the slide gate 104 to the seed treatment dispenser 200. The arrow labeled “b” indicates the position of the pull cord or rod when the seed treatment dispenser is in an inactive state. The arrow labeled “c” indicates the position of the slide gate when the seed treatment dispenser is in an inactive state. The forces applied to the seed treatment dispenser by the pull cord or rod 202 moving from position “b” to the position “d” causes an opening in the bottom surface of the seed treatment dispenser (for example, a break in the bottom surface of the seed treatment reservoir, opening of a lid covering an opening through which seed treatment is dispensed, etc.). FIG. 4B shows a sectional view of a seed treatment dispenser hanging from fasteners 109 attached to the interior central support structure 106. FIG. 4C shows a view of a seed treatment dispenser 200 connected to a slide gate of a seed storage container by pull cords or rods 202.

FIG. 4D shows a sectional view of a seed storage container with an internally mounted seed treatment dispenser 200. In this example the seed treatment dispenser 200 is connected to the interior central support structure 106 by fasteners 209. This centrally mounted seed treatment dispenser is activated when a user pulls the slide gate 104 in direction “a” to release seeds from the seed storage container. The action of opening the slide gate of the seed storage container pulls on the pull cord or rod 202 which connects the slide gate 104 to the seed treatment dispenser 200. The arrow labeled “b” indicates the position of the pull cord or rod when the seed treatment dispenser is in an inactive state. The arrow labeled “c” indicates the position of the slide gate when the seed treatment dispenser in an inactive state. The forces applied to the seed treatment dispenser by the pull cord or rod 202 moving from position “b” to the position “d” causes an opening in the bottom surface of the seed treatment dispenser (for example, a break in the bottom surface of the seed treatment reservoir, opening of a lid covering an opening through which seed treatment is dispensed, etc.). FIG. 4E shows a sectional view of a seed treatment dispenser having angled upper surfaces hanging from fasteners 109 attached to the interior central support structure 106. FIG. 4F shows a view of a seed treatment dispenser 200 connected to a slide gate of a seed storage container by pull cords or rods 202.

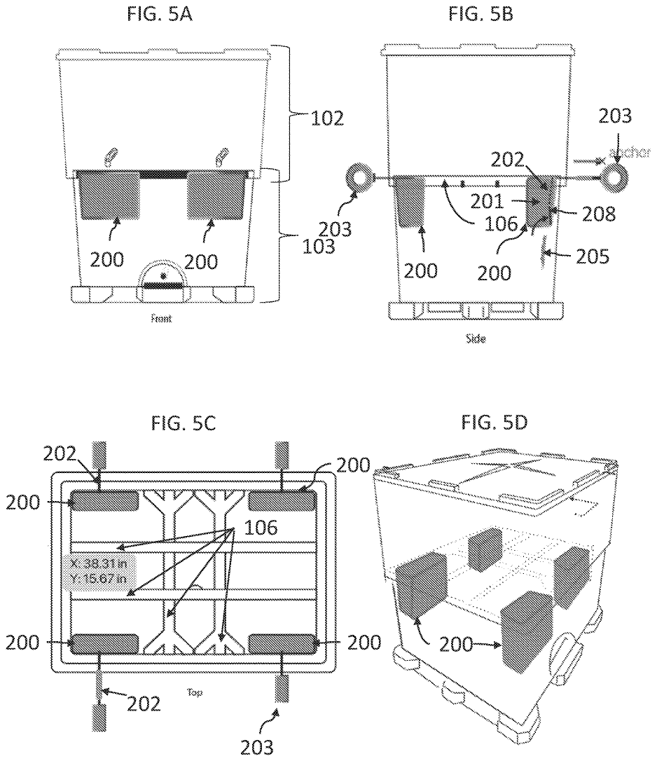

FIG. 5A shows a cross-sectional view of a seed storage container configured to dispense seeds, comprising an upper segment 102 and a base segment 103, and two internal seed treatment dispensers 200 mounted to the edge of the seed storage container. FIG. 5B shows a cross-sectional view of a seed storage container configured to dispense seeds, comprising two internal seed treatment dispensers 200 mounted to the edge of the seed storage container; this exemplary image also shows a pull cord 202 connecting a lid in a fully open, activated position 208 and a handle 203 located on the exterior of the seed storage container. This example is notable as the lid in a fully open, activated position 208 is pulled upward into the seed treatment reservoir to release the seed treatment 205, and the pull cord extends from the lid through the interior of the seed treatment dispenser. In some embodiments, the pull cord runs through the junction between the removable upper portion of a seed storage container and the base of the seed storage container. FIG. 5C is a view from the top of seed storage container, showing interior central support structures 106, and four separate seed treatment dispensers 200, each connected to a manual activation pull cord, rod, or slide 202, and a handle 203. FIG. 5D shows a perspective view of four seed treatment dispensers mounted to the side walls of the seed storage container.

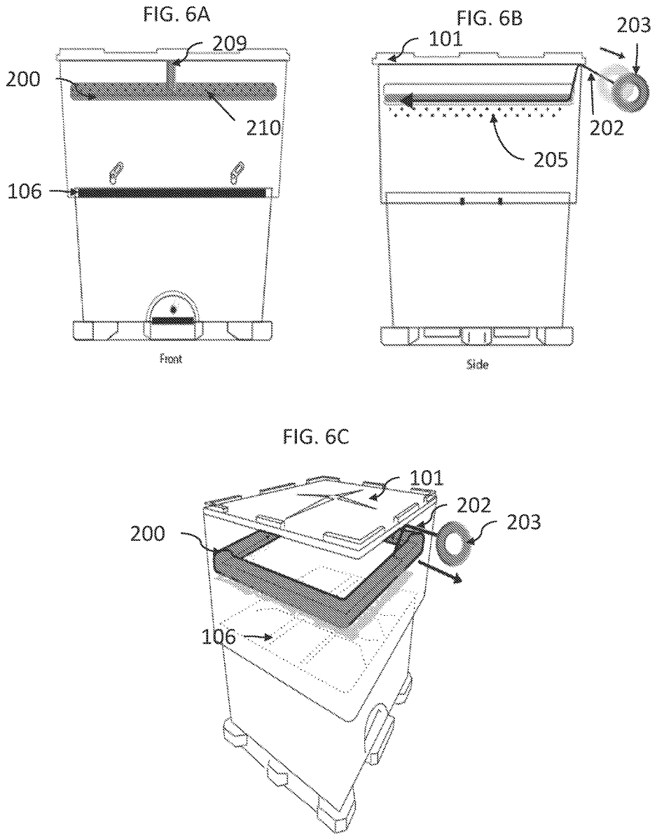

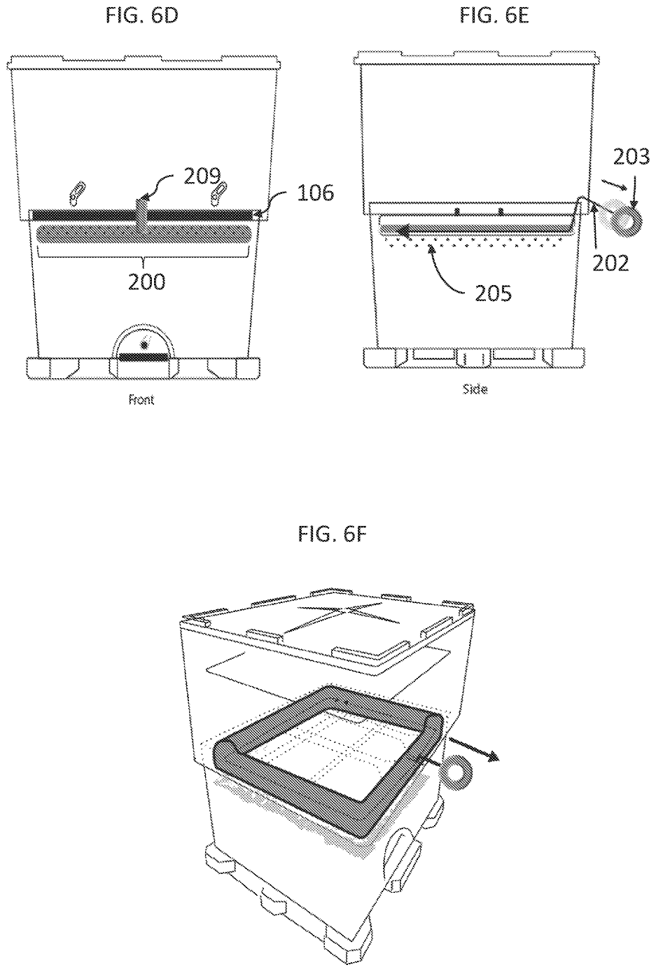

FIG. 6A shows a side sectional view of a seed storage container configured to dispense seeds comprising a seed treatment dispenser 200 fastened to a seed treatment container with a fastener 209 (for example, a hook fitting over the top edge of the upper segment of a seed treatment dispenser configured to dispense seeds and under a lid of the seed storage container). In some embodiments, the seed treatment dispenser extends along all four sides of the upper segment of a seed storage container and may be secured to the seed storage container with two fasteners each positioned midway along the opposite walls. In some embodiments, the seed treatment dispenser extends along all four sides of the upper segment of a seed storage container and may be secured to the seed storage container with four fasteners each one positioned midway along each wall. In some embodiments, the seed treatment dispenser comprises a hollow shape extending along all four sides of the upper segment of a seed storage container, wherein the seed treatment dispenser is not fastened to the seed storage container. In some embodiments, the seed treatment dispenser comprises a hollow shape (e.g., a tube) comprising 1, 2, 3, 4, 5, 6 7, 8 or more interior chambers (e.g., seed treatment reservoirs). In some embodiments, the seed treatment dispenser comprises an enclosed (except for one or more openings through which seed treatment may be dispensed, for example, through one or more perforations) hollow container in a shape such as a square, rectangle, circle or oval wherein the shape comprises a continuous perimeter having an empty center. In some embodiments, the widest dimension of the seed treatment dispenser is larger than the largest opening between elements of the central support structure. FIG. 6B shows an exemplary seed treatment dispenser having a manual activation mechanism wherein the dispenser is activated by pulling a handle 203 in a direction away from the center of the seed storage container, wherein the handle 203 is connected to a pull cord 202. The seed treatment dispenser of FIG. 6C is situated in the upper segment of a seed storage container, and the seed treatment dispenser is not attached to the side of the seed storage container. The seed treatment dispenser of FIG. 6C is an example of a seed treatment container that may be loaded into the seed storage container before or after the seed storage container is filled, so long as the pull cord of 202 is of sufficient length to extend over the top edge of the upper segment of the seed storage container while the seed treatment dispenser is supported by the interior central support structure 106. The seed treatment dispenser of FIG. 6C is an example of a seed treatment dispenser comprising a hollow container in a rectangular shape, wherein the shape comprises a continuous perimeter having an empty center.

In some embodiments, a pull cord comprises two regions: a first region wherein, in the inactivated state, the pull cord is integral to a surface of the seed treatment reservoir and a second region wherein the pull cord is not integral to a surface of a seed treatment reservoir wherein the second region is at least 4, 6, 8, 10, 12 inches in length and comprised of an abrasion resistant material. In some embodiments, applying a pulling force to the second region of the pull cord results in separation of the pull cord and the surface of the seed treatment reservoir such that contents of the seed treatment reservoir are released. In some embodiments, the first and or second region of the pull cord can fit between a lid secured to a seed storage container and an upper edge of an upper segment of a seed storage container. In some embodiments, the second region of the pull cord is attached to a handle. In some embodiments, the second region of the pull cord is attached to a hook, wherein the hook can be secured over a side wall of an upper segment of the seed storage container. In some embodiments, the one or both ends of a second region of the pull cord is attached to the first region. In some embodiments, a seed treatment dispenser comprises a pull cord having a first region wherein the pull cord is integral to a surface of the seed treatment reservoir and the pull cord of the first region is continuous with the pull cord of a second region wherein the pull cord of the second region is not integral to a surface of the seed treatment reservoir. A pulling force applied to the second region of the pull cord is capable of separating the pull cord of the first region from the seed treatment reservoir. Optionally the second cord is attached to a hook configured to fit securely over a top edge of an upper segment of a seed storage container when a lid is secured to the upper segment of the seed storage container. FIG. 6D shows a side sectional view of a seed storage container configured to dispense seeds comprising a seed treatment dispenser 200 fastened to a seed treatment container with a fastener 209 (for example, a fastener attached to an internal support structure 106). FIG. 6E shows seed treatment 205 released from a seed treatment dispenser when manually activated by a pulling force applied to a handle 203 attached to a pull cord 202. The seed treatment dispenser of FIG. 6F is an example of a seed treatment container that may be loaded into the seed storage container before the seed storage container is filled; the seed treatment dispenser is supported by the interior central support structure 106. The seed treatment dispenser of FIG. 6F is an example of a seed treatment dispenser comprising a hollow container in a rectangular shape, wherein the shape comprises a continuous perimeter having an empty center.

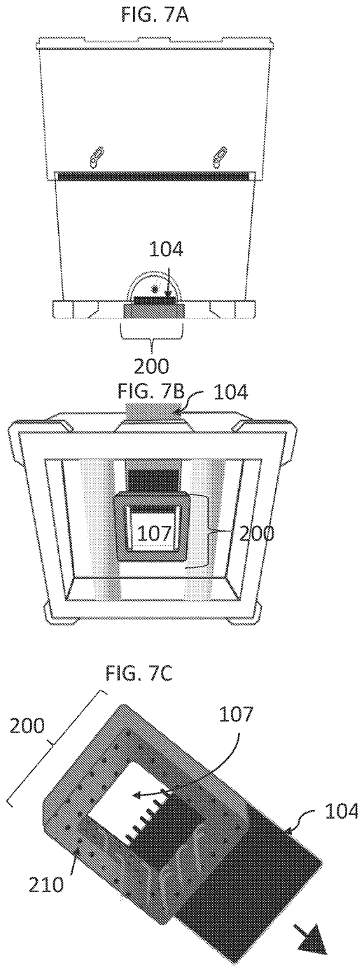

FIG. 7A shows an example of a seed treatment dispenser 200 mounted on the exterior of a seed storage container below the slide gate 104 that separates the interior of the seed storage container from the opening through which seed is dispensed. FIG. 7B shows an upward facing view of the bottom segment of the base segment of a seed storage container featuring a seed treatment dispenser 200 positioned within the opening through which seed is dispensed 107 and the slide gate of the seed storage container 104 in the open position. FIG. 7C shows a detailed view of an exemplary seed treatment dispenser 200 having perforations 210 through which seed treatment can flow when the seed treatment dispenser is activated. FIG. 7C also shows the opening through which seed is dispensed 107 and a slide gate 104 of a seed storage container in a partially open position. In some embodiments, when slide gate 104 is opened, and seeds are released, the seed treatment is pulled out of seed treatment reservoir through perforations 210 on the inside and bottom of the seed treatment reservoir due to airstream/seed flow (venturi effect).

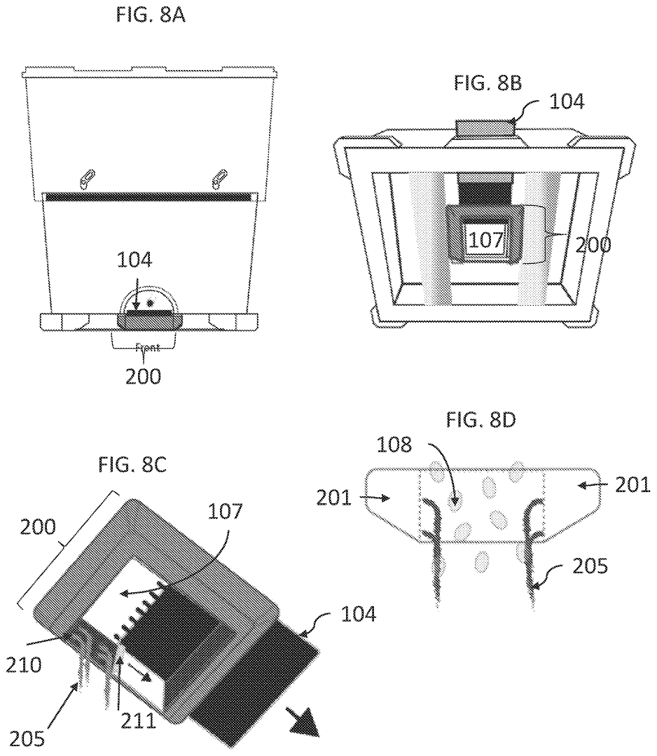

FIG. 8A shows an example of a seed treatment dispenser 200 mounted on the exterior of a seed storage container below slide gate 104 that separates the interior of the seed storage container from the opening through which seed is dispensed. FIG. 8B shows an upward facing view of the bottom segment of the base segment of a seed storage container featuring a seed treatment dispenser 200 positioned within the opening through which seed is dispensed 107 and the slide gate of the seed storage container 104 in the open position. FIG. 8C shows a detailed view of an exemplary seed treatment dispenser 200 having perforations 210 and seed treatment released from the dispenser 205 when the seed treatment dispenser is activated. FIG. 8C also shows the opening through which seed is dispensed 107 and a slide gate 104 of a seed storage container in a partially open position, as well as an activation mechanism 220 comprising a connection between a covering of the perforations of the seed treatment reservoir and the edge of the slide gate 104. FIG. 8C is an example of a seed treatment dispenser comprising a hollow container in a rectangular shape, wherein the shape comprises a continuous perimeter having an empty center. As shown in FIG. 8B, the empty center of a seed treatment dispenser may be positioned under the opening through which seed treatment is dispensed such that seed flows through the empty center of the seed treatment dispenser. FIG. 8D shows a detailed cross-sectional view of the seed treatment dispenser shown in FIG. 8C. FIG. 8D shows an example of a seed treatment reservoir 201 and an empty center region through which seed 108 can flow and come into contact with seed treatment dispensed from the seed treatment dispenser. FIGS. 8A-8D show an example of seed treatment reservoirs having a bottom surface that slopes downward toward one or more openings through which seed treatment is dispensed; and this configuration aids the flow of seed treatment while being dispensed.

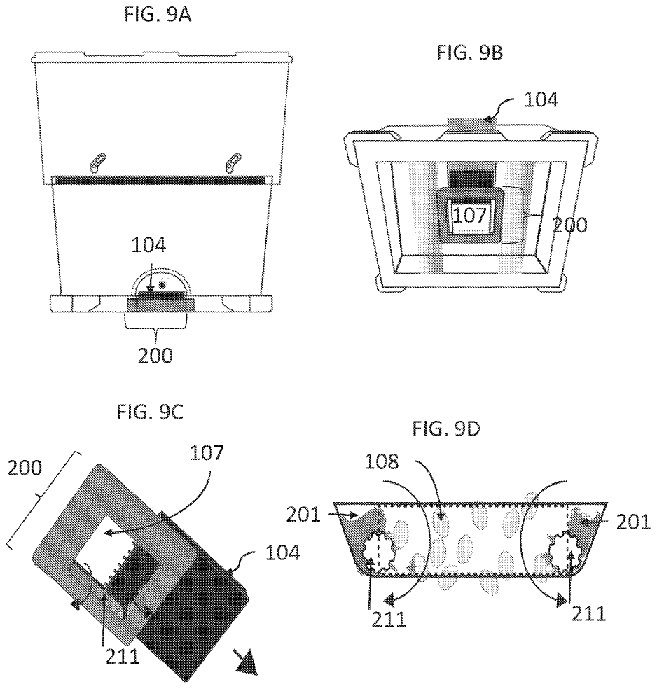

FIG. 9A shows an example of a seed treatment dispenser 200 mounted on the exterior of a seed storage container below a slide gate 104 that separates the interior of the seed storage container from the opening through which seed is dispensed. FIG. 9B shows an upward facing view of the bottom segment of the base segment of a seed storage container featuring a seed treatment dispenser 200 positioned within the opening through which seed is dispensed 107 and the slide gate of the seed storage container 104 in the open position. FIG. 9C shows a detailed view of an exemplary seed treatment dispenser 200 having an activation mechanism 211 comprising rollers having extensions that cause the rollers to spin when the extensions are contacted by moving seed passing through the opening 107, the contact of the seeds and extensions causes the extensions to rotate through the seed treatment reservoir and contact the seed treatment and, by continued rotation of the extensions of the rollers, seed treatment is moved into the opening 107. The opening of the slide gate 104 causes seed to be dispensed from the storage container and the movement of seeds through the opening 107 automatically results in seed treatment being dispensed from the seed treatment dispenser. FIG. 9C is an example of a seed treatment dispenser comprising a hollow container in a rectangular shape, wherein the shape comprises a continuous perimeter having an empty center. As shown in FIG. 9B, the empty center of a seed treatment dispenser may be positioned under the opening through which seed treatment is dispensed such that seed flows through the empty center of the seed treatment dispenser. FIG. 9D shows a detailed cross-sectional view of the seed treatment dispenser shown in FIG. 9C. FIG. 9D shows an example of a seed treatment reservoir 201, an empty center region through which seed 108 can flow and come into contact with seed treatment dispensed from the seed treatment dispenser. In some embodiments, a seed treatment dispenser comprising a roller dispenser has a seed treatment reservoir having a curved base edge matching radius of rollers to keep powder from collecting in corners of the seed treatment reservoir.

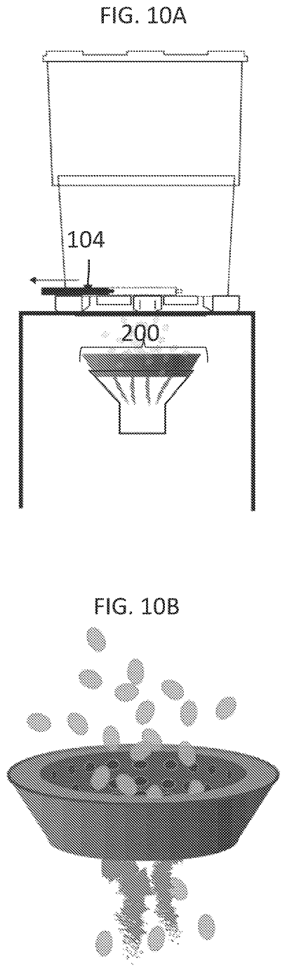

FIG. 10A shows a seed treatment dispenser which can be placed under a seed box and above a container into which seed is to be dispensed, for example between a seed storage container (for example, a seed box) and a seed box tender or seed hopper. FIG. 10A shows a seed treatment dispenser positioned to sit atop a funnel used in the unloading of seeds from a seed storage container (for example, into a seed tender). FIG. 10B is an example of a seed treatment dispenser comprising a hollow container in a circular shape, wherein the shape comprises a continuous perimeter having an empty center. FIG. 10A shows, the empty center of a seed treatment dispenser may be positioned under the opening though which seed treatment is dispensed such that seed flows through the empty center of the seed treatment dispenser. In some embodiments, a protective film is removed from the seed treatment dispenser before the seed treatment dispenser is installed.

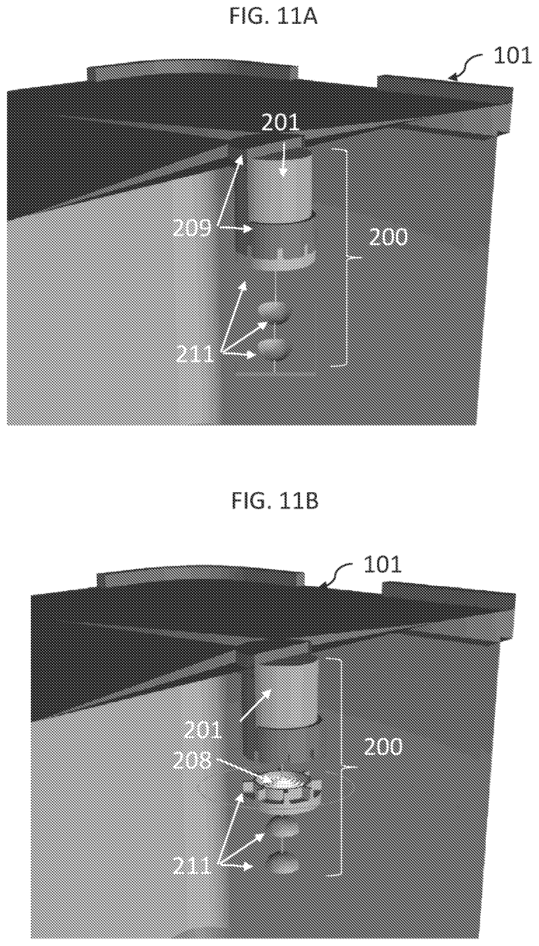

FIG. 11A shows an example of a seed treatment dispenser 200 attached to a lid 101 of a seed storage container by a fastener 209. The seed treatment dispenser of FIG. 11A shows an example of a seed treatment dispenser wherein the bottom surface of the seed treatment reservoir 201 is attached to an activation mechanism. In this example, the activation mechanism comprises two discs (which may have curved, flat, level, or sloped surfaces, e.g. sloping up or down, or having concave surfaces facing up or down) which are attached to the bottom exterior surface of the seed treatment reservoir by a flexible cord or fixed rod wherein activation mechanisms are or become fully submerged by seed loaded within the seed storage container, and downward force exerted on the activation mechanisms by the flow of seed out of the seed storage container causes the separation of the bottom surface from the seed treatment reservoir and release of the seed treatment. FIG. 11B shows an example of a seed treatment dispenser wherein the bottom surface of the seed treatment dispenser comprises a lid covering an opening through which seed treatment is dispensed 208, shown here in the fully activated position. In some embodiments, flowing seeds catch on the activation mechanisms 211 releasing spiral spring-loaded lid 208, releasing seed treatment in a spinning motion.

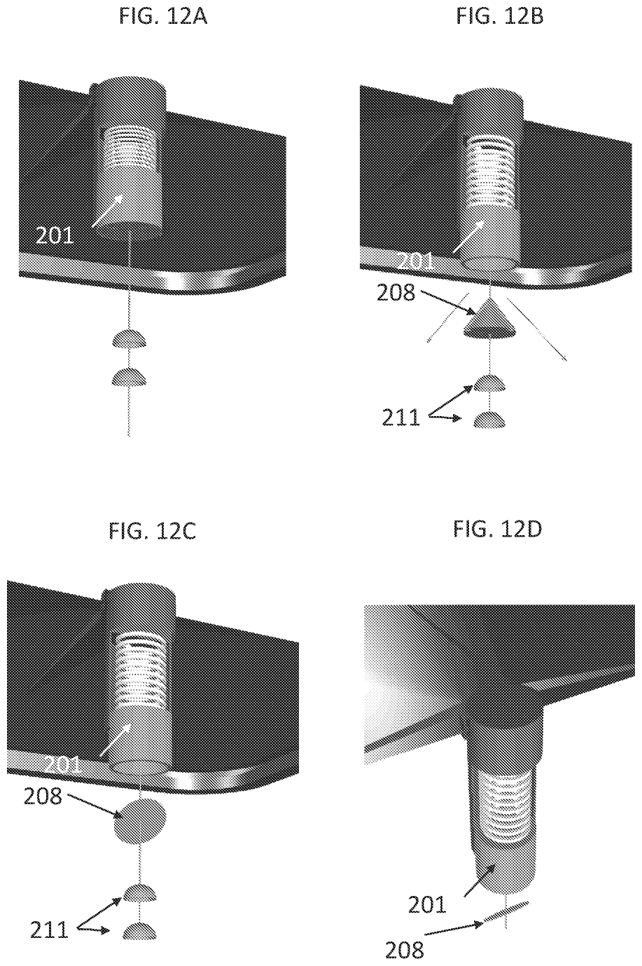

FIG. 12A shows an example of a seed treatment dispenser 200 which may be attached to a seed storage container (for example, a lid or side wall of a seed storage container) by a fastener 209. The seed treatment dispensers of FIGS. 12A-12D show an example of a seed treatment dispenser wherein the bottom surface of the seed treatment reservoir 201 is attached to an activation mechanism. In these examples, the activation mechanism comprises discs (which may have curved, flat, level, or sloped surfaces, e.g. sloping up or down, or having concave surfaces facing up or down) that are attached to the bottom exterior surface of the seed treatment reservoir by a flexible cord or fixed rod wherein activation mechanisms are or become fully submerged by seed loaded within the seed storage container, and downward force exerted on the activation mechanisms by the flow of seed out of the seed storage container causes the separation of the bottom surface from the seed treatment reservoir and release of the seed treatment. In some embodiments, the activation mechanisms are attached to a cord, wherein the cord is also attached to a lid of the seed treatment container and an upper surface of the seed treatment reservoir which in turn is connected to a spring, wherein the downward pressure on the activation mechanisms extends the spring, lowering the lid of the seed treatment reservoir and upper surface of the seed treatment reservoir, simultaneously allowing release of the seed treatment and pushing seed treatment out of the seed treatment reservoir. FIGS. 12B-12D show an example of a seed treatment dispenser wherein the bottom surface of the seed treatment dispenser comprises a lid covering an opening through which seed treatment is dispensed 208, shown in the fully activated position. FIG. 12B shows an example of an integrated lid and bottom surface of a seed treatment reservoir wherein the surface is sloped toward the opening of the seed treatment reservoir.

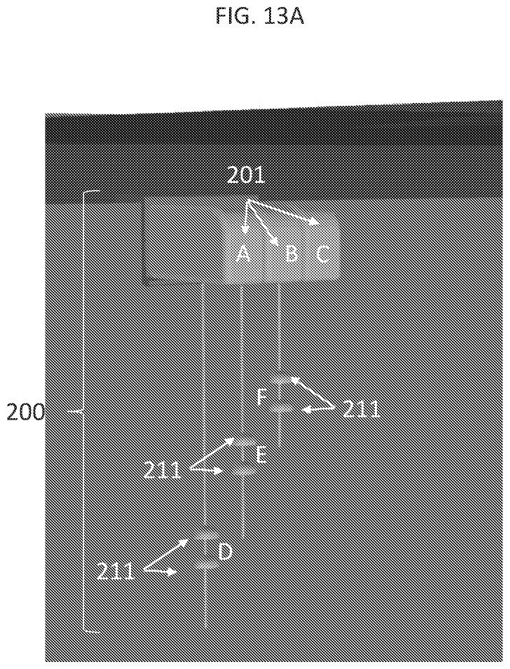

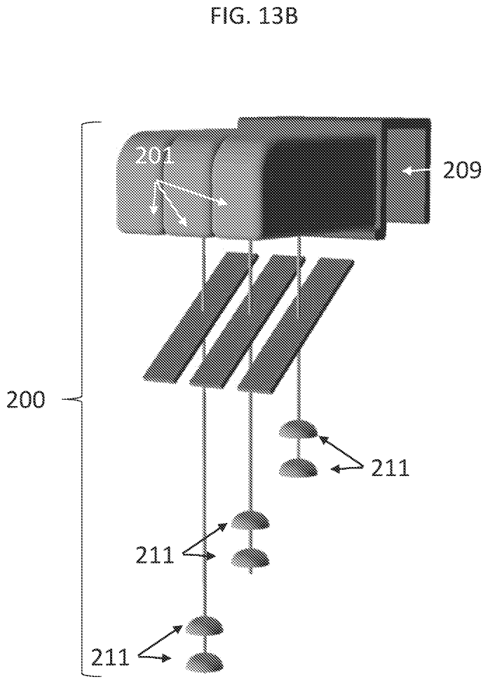

FIG. 13A shows an example of a seed treatment dispenser 200 which may be attached to a seed storage container (for example, a lid or side wall of a seed storage container). FIGS. 13A and 13B show an example of a seed treatment dispenser comprising more than one seed treatment reservoir, in this example three seed treatment reservoirs labeled A, B, and C. The seed treatment dispensers of FIGS. 13A and 13B show an example of a seed treatment dispenser wherein the bottom surface of each seed treatment reservoir 201 is attached to an activation mechanism 211. In these examples, the activation mechanism comprises discs (which may have curved, flat, level, or sloped surfaces, e.g. sloping up or down, or having concave surfaces facing up or down) that are attached to the bottom exterior surface of the seed treatment reservoir by a flexible cord or fixed rod wherein activation mechanisms are or become fully submerged by seed loaded within the seed storage container, and downward force exerted on the activation mechanisms by the flow of seed out of the seed storage container causes the separation of the bottom surface from the seed treatment reservoir and release of the seed treatment. FIG. 13A also shows an example wherein each activation mechanism extends into a seed filled seed storage container at different depths shown by D, E, and F, resulting in different activation characteristics. In this example, each seed treatment reservoir is attached to a separate activation mechanism, though in some embodiments, multiple seed treatment reservoirs can be attached to a single seed treatment reservoir.

FIG. 13B shows an example of a seed treatment dispenser 200 which may be attached to a side wall of a seed storage container by a hook fastener fitting over the side wall. The seed treatment dispenser of FIG. 13B shows an example of a seed treatment dispenser wherein the bottom surface of each seed treatment reservoir 201 is attached to an activation mechanism 211; this example shows a seed treatment dispenser wherein each seed treatment reservoir is shown in a fully activated state. In some embodiments, a seed treatment dispenser comprises more than one seed treatment reservoir and each seed treatment reservoir is activated simultaneously. In some embodiments, a seed treatment dispenser comprises more than one seed treatment reservoir and each seed treatment reservoir may be activated at a different time.

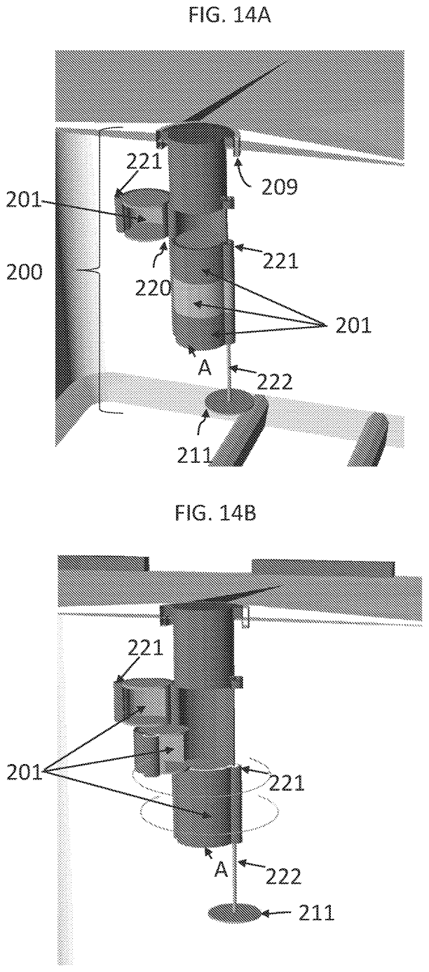

FIG. 14A shows an example of a seed treatment dispenser 200 which may be attached to a seed storage container (for example, a lid or side wall of a seed storage container) by a fastener 209. FIGS. 14A and 14B show examples of a seed treatment dispenser comprising more than one seed treatment reservoir. The seed treatment dispensers of FIGS. 14A and 14B show an example of a seed treatment dispenser wherein a single activation mechanism 211 activates dispensing of seed treatment from multiple seed treatment reservoirs sequentially. The exemplary seed dispensers shown in FIGS. 14A and 14B illustrate an activation mechanism comprising a disc 211 that is attached to a rod 222. In some embodiments, multiple discs or flanges may be used, and the discs or flanges may have curved, flat, level, or sloped surfaces (e.g. sloping up or down, or having concave surfaces facing up or down). In this example, prior to activation a seed treatment dispenser comprises one or more seed treatment reservoirs stacked vertically wherein each seed treatment reservoir comprises: a spring-loaded hinge 220 such that the seed treatment reservoirs must be actively held in the inactive state, “A”. In this embodiment, the reservoirs are held in the inactive state by a rod 222 passing through a channel 221 and the spring-loaded treatment reservoirs are held in the closed, inactive state by insertion behind a flange or into a loop secured to the seed treatment dispenser (see A in FIG. 14A and FIG. 14B). When a seed treatment dispenser loaded with seed treatment is installed in the seed storage container the one or more activation mechanisms are or become fully submerged by seed loaded within the seed storage container. In this example, the mechanism is activated by downward force exerted on the activation mechanism 211 by the flow of seed out of the seed storage container. This causes the rod 222 to move down to sequentially release each seed treatment reservoir allowing it to spring open and disperse the seed treatment.

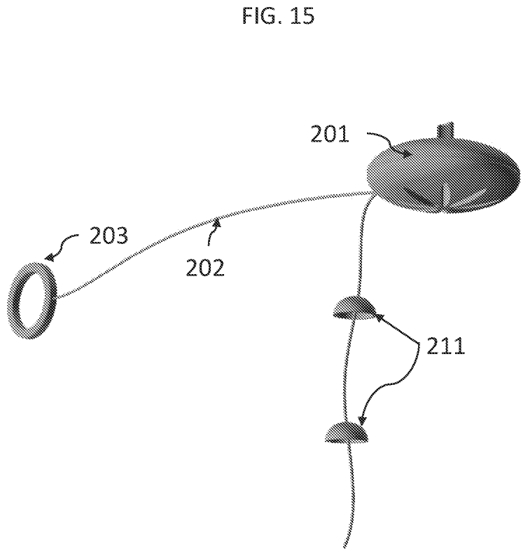

Referring to FIG. 15, a seed treatment dispenser may have both a manual and an automatic activation mechanism, as shown by the manual activation pull cord 202 connected to handle 203, and automatic activation mechanism 211. In some embodiments, the manual or automatic activation mechanism pulls on a cord wrapped around a cartridge causing the seed treatment reservoir to spin (e.g., similar to a top or salad spinner) propelling the seed treatment across the seed surface.

As described above, the actuation or activation of the seed activation mechanism can be manual or physical, actuated by force applied by a user, by seed flowing through a seed container, and the like. In some embodiments, the seed treatment dispenser systems described herein can include an electronic activation mechanism in addition to or instead of a passive (automatic) 211 or manual 202 mechanical activation mechanism. An electronic activation mechanism is an electronically actuated mechanism for opening and or closing or enabling opening and or closing of a seed treatment reservoir, such as opening a lid covering opening through which seed treatment is dispensed, uncovering perforations of a seed treatment reservoir, etc. An electronic activation mechanism may optionally be activated by a signal triggered by an user interaction with a remote device (a device not integrated with the seed treatment dispenser), a change in position of a remote device (for example, a device wholly or partially integrated in or attached to a slide gate of a seed storage container that sends a signal to an electronic activation mechanism upon a change in position of the slide gate for example between open and close). In other examples, an electronic activation mechanism comprises a component capable of directly (for example, a GPS capable device) or indirectly (for example, RFID tagged device) determining a geolocation of a seed treatment dispenser. For example, an RFID tag mounted on a seed treatment device may be read by an RFID reader located at an entrance or exit to a facility or mounted on a piece of equipment (for example, a bulk box seed tender, box hopper, a fork lift, etc.) triggering an electronic activation mechanism of a seed treatment dispenser within a threshold distance from the RFID reader. Optionally, an electronic activation mechanism of a seed treatment dispenser may be triggered automatically a period of time after exposure to the RFID reader. An electronic activation mechanism comprising a geolocation component may be triggered based on the geolocation of a seed treatment dispenser. For example, an electronic activation mechanism may be triggered to enable opening of a seed treatment reservoir only when a GPS-capable seed treatment dispenser is located within a geofenced geographic location. There may be multiple geofenced geographic locations within which opening of a seed treatment dispenser is enabled, for example one or more fields or facilities. In some embodiments, an electronic activation mechanism may enable a seed treatment dispenser to be activated by a passive automatic or manual mechanical activation mechanism or an additional electronic activation mechanism.

In some embodiments, an electronic activation mechanism comprises a proximity sensor, for example an optical proximity sensor (including without limitation, a lidar sensor, a infrared sensor, a capacitive proximity sensor, an ultrasonic sensor, etc.). An electronic activation mechanism comprising a proximity sensor may trigger opening and or closing or enabling opening and or closing of a seed treatment reservoir upon detecting a change in seed level within a seed storage container, for example an increase of distance between the sensor and average seed level of at least 5 cm, at least 10 cm, at least 15 cm, at least 20 cm, at least 30 cm, at least 40 cm, at least 50 cm, at least 60 cm, or at least 70 cm. In some embodiments, an electronic activation mechanism can include one or more detectors configured to detect a movement of seed within the seed storage container, and in response to detecting the movement of seed, can cause a release of seed treatment from the seed treatment reservoir.

In some embodiments, a safety device can be included in conjunction with the seed dispenser. The safety device can receive overrides signals from a user or device that can configure the electronic activation mechanism into a locked state, preventing seed treatment from being released from the seed treatment reservoir. Such embodiments are beneficial in that they allow for manual control of seed treatment release when desired while enabling an automatic release of seed treatment otherwise. In some embodiments, the safety device can prevent the activation of the electronic activation mechanism in response to detecting a lack of seed in the seed container, in response to detecting a wrong type of seed in the seed container, in response to determining that the seed dispenser system is at the wrong location for dispending seeds (e.g., by using a GPS positioning system), in response to detecting the seed dispenser system is in transit, and the like.

The electronic activation mechanism can include gears, compression mechanisms, or any other components configured to, when the electronic activation mechanism is activated, cause a force to be applied to the seed treatment reservoir. The force, when applied, causes seed treatment to be expelled or squeezed from the seed treatment reservoir. In other embodiments, the electronic activation mechanism can pump seed treatment from the reservoir to be applied to the seed. In some embodiments, the electronic activation mechanism, when actuated, can compress the seed treatment reservoir downward onto a screw, edge, blade, point, or other release mechanism, creating a hole or opening in a surface of the seed reservoir and compressing seed treatment out of the seed treatment reservoir, through the hole or opening, and onto the seeds. In some embodiments, a set of retractable tabs or other structures prevents the seed treatment reservoir from making contact with a screw or blade below the seed treatment reservoir until the electronic activation mechanism actuates and retracts the tabs or other structures, causing the screw or blade to pierce or create an opening within a surface of the seed treatment reservoir.

It should be noted that in embodiments with an electronic activation mechanism, the seed treatment dispenser system may not have a lever arm, weights, springs, cables, or other components associated with a manual or physical activation of a seed treatment activation mechanism as described above. It should also be noted that in some embodiments, a seed treatment dispenser system or seed storage container may include batteries, solar panels, capacitors or other power sources to power the electronic activation mechanism; may include controllers and/or other sensors to control the electronic activation mechanism; and may include one or more communication interfaces configured to enable the seed treatment dispenser system to receive or send signals, instructions, or other information from local or remote devices or entities.

In some embodiments, the electronic activation mechanism, upon activation and release of seed treatment from a seed treatment reservoir, can generate a signal or other indication that seed treatment was released. In some embodiments, the electronic activation mechanism can produce a signal or other indication that the activation malfunctioned or failed, or that the seed treatment was not or was only partially released from the seed treatment reservoir. In some embodiments, the electronic activation mechanism can produce a signal indicating that the seed treatment reservoir is empty and/or needs to be replaced, for instance for transmission to a device or system associated with an entity that can replace the seed treatment reservoir.

A seed treatment dispenser may comprise an electronic storage media that may be programmed to store information for example information related to the seed treatment dispenser, seed treatment reservoir, and or seed storage container, including without limitation: a unique identifier, a location, a date of first service, a date of last service, a type and or amount of seed treatment loaded in one or more seed treatment reservoir, an product history (for example, one or more of an loading event, a loaded product, a date, a time, a storage duration, a location, etc.), an activation history (for example, one or more of an activation event, a dispensed product, a date, a time, a duration, a location, etc.), etc.,

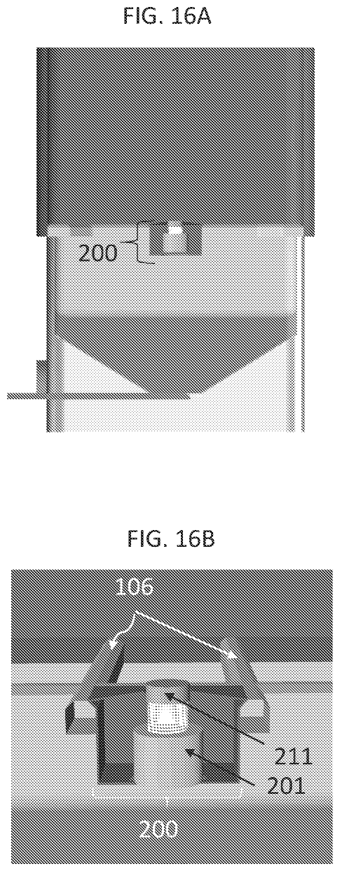

FIG. 16A shows an example of an automatically activating centrally mounted seed treatment dispenser 200. As illustrated in FIG. 16B an automatically activating centrally mounted seed treatment dispenser 200 may be set securely within the grid created by the interior central support structure 106. In this embodiment, the seed treatment dispenser is activated by the pressure of the seeds loaded on top of activation mechanism 211, compressing the seed treatment reservoir comprising an engineered weak spot calibrated to burst when seeds are released from the seed storage container.

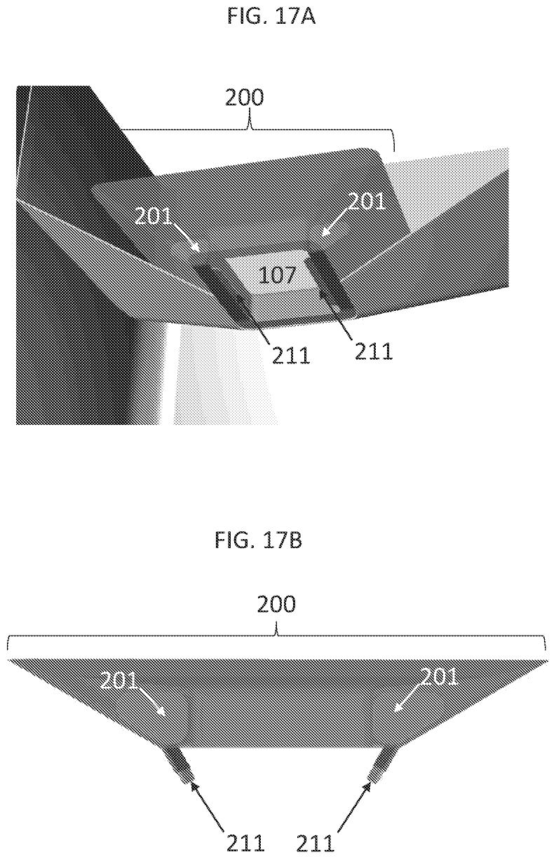

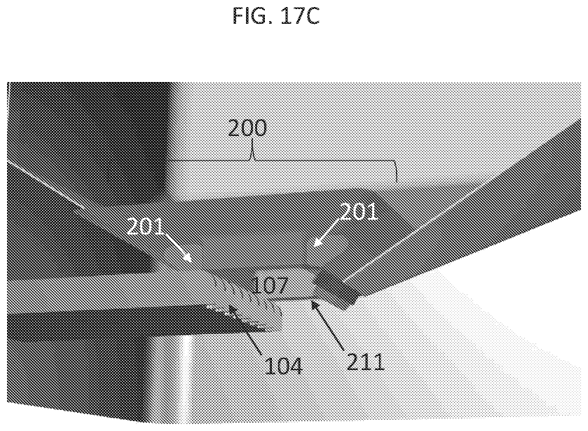

FIGS. 17A and 17B illustrate views of an exemplary seed treatment dispenser 200 which sits securely above the slide gate 104 that, in the closed position covers the opening through which seeds are dispensed 107 from the seed storage container. In this example, the seed treatment dispenser comprises two seed treatment reservoirs 201, which may optionally be loaded with the same or different treatments. The seed treatment dispensers may comprise a plurality of seed treatment reservoirs having equal or differing volumes. In some embodiments, the activation mechanisms 211 are activated by downward pressure on the mechanisms from the flow of seeds out of the seed storage container. In some embodiments, the activation mechanisms 211 (optionally, spring loaded hatches) are in an inactivate state when held securely against the closed slide gate and the seed treatment reservoirs are reversibly opened and closed automatically with the opening or closing of the slide gate of the seed storage container. In some embodiments, the seed treatment dispenser comprises two activation mechanisms oriented on opposite sides of the opening 107 and perpendicular to the direction of travel of the slide gate 104 by which flow of seed from the storage container is controlled. In this orientation both activation mechanisms engage with the slide gate at the same time. In some embodiments, the activation mechanisms are constructed of a pliable material (for example, silicone) which can be repeatedly deformed by interaction with the slide gate and/or seeds.

FIG. 17C illustrates a view of an exemplary seed treatment dispenser 200 which sits securely above the slide gate 104 that, in the closed position covers the opening through which seeds are dispensed 107 from the seed storage container. In this example, the seed treatment dispenser comprises two seed treatment reservoirs 201, which may optionally be loaded with the same or different treatments and be of the same or different volumes. In some embodiments, the activation mechanisms 211 (optionally, spring loaded hatches) are in an inactivate state when held securely against the closed slide gate and the seed treatment reservoirs are reversibly opened and closed automatically with the opening or closing of the slide gate of the seed storage container. In some embodiments, the seed treatment dispenser comprises two activation mechanisms oriented on opposite sides of the opening 107 and in line with the direction of travel of the slide gate 104 by which flow of seed from the storage container is controlled, in this orientation the activation mechanisms are engaged and disengaged sequentially.

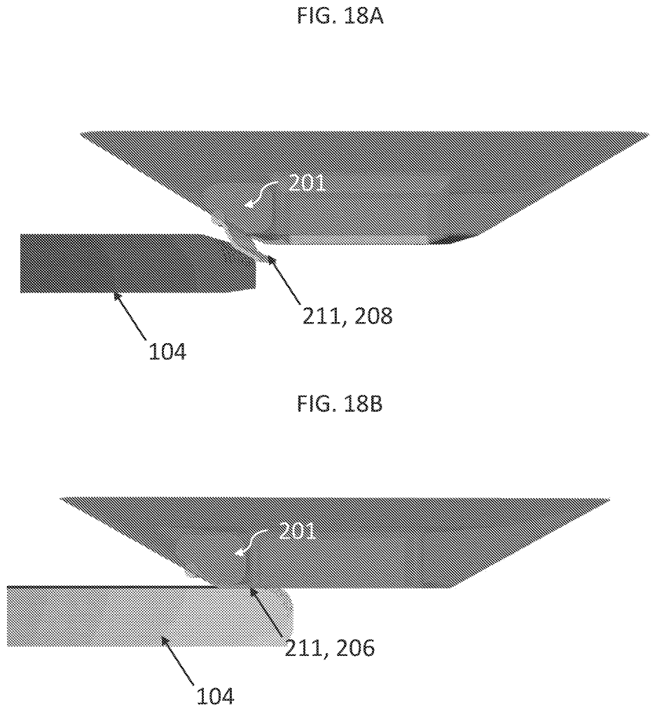

FIGS. 18A and 18B illustrate views of an exemplary seed treatment dispenser 200 positioned securely above the slide gate 104 that, in the closed position, covers the opening through which seeds are dispensed from the seed storage container. In this example, the seed treatment dispenser comprises one seed treatment reservoir 201, however, a similar seed treatment dispenser may comprise more than one seed treatment reservoir positioned on the same or different sides of the seed treatment dispenser and have one or more activation mechanisms. In some embodiments, the activation mechanism 211 (optionally, a spring-loaded hatch) is in an inactivate state when held securely against the closed slide gate (as illustrated in FIG. 18B) and the seed treatment reservoirs are reversibly opened and closed automatically with the opening or closing of the slide gate of the seed storage container. FIG. 18A illustrates a configuration wherein the slide gate 104 is open and the activation mechanism 211 is in an activated state and the lid covering the opening through which seed treatment is dispensed is in an open (activated) position 208.

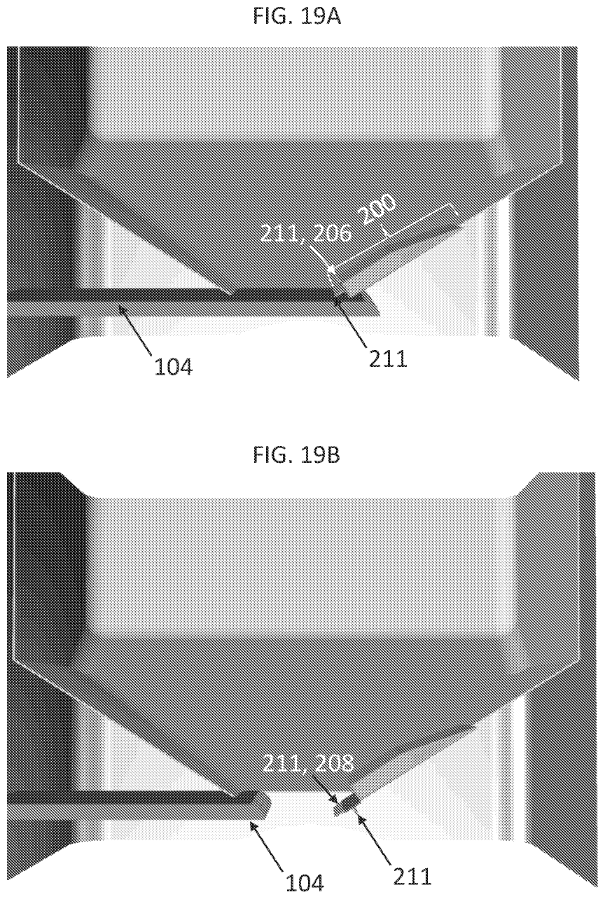

FIGS. 19A and 19B illustrate views of an exemplary seed treatment dispenser 200 positioned securely above the slide gate 104 that, in the closed position, covers the opening through which seeds are dispensed from the seed storage container. In some embodiments, the activation mechanism 211 is in an inactivate state when held securely against the closed slide gate (as illustrated in FIG. 19A) and the seed treatment reservoirs are reversibly opened and closed automatically with the opening or closing of the slide gate of the seed storage container. FIG. 19A illustrates a configuration wherein the slide gate 104 is closed and the activation mechanism 211 is in an inactivated state and the lid covering the opening through which seed treatment is dispensed is closed (inactivated) 206. FIG. 19B illustrates a configuration wherein the slide gate 104 is open and the activation mechanism 211 is in an activated state and the lid covering the opening through which seed treatment is dispensed is open 208.

FIGS. 20A and 20B illustrate views of an exemplary seed treatment dispenser 200 which sits securely above the opening through which seed is dispensed from a seed container. In this example, the seed treatment dispenser comprises two seed treatment reservoirs 201, which may optionally be loaded with the same or different treatments. The seed treatment dispensers may comprise a plurality of seed treatment reservoirs having equal or differing volumes. In some embodiments, the activation mechanisms 211 are rollers activated by the flow of seeds out of the opening through which seed is dispensed, the rollers spin when contacted by seed, pick up powder, and deposit on passing seeds as they exit.

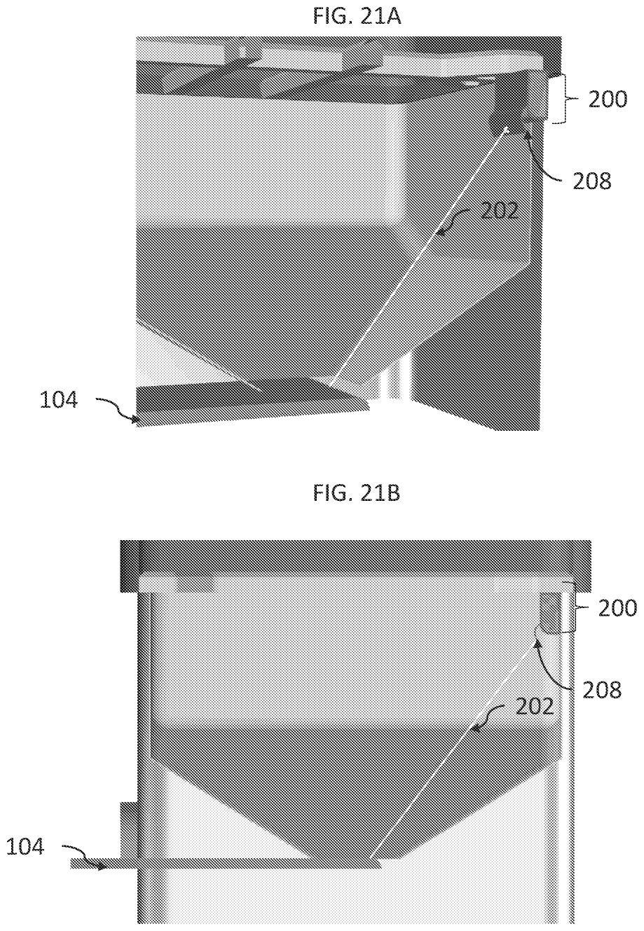

FIG. 21A shows a sectional view of a seed storage container with an internally mounted seed treatment dispenser 200. This seed treatment dispenser is activated when a user pulls the slide gate 104 in to release seeds from the seed storage container. The action of opening the slide gate of the seed storage container pulls on the pull cord or rod 202 which connects the slide gate 104 to the lid of the seed treatment reservoir 208.

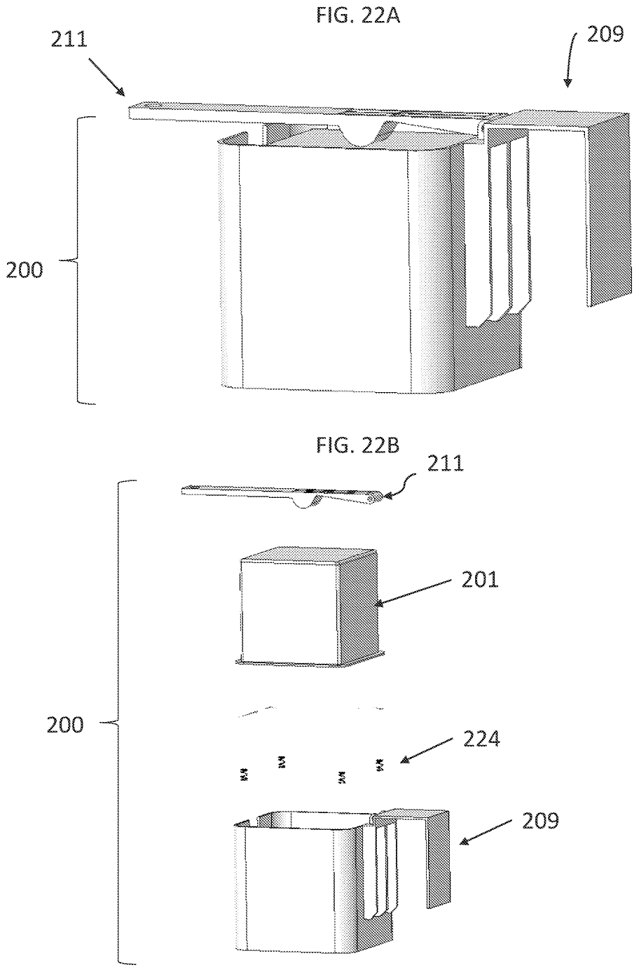

FIGS. 22A-B, 23A-C and FIG. 24 show different views, examples and components of a seed treatment dispenser which may be attached to a seed storage container (for example, a side wall of a seed storage container). The seed treatment dispenser consists of an outer structure that holds an inner seed treatment reservoir. When the seed treatment dispenser is not activated, the inner seed treatment reservoir is kept above the bottom of the seed treatment dispenser by a holding device or devices that hold the seed treatment reservoir above a serrated edge, or another sharp surface, that faces upward and is positioned near or at the bottom of the seed treatment dispenser. In some embodiments, the holding device may be a spring. In some embodiments, the holding device may be made of a material that is engineered to break or compress under the force created by the activation mechanism. In some embodiments, the holding device may move under the force created by the activation mechanism, allowing the seed treatment reservoir to lower. The bottom of the seed treatment reservoir is made of a material that can be cut by a serrated edge, or another sharp surface, or has sections that have been prepared such that it can be cut by the serrated edge, or another sharp surface, when such sections come into contact with such serrated edge, or another sharp surface. The activation mechanism for the seed treatment dispenser is a levered arm that pushes down on the seed treatment reservoir when force is applied to it. In some embodiments, the activation arm may be automatically activated by an attachment connected to the end of the activation arm by a rod or a flexible cord that creates force on one end of the activation arm when the seed is emptied out of the seed box, causing the activation mechanism to exert downward pressure on the seed treatment dispenser. This causes the seed treatment reservoir to push down on the holding device and causing the bottom of the seed treatment reservoir to be cut by the serrated edge, or another sharp surface, on the inner bottom of the seed treatment dispenser that effectuates release of the seed treatment. In some embodiments, the activation arm may be connected to a cord that would allow for manual activation. In some embodiments, the seed treatment dispenser may have a design with a greater width than the example in FIGS. 22A-B, 23A-C and FIG. 24. In some embodiments, the mount spans across the top of the seed storage container and the seed treatment dispenser is positioned at the top middle of the seed storage container.

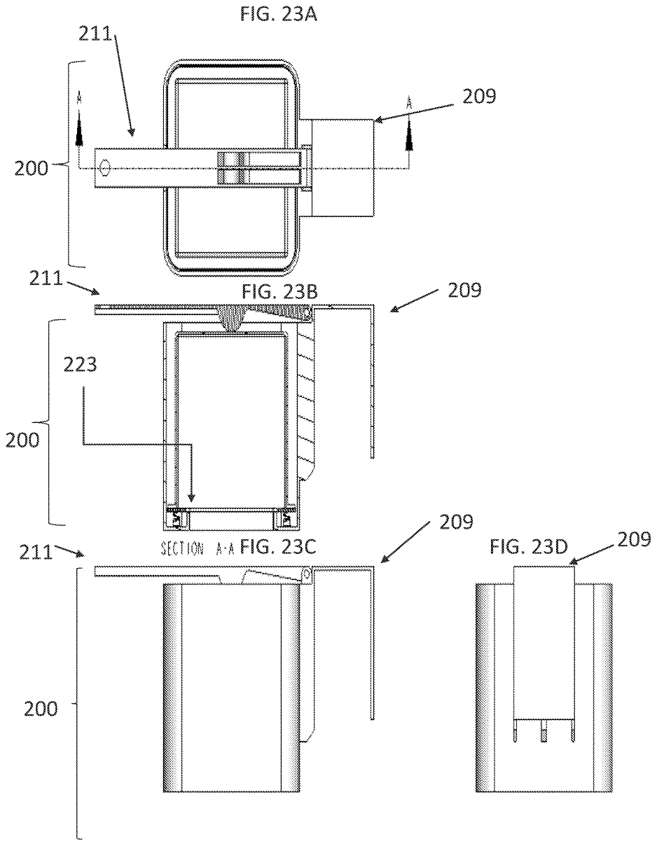

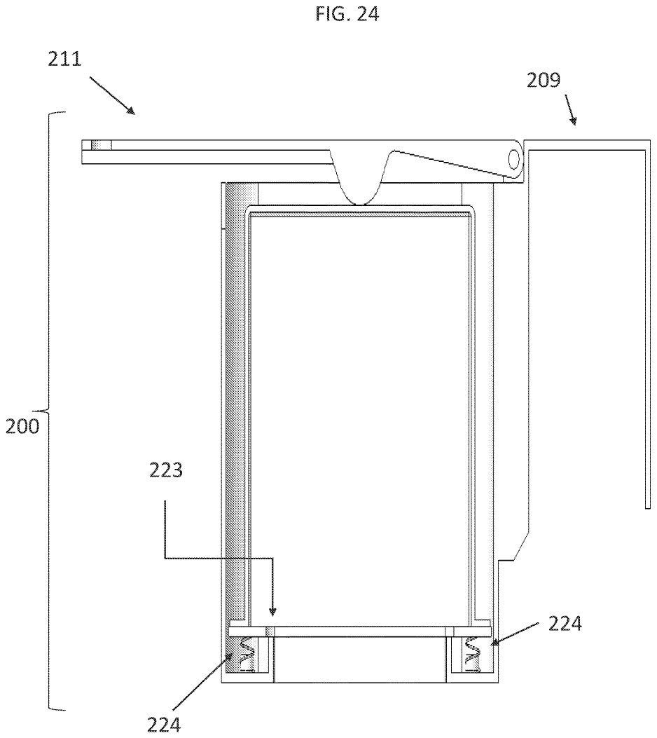

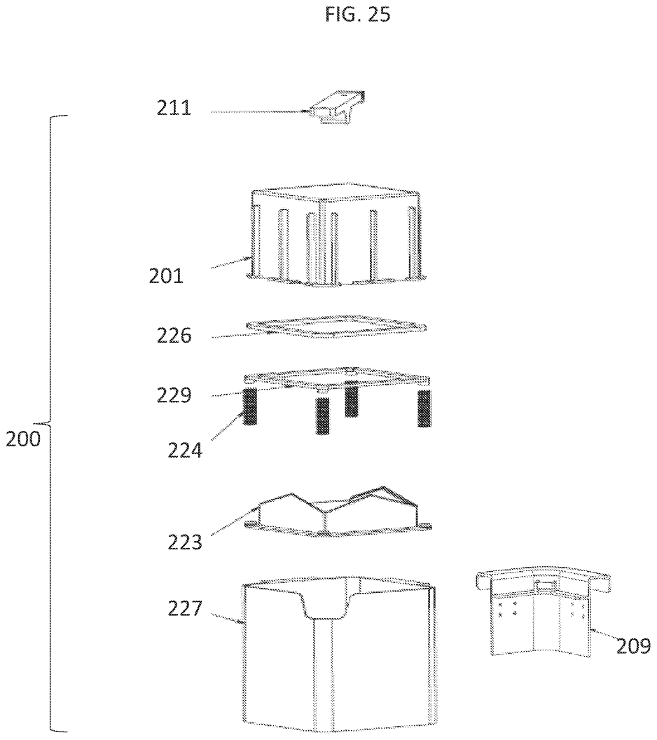

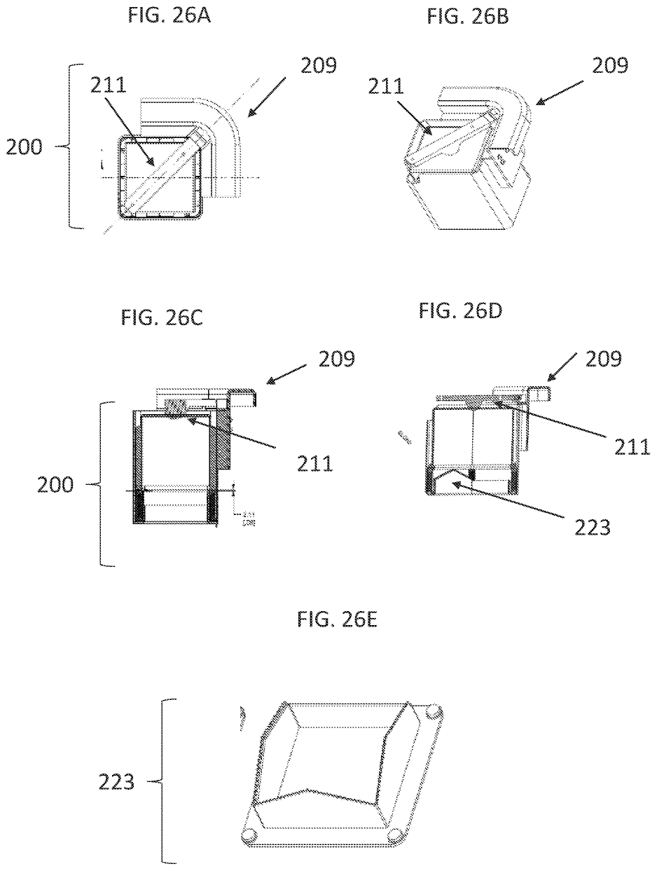

FIG. 25 and FIG. 26A-E show different views and components of a seed treatment dispenser which may be attached to a seed storage container (for example, a side wall or at the corner of a seed storage container). The seed treatment dispenser consists of an outer structure that holds an inner seed treatment reservoir. When the seed treatment dispenser is not activated, the inner seed treatment reservoir is kept above the bottom of the seed treatment dispenser by a holding device or devices that hold the seed treatment reservoir above a serrated edge or another sharp surface, that faces upward and is positioned near or at the bottom of the seed treatment dispenser. In some embodiments, the holding device may be a spring. In some embodiments, the holding device may be made of a material that is engineered to break or compress under the force created by the activation mechanism. In some embodiments, the holding device may move under the force created by the activation mechanism, allowing the seed treatment reservoir to lower. In some embodiments, the seed treatment reservoir may sit on a sealing plate that sits on a spring plate that sits on the holding device. The bottom of the seed treatment reservoir is made of a material that can be cut by a serrated edge, or another sharp surface, or has sections that have been prepared such that it can be cut by the serrated edge, or another sharp surface, when such sections come into contact with such serrated edge, or another sharp surface. The serrated or sharp edge may have a surface that is wholly (for example, 223 in FIG. 23) or partially (for example, 223 in FIG. 26D) parallel (or substantially parallel, for example less than 10 degrees difference) with the non-cutting edge of the cutting edge assembly. In other embodiments the cutting edge forms a point, such as shown in 223 of FIG. 26D or FIG. 26E. The angles comprising the point may be more or less steep than those pictured. In some embodiments one or more points may be positioned on a substantially straight edge (for example, as side of an approximately rectangular cutting mechanism such as is shown in FIG. 26E at 223). The cutting edge assembly may comprise a continuous cutting edge, for example as to completely cut out a shape from surface it cuts. Alternately a cutting edge assembly comprises one or more cutting edges adjacent to non-cutting surfaces. For example, a cutting edge assembly may have three non-continuous cutting edges positioned around three sides of a rectangular shaped assembly, a cutting edge assembly may comprising cutting edges positioned in an x-shape, a cutting edge may be half or three-quarters of a circle, a rectangular cutting assembly may have two cutting edges positioned on opposite or adjacent sides, a rectangular cutting assembly may have one or more sets of cutting edges positioned to cut one or more corners, etc.

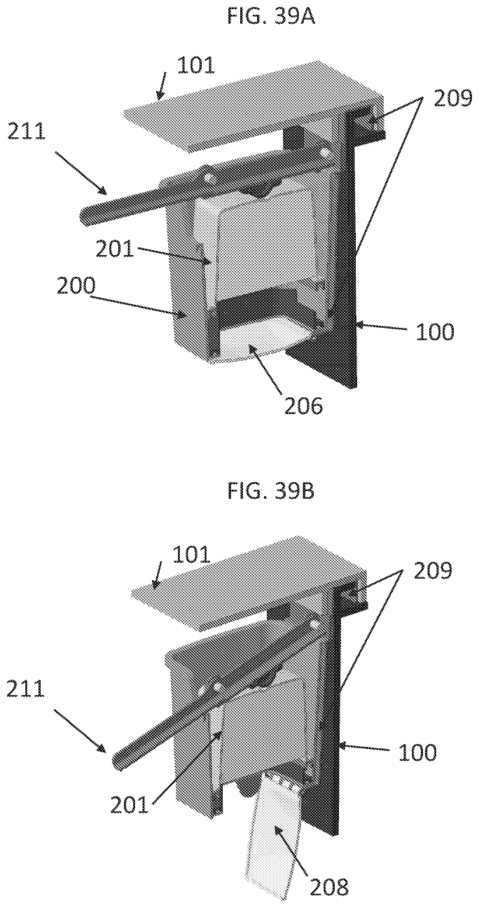

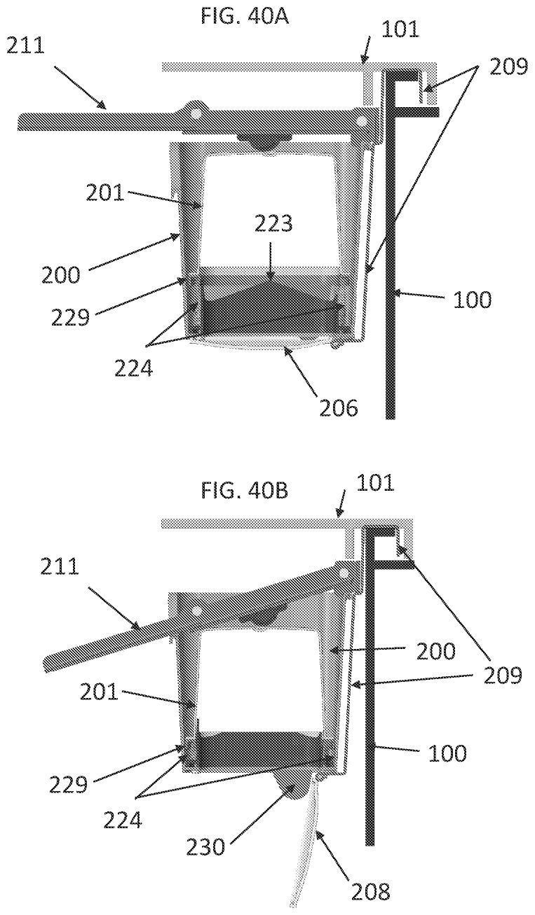

The activation mechanism for the seed treatment dispenser shown in FIGS. 22-26 and 39-41 is a levered arm that pushes down on the seed treatment reservoir when force is applied to it. In some embodiments, the activation arm may be automatically activated by an attachment connected to the end of the activation arm by a rod or a flexible cord that creates force on one end of the activation arm when the seed is emptied out of the seed box, causing the activation mechanism to exert downward pressure on the seed treatment dispenser. This causes the seed treatment reservoir to push down on the holding device and causing the bottom of the seed treatment reservoir to be cut by the serrated edge, or another sharp surface, on the inner bottom of the seed treatment dispenser that effectuates release of the seed treatment. In some embodiments, the activation arm may be connected to a cord that would allow for manual activation. An outer surface of a seed treatment dispenser or seed treatment outer housing 227 may have a channel through which the activation arm may travel when depressed, examples of this are shown in FIG. 25, FIG. 26B, FIG. 26D, FIGS. 39A-39B, FIG. 40B, and FIG. 41. The channel may extend for through all or part of the seed treatment dispenser or seed treatment outer housing 227.

In some embodiments, the attachment 209 hangs on the side wall of the seed storage container. In some embodiments, the mount spans across the top of the seed treatment dispenser and the seed treatment dispenser is positioned at the top middle of the seed storage container. In some embodiments, the seed treatment dispenser may have a design with a greater width than the examples in FIG. 25 and FIG. 26A-E, for example, substantially the full length of a seed storage container.

FIG. 25 shows an exemplary fastener 209 that may be used to secure a seed treatment dispenser in the corner of a seed storage container. The fastener in FIG. 25 shows an extended hook covering approximately perpendicular walls of a seed storage container. In some embodiments the fastener for a corner mounted seed treatment dispenser may comprise one or more hooks, for example at least one hook to extend over the edge of one wall of the seed storage container.

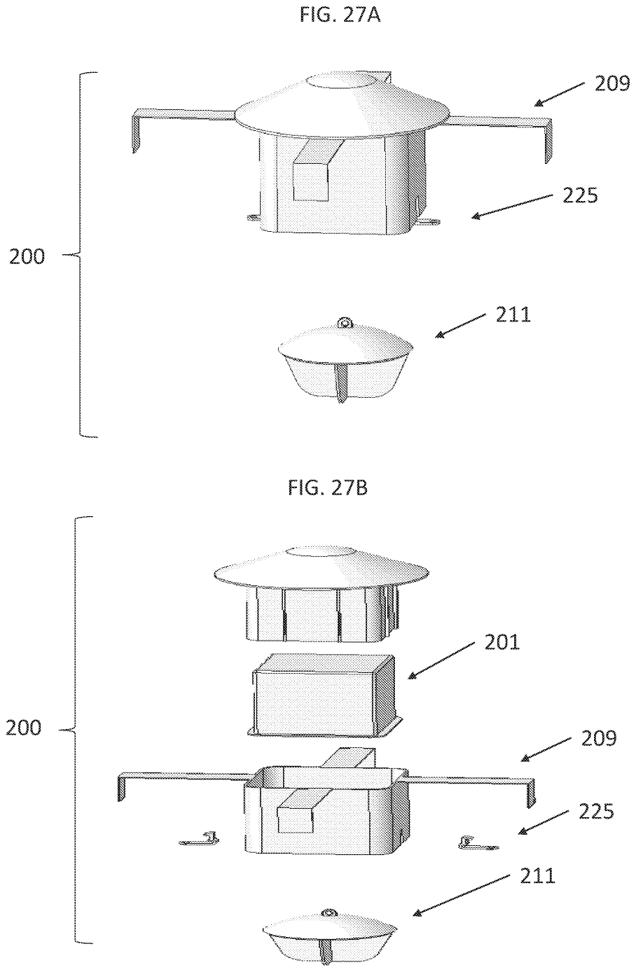

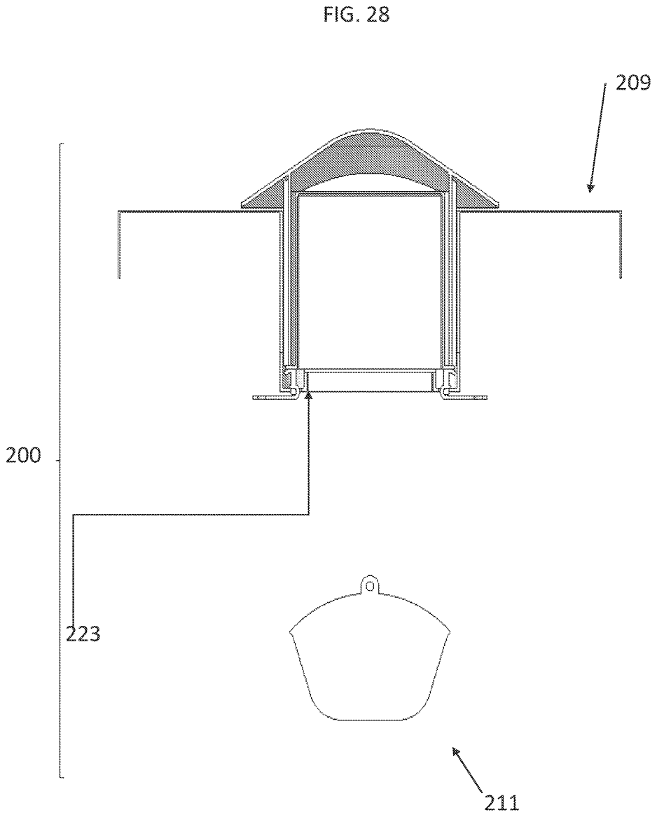

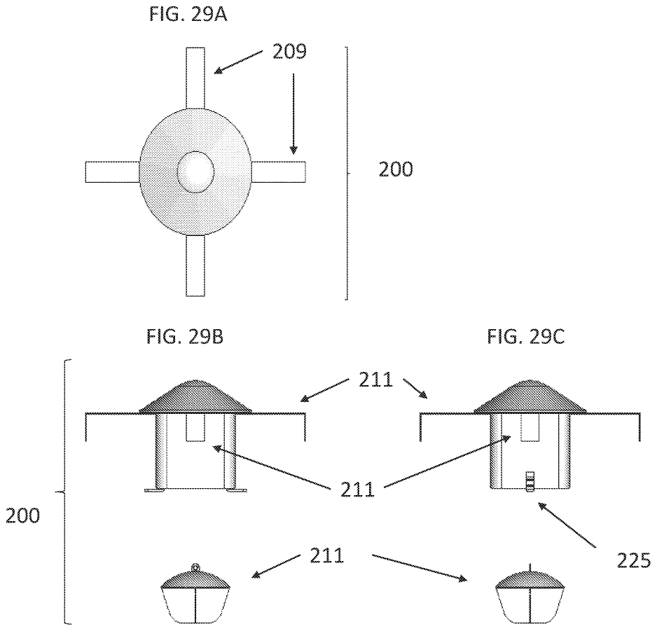

FIGS. 27A-B, 28 and 29A-C show different views of an exemplary center mounted seed treatment dispenser that may be attached to the center of a seed storage container. The seed treatment dispenser consists of an outer structure that holds an inner seed treatment reservoir, sitting on safety clips that hold the seed treatment reservoir above the bottom of the seed treatment dispenser. The safety clips hold the seed treatment reservoir above a serrated edge, or another sharp surface, connected near or at the bottom of the seed treatment dispenser that face upward. In some embodiments, the serrated edge or the sharp surface is a removable component of the seed treatment dispenser. The bottom of the seed treatment reservoir is made of a material that can be cut by the serrated edge, or another sharp edge, or has sections that have been prepared such that it can be cut by a serrated or another sharp edge when such sections come into contact with such sharp edge. The activation mechanism for the seed treatment dispenser hangs below the seed treatment reservoir, connected to the safety clips by rods or flexible cords. In some embodiments, the activation mechanism may be automatically activated when the seed is emptied out of the seed box, causing the activation mechanism to lower and pull out the safety clips, thus causing the seed treatment reservoir to push down against the sharp edge and resulting in the bottom of the seed treatment reservoir to be cut by the sharp edge at or near the bottom of the seed treatment dispenser that effectuates release of the seed treatment. In some embodiments, the activation arm may be connected to a cord that would allow for manual activation.

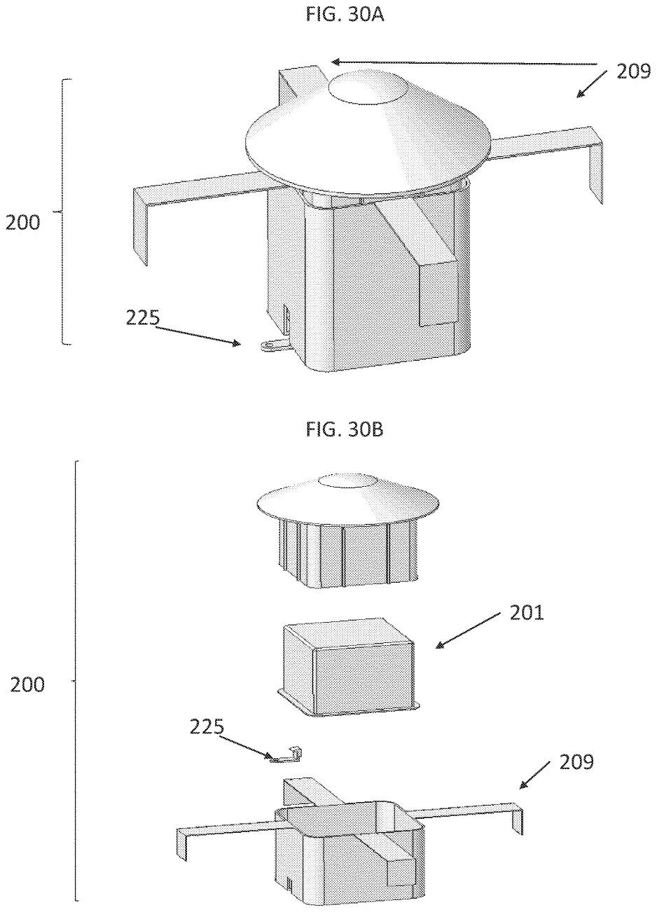

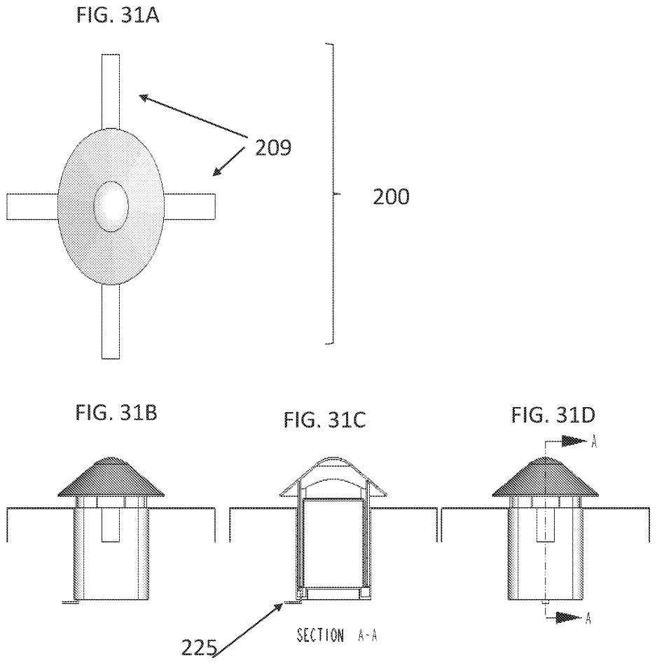

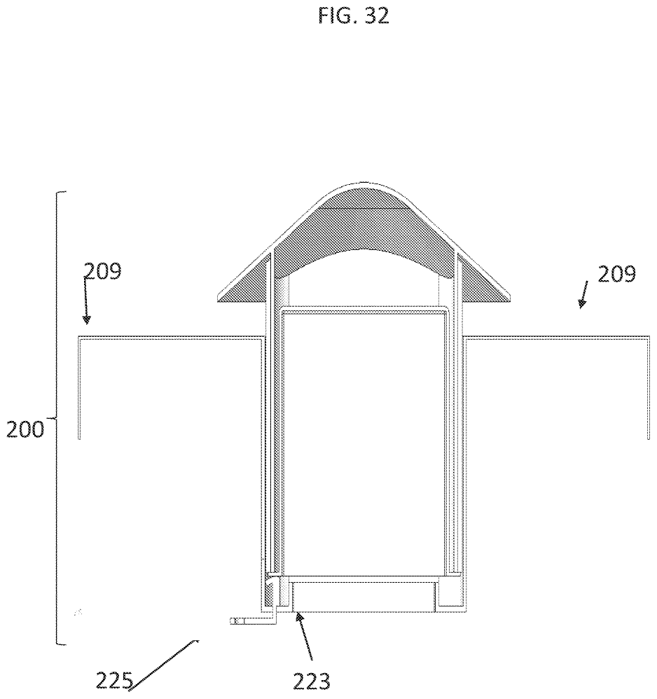

FIGS. 30A-B, 31A-D and 32 show different views of an exemplary center mounted seed treatment dispenser having an automatic activation system. The seed treatment dispenser consists of an outer structure that holds an inner seed treatment reservoir, sitting on a safety clip that holds the seed treatment reservoir above the bottom of the seed treatment dispenser. The safety clip holds the seed treatment reservoir above a serrated edge, or another sharp edge, facing upward that is near or at the bottom of the seed treatment dispenser. The bottom of the seed treatment reservoir is made of a material that can be cut by a serrated edge, or another sharp edge, or has sections that have been prepared such that it can be cut by a serrated edge, or another sharp edge, when such sections come into contact with such edge. In some embodiments, the safety clip is removed after the seed container has been filled by means of being connected to a flexible cord that can be pulled. In some embodiments, the safety clip is removed prior to dispensing the seed from the seed storage container. The activation mechanism for the seed treatment dispenser is the cap. The activation mechanism may be automatically activated when the seed is emptied out of the seed box, causing the activation mechanism to lower, thus causing the seed treatment reservoir to push down against the serrated edge, or another sharp edge, and resulting in the bottom of the seed treatment reservoir to be cut which effectuates release of the seed treatment.

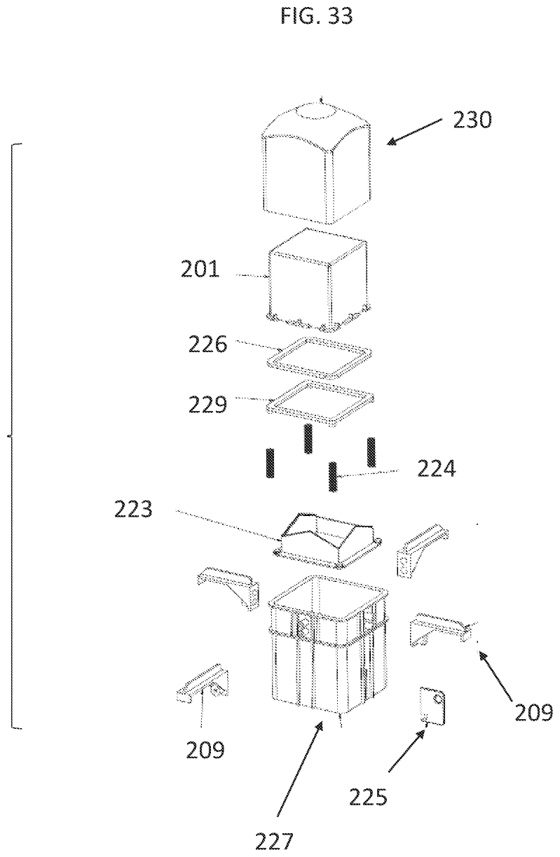

FIG. 33 shows an angle side view of the individual components of an exemplary center mounted seed treatment dispenser having an automatic activation system. The seed treatment dispenser consists of an outer housing structure that holds an inner seed treatment reservoir, sitting on a safety clip that holds the seed treatment reservoir above the bottom of the seed treatment dispenser. When the seed treatment dispenser is not activated, the inner seed treatment reservoir is kept above the bottom of the seed treatment dispenser by a holding device or devices that hold the seed treatment reservoir above a serrated edge or another sharp surface, that faces upward and is positioned near or at the bottom of the seed treatment dispenser. In some embodiments, the holding device may be a spring. In some embodiments, the holding device may be made of a material that is engineered to break or compress under the force created by the activation mechanism. In some embodiments, the holding device may move under the force created by the activation mechanism, allowing the seed treatment reservoir to lower. In some embodiments, the seed treatment reservoir may sit on a sealing plate that sits on a spring plate that sits on the holding device. The safety clip prevents the seed treatment dispenser from releasing the seed treatment. The bottom of the seed treatment reservoir is made of a material that can be cut by a serrated edge, or another sharp edge, or has sections that have been prepared such that it can be cut by a serrated edge, or another sharp edge, when such sections come into contact with such edge. In some embodiments, the safety clip is removed after the seed container has been filled by means of being connected to a flexible cord that can be pulled. In some embodiments, the safety clip is removed prior to dispensing the seed from the seed storage container. The activation mechanism for the seed treatment dispenser is the cap. The activation mechanism may be automatically activated when the seed is emptied out of the seed box, causing the activation mechanism to lower, thus causing the seed treatment reservoir to push down against the serrated edge, or another sharp edge, and resulting in the bottom of the seed treatment reservoir to be cut which effectuates release of the seed treatment.

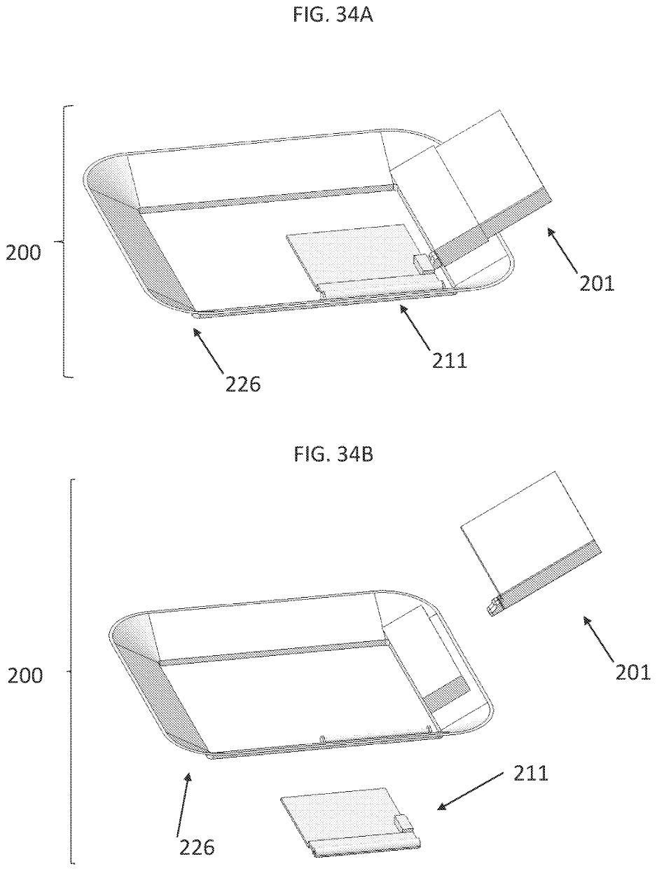

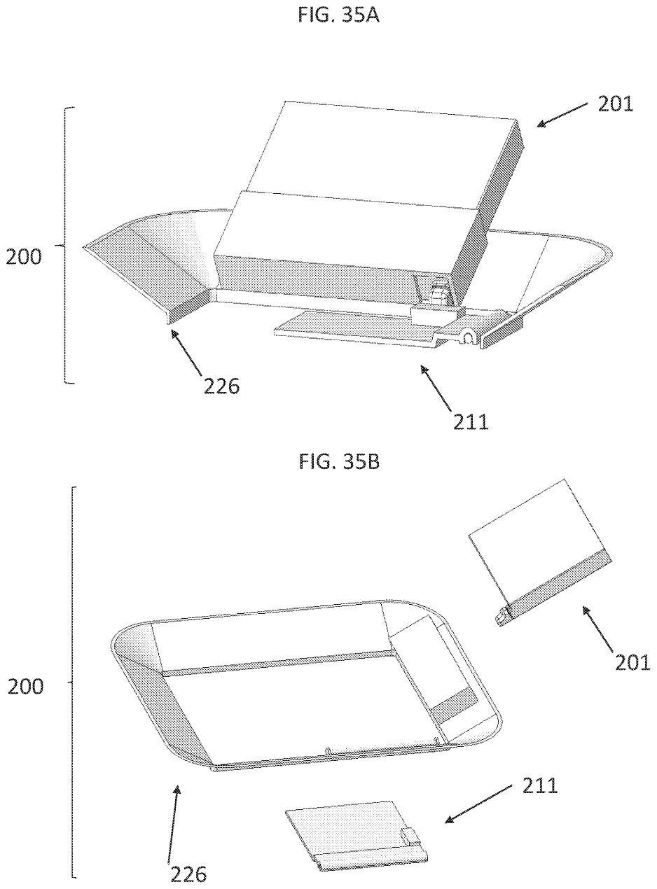

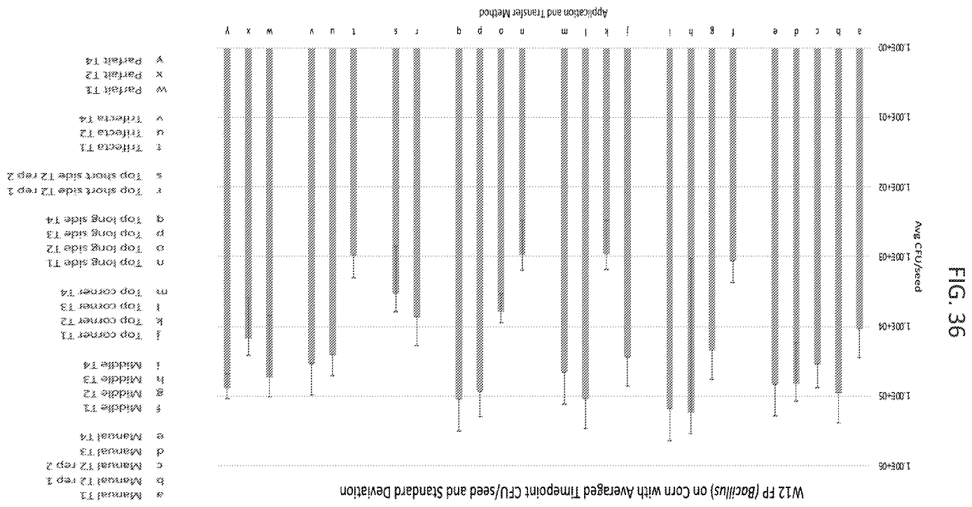

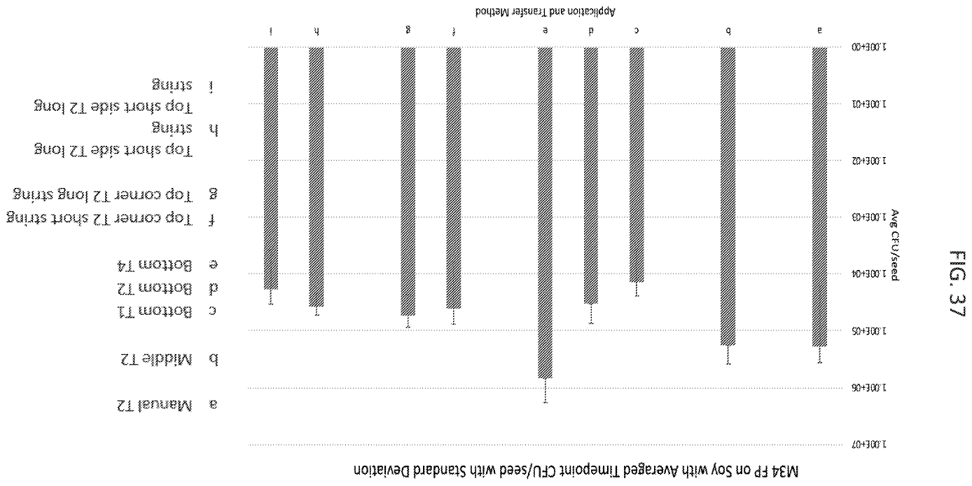

FIGS. 34A-B and 35A-B show different views of an exemplary seed treatment dispenser that mounts on the inner bottom of a seed storage container. The seed treatment reservoir is attached at an angle near the opening through which seed is dispensed from the seed storage container. The seed treatment reservoir is attached to the activation mechanism which, in turn, is attached to the slide gate of the seed storage container. When the slide gate of the seed storage container is opened, the activation mechanism pulls open a section of the seed treatment reservoir, thus effectuating the release of the seed treatment.

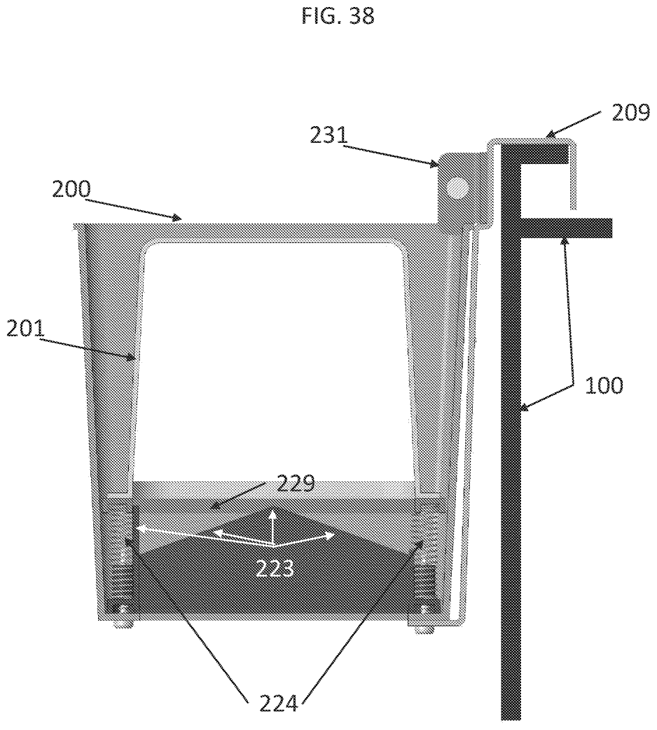

FIG. 38 is a cross sectional side view of an exemplary top mounted seed treatment dispenser showing a removable seed treatment reservoir 201 installed over a sharp edge 223 for piercing the seal covering the opening in the seed treatment reservoir through which seed treatment is dispensed. In some embodiments, the surface comprising the sharp edge forms a continuous surface oriented to the interior of springs and sized to fit within an interior opening of the spring plate.

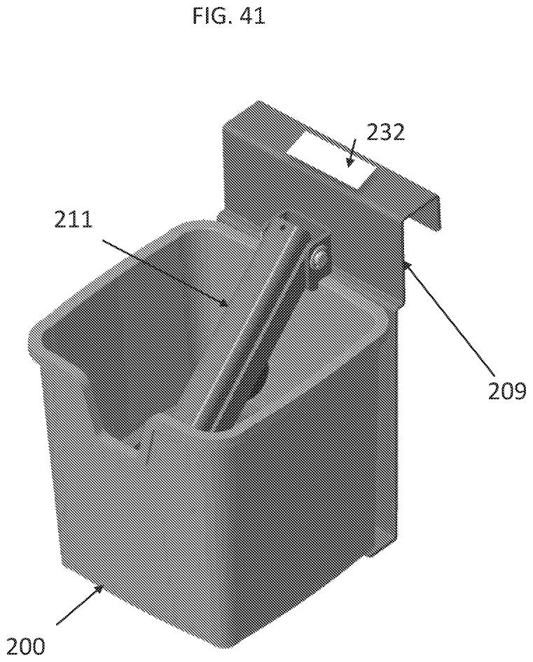

FIG. 38 also shows an exemplary connection of a fastener to the seed treatment device. In this embodiment the fastener is separable from the seed treatment device, but in other embodiments the fastener and seed treatment device may be integrated into a single unit. In this embodiment the fastener comprises a connection point 231 for an activation mechanism. This example also shows a design by which the wall off the seed treatment dispenser fits under the connection point 231 and the bottom edge of the seed treatment dispenser is supported by the fastener 209. Optionally the fastener is steel, for example powder coated steel. In an alternative embodiment the fastener comprises a hook fitting over an edge of a seed storage container and is friction fit into an extension of the fastener extending wholly or partially around or under the outer surface of the seed treatment dispenser. In some embodiments, the portion of the fastener fitting over the side of a seed storage box and under a lid of a seed storage box is 1-5 mm, 1.5-3, 2-4 mm, 3-5 mm in thickness. Optionally, the portion of the fastener fitting over the side of a seed storage box and under a lid of a seed storage box may comprise an opening through which a pin or latch for securing the lid of a seed storage container to the wall of the seed storage container may pass, for example refer to 232 in FIG. 41.

Optionally the seed treatment dispenser comprises a lid covering an opening through which seed treatment is dispensed 206 in addition to a covering over the opening of the seed treatment reservoir through which seed treatment is dispensed. Optionally the additional lid is positioned on a one-way hinge opening away from the interior of the seed treatment dispenser so that seed treatment may be dispensed when the seed treatment device is activated, but seeds will not enter the seed treatment dispenser. The lid may contain perforations. The perforations on the lid are optionally smaller in diameter than the average diameter of the type of seed to be loaded into the seed treatment dispenser. The upper surface of the lid has one or more extensions capable of breaking clumps of seed treatment falling onto the extensions.

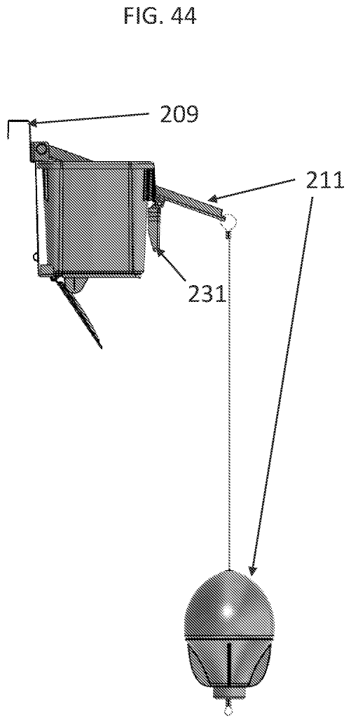

In some embodiments the activation mechanism comprises an activation arm (e.g. lever), optionally activated by an anchor attached by a rigid or pliable tether (for example, see FIG. 44). In some embodiments the anchor has a bell or cone shape, and is capable of generating a force of at least 4 pounds, at least 5 pounds, between 5-10 pounds (inclusive), at least 6 pounds, at least 7 pounds, between 7-9 pounds (inclusive), at least 8 pounds, or at least 9 pounds, when engaged with seed being dispensed from a seed storage container. In some embodiments, the anchor weight at least 1, 2, 3, 4, 5 pounds. In some embodiments, the tether is a least 24 inches, at least 28 inches, at least 30 inches, between 30-26 inches, at least 32 inches, at least 34 inches, or at least 36 inches, in length. The lever may extend beyond the outer dimension of the seed treatment dispenser (for example, in FIG. 39A and FIG. 39B, or FIG. 23ABC) or may not extend beyond the outer dimension of the seed treatment dispenser (for example, in FIG. 26ABCD), and optionally may be capable of folding such that it may fit within the outer walls of the seed treatment dispenser when not in use. FIG. 39A shows an example of foldable activation arm 211 shown in an extended state. The activation arm of FIGS. 39A and 39B has an extension along the bottom surface that applies force centrally to the surface of the seed treatment reservoir opposite the opening through which the seed treatment is dispensed.

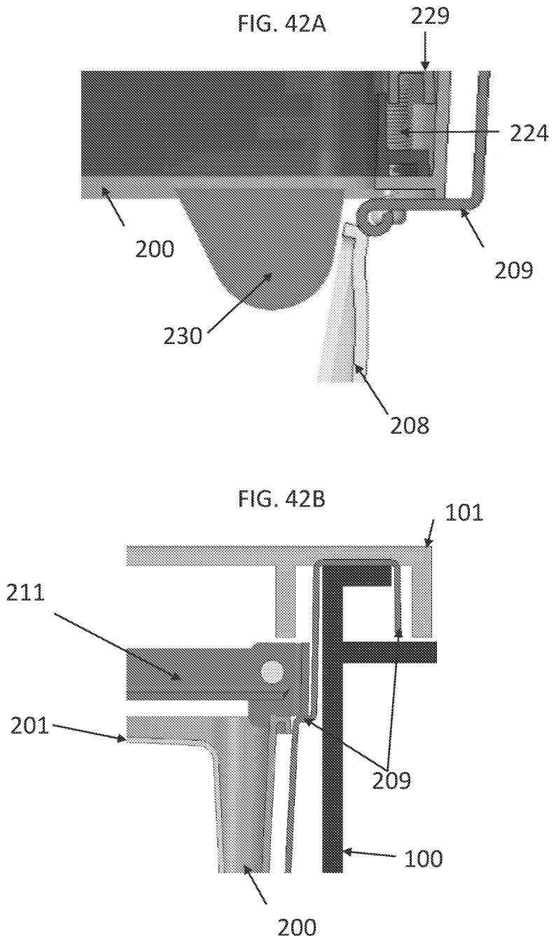

FIG. 39A and FIG. 39B also shows an example of an extension 230 (optionally of the spring plate 229) that is lowered when downward force is applied on the seed treatment reservoir, optionally, and as shown in this example, by an activation arm. The movement of the extension pushes the extension 230 against the lid 206 resulting in opening of the lid. In some embodiments, the spring plate comprises one or more integrated extensions of for opening a lid covering an opening in the seed treatment dispenser through which seed treatment is dispensed. An example of an extension 230 is also shown in FIG. 42B. FIG. 42B shows a partial sectional view of a seed treatment dispenser 200 in the activated state. The springs 224 are compressed and extension 230 extends below the bottom surface of the seed treatment dispenser and has pressed against the lid in the open position 208.

A seed treatment dispenser may not comprise a seed treatment reservoir, which can be a separate, removable, consumable. An exemplary seed treatment dispenser without seed treatment reservoir is shown in FIG. 41. FIG. 41 also shows an example of a fastener 209 extending the entire width of the seed treatment reservoir (though optionally a fastener may extend less than the full width of the seed treatment dispenser or a fastener may extend beyond the width of the seed treatment dispenser). The fastener 209 shown also shows a cut out in the upper surface of the fastener. A fastener with a cut out may be further secured to the seed storage container by positioning the cutout over a passage through which a pin or other device for securing a lid of a seed treatment box may pass; insertion of the pin for securing the lid thus also secures the seed treatment dispenser to the seed storage container preventing the seed treatment dispenser from shifting during transportation or storage.

FIG. 42B shows a partial sectional view of a seed treatment dispenser 200, comprising a seed treatment reservoir, secured in a seed storage container 100 by a fastener 209 extending over a side wall of the seed treatment dispenser and under the lid 101 of the seed storage container. As shown the activation arm 211 fits below the lower edge of the lid 101. Optionally top corner of the end of the activation arm secured to the seed treatment dispenser or fastener is rounded or beveled such that it does not interfere with (e.g. touch) the lower side of the lid when the free end of the activation arm is depressed. In some applications it may be desirable to prevent dispensing of seed treatment while the lid of the seed storage container is attached to the seed storage container, in this top corner of the end of the activation arm secured to the seed treatment dispenser or fastener should not rounded or beveled and a top surface of the activation arm should sit flush with a bottom edge of the lid of the seed storage container such that the activation arm will not rotate when force is applied to the free end of the activation arm.

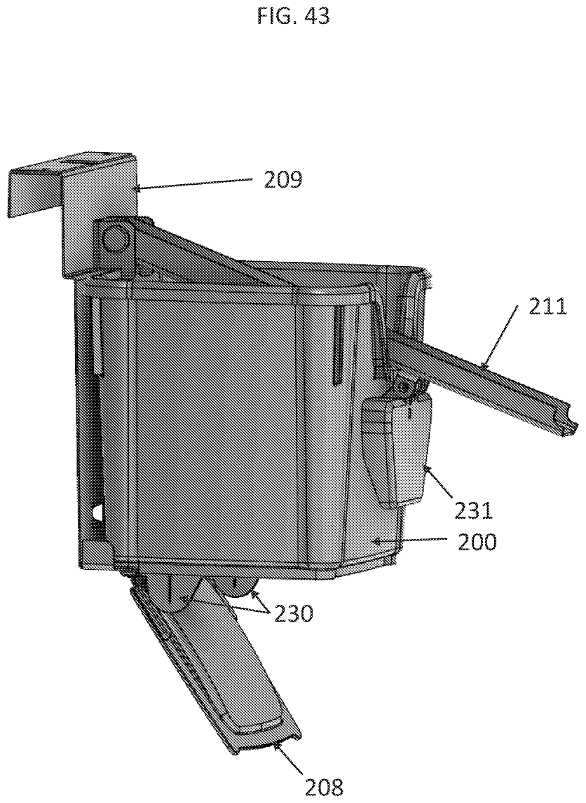

Some seed treatment dispensers described herein comprise a lower wall or opening within a top of a side surface of the dispensers (such as opening 240) through which an activation arm may pass when activated. In some embodiments the lower wall is covered when the arm is in an inactivated state, for example by one or more brushes or flexible material or by a cover 231 as shown in FIG. 43 and FIG. 44. The opening allows the activation arm to apply greater pressure onto the seed treatment reservoir, better enabling the seed treatment to flow from the seed treatment reservoir.

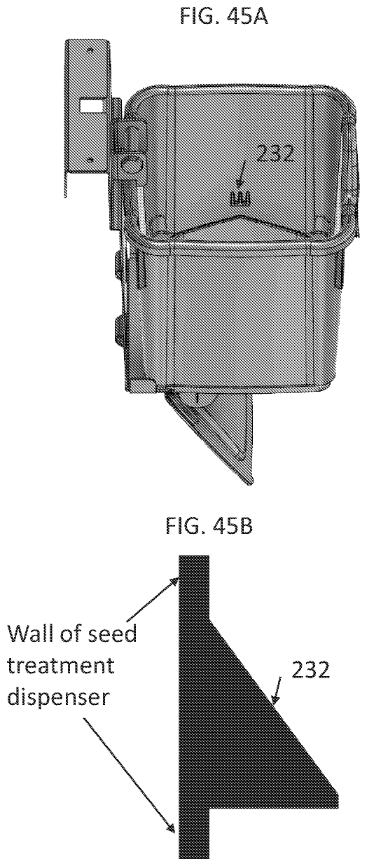

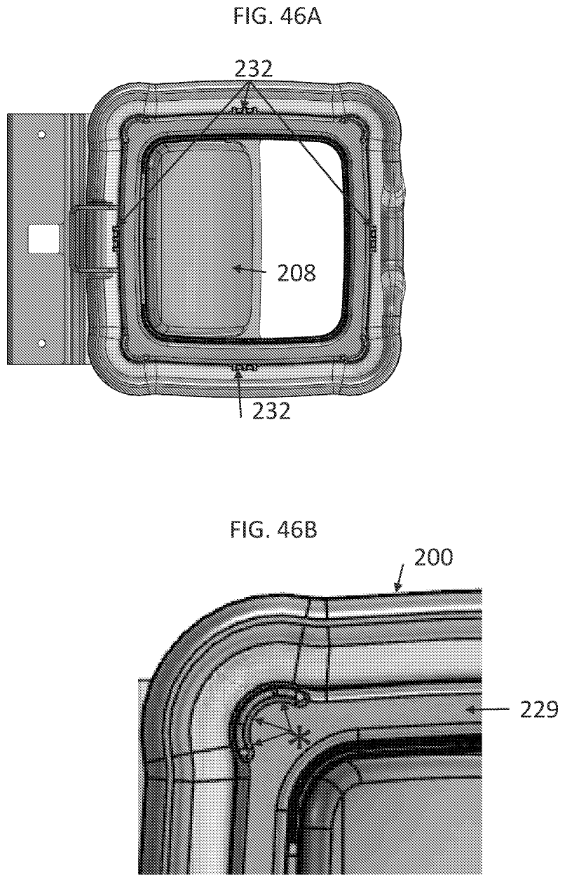

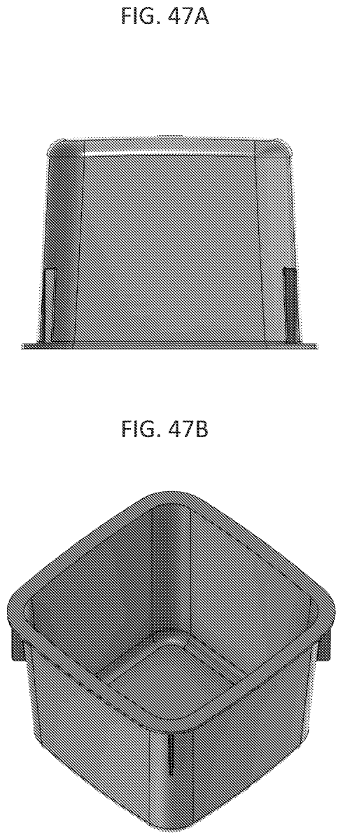

Some seed treatment dispensers are configured to accept a fully removeable seed treatment reservoir (examples are shown in FIGS. 47A and 47B). For many seed treatment dispensers configured to accept a removable seed treatment reservoirs (such as seed treatment pods), it is important for the efficient dispensing of seed treatment that the seed treatment reservoir be consistently installed relative to a cutting edge capable of opening the seed treatment reservoir when activated. One mechanism for maintaining a consistent orientation of a seed treatment reservoir when installed in a seed treatment device is one or more catches on a wall of the seed treatment dispenser that maintain the seed treatment reservoir in place during transportation, examples are shown in FIG. 45A and FIG. 46A. An integral catch 232 such as shown in FIG. 45A, FIG. 45B and FIG. 46A is tapered so that a seed treatment reservoir may be pushed over the catch during installation in the seed treatment device, but has a flat or less tapered edge side so that the device is not easily tilted or pushed out during transportation. Another mechanism to assist in maintaining a removeable seed treatment reservoir in a seed treatment dispenser are corresponding channels or curves in the seed treatment reservoir and seed treatment dispenser. An example is shown in FIG. 46A and FIG. 46B. These figures show an example of a seed treatment dispenser having curved walls wherein the curved walls create a channel fitting the corresponding shape of the corner of a spring plate upon which the removeable seed treatment reservoir may be placed. In some embodiments, one or more regions a spring plate may be raised to create a barrier to prevent an installed removeable seed treatment reservoir from sliding out of alignment, an example is shown in FIG. 46A and FIG. 46B.

In some embodiments, the seed treatment dispenser is reversibly attached to a seed storage container, by one or more of the following: a mechanical attachment or one or more adhesives. In some embodiments, at least one component of the seed treatment dispenser is integral (forms one piece) with the seed storage container. For example, at least one component of the seed treatment dispenser (including, for example, a fastener, seed treatment reservoir, activation mechanism, tether, etc.) can be molded into a lid of a seed storage container, molded into a wall (e.g. a side wall of an upper segment or a base) of a seed storage container, is molded into the sides of an opening through which seed is dispensed, is molded into a structure under the opening through which seed is dispensed, etc.

### EXAMPLES

### Example 1. Dispersal and Recovery of Microbial Treatments

This example and the following table describe exemplary rates of application and recovery of microbial products added to corn and soybean seeds in seed storage containers either via seed treatment dispensers or manual application of microbial products. Microbial products in this example were flowable powders.

TABLE 1
Description of application method of flowable powder microbial product.
Application Methods

| Name | Description |
|---|---|
| Manual | Evenly sprinkling FP on top of seed in application box |
| Top corner | Seed treatment dispenser mounted on top in corner of |
| | application box |
| Top long side | Seed treatment dispenser mounted on top in center of the |
| | long side of the application box |
| Top short side | Seed treatment dispenser mounted on top in center of the |
| | short side of the application box |
| Middle | Seed treatment dispenser mounted on cross braces in |
| | middle of application box |
| Bottom | Plastic tube mounted against cross braces with exit of |
| | tube near gate and sloped bottom of application box |
| Trifecta | Manual method with FP applied on top of seed at the |
| | corner, center of the long side, and center of the short |
| | side of the application box |
| Parfait | Manual method with FP evenly sprinkled on seed after |
| | ⅓ application box filled, after ⅔ application box filled, |
| | and after application box full |

TABLE 2
Description of transfer method of seeds after application of
flowable powder microbial product.
Transfer Methods

| Name | Description |
|---|---|
| T1 | Sample out of application box |
| T2 | Application box to second box, sample out of second box |
| T3 | Application box to bulk tender, sample out of auger on bulk tender |
| T4 | Application box on box tender, sample out of auger on box tender |

TABLE 3
Description of time at which seeds samples were collected.
Sample Time

| Name | Description |
|---|---|
| A | Seed sample after approximately 10% fill in collection box |
| B | Seed sample after approximately fills to cross braces of |
| | collection box |
| C | Seed sample after approximately 80% fill in collection box |
| D | Seed sample from top layer of seed in collection box |

Flowable powder microbial products were added to seed storage containers containing previously untreated soy or corn seeds using one of the application methods described in Table 1. A seed storage container in which the treatment is applied (either manually or via a seed treatment dispenser) is referred to in this example as the application container. The samples of seeds from the application container (after application of the seed treatment) were collected either directly from the application container, out of a second seed storage container into which the contents of the application container had been transferred, or out of a auger on bulk tender where the contents of the application container were transferred to a bulk tender, or out of a auger on box tender where the contents of the application container were transferred to a box tender (as described in Table 2). The samples were collected at times indicated in Table 3, which describe the sampling time relative to the transfer of seeds to a collection box (e.g. seed storage container, bulk tender, or box tender). Treated seeds were collected in sterile containers to sterile buffer was added (e.g. MOPS, PBS, tris, etc.). The tubes were vortexed at high speed for 5-15 minutes. The liquid fraction was serially diluted and plated on agar plates. Agar plate types could include TSA, PDB, NA, R2B, etc. depending on the organism. Plates were incubated at room temperature to 37° C. for 1-5 days, colonies were counted, and colony forming units (CFU)/g was calculated. Results are included in Table 4.

TABLE 4
Average dose of microbial treatment detected by crop
type, application method, and transfer method.

| | | | | Averaged | |
|---|---|---|---|---|---|
| | | Application | Transfer | Timepoint Dose | StDev |
| Product | Crop | Method | Method | (CFU/seed) | CFU/seed |
| W12 FP | Corn | Manual | T1 | 1.08E+04 | 17414.19 |
| W12 FP | Corn | Middle | T1 | 1.14E+03 | 1224.95 |
| W12 FP | Corn | Top corner | T1 | 2.78E+04 | 43897.65 |
| W12 FP | Corn | Top long side | T1 | 9.46E+02 | 638.64 |
| W12 FP | Corn | Trifecta | T1 | 9.42E+02 | 1107.60 |
| W12 FP | Corn | Parfait | T1 | 5.47E+04 | 47658.19 |
| W12 FP | Corn | Manual 2 reps | T2 | 6.24E+04 | 96074.77 |
| | | averaged | | | |
| W12 FP | Corn | Middle | T2 | 2.20E+04 | 35764.38 |
| W12 FP | Corn | Top corner | T2 | 9.29E+02 | 626.86 |
| W12 FP | Corn | Top long side | T2 | 6.15E+03 | 2693.50 |
| W12 FP | Corn | Top short side | T2 | 5.42E+03 | 7153.74 |
| | | 2 reps averaged | | | |
| W12 FP | Corn | Trifecta | T2 | 2.53E+04 | 26252.10 |
| W12 FP | Corn | Parfait | T2 | 1.51E+04 | 11176.89 |
| W12 FP | Corn | Manual | T3 | 6.79E+04 | 50471.50 |
| W12 FP | Corn | Middle | T3 | 1.73E+05 | 171975.09 |
| W12 FP | Corn | Top corner | T3 | 1.09E+05 | 182571.71 |
| W12 FP | Corn | Top long side | T3 | 8.59E+04 | 112524.49 |
| W12 FP | Corn | Manual | T4 | 6.88E+04 | 125639.92 |
| W12 FP | Corn | Middle | T4 | 1.53E+05 | 286407.62 |
| W12 FP | Corn | Top corner | T4 | 4.64E+04 | 84165.40 |
| W12 FP | Corn | Top long side | T4 | 1.12E+05 | 205123.47 |
| W12 FP | Corn | Trifecta | T4 | 3.43E+04 | 61540.91 |
| W12 FP | Corn | Parfait | T4 | 7.82E+04 | 30667.16 |

The figures depict various embodiments for purposes of illustration only. One skilled in the art will readily recognize from the following discussion that alternative embodiments of the structures and methods illustrated herein may be employed without departing from the principles described herein. In light of the above disclosure, persons skilled in the relevant art can appreciate that many modifications and variations are possible.

1. A seed treatment dispenser, wherein the seed treatment comprises:
at least one seed treatment reservoir,
at least one opening through which seed treatment is dispensed, and
an activation mechanism.

2. The seed treatment dispenser of claim 1, wherein the volume of the seed treatment reservoir is less than 3 cubic feet, between 18 cubic feet and 0.001 cubic feet, between 3 cubic feet and 0.01 cubic feet, between 2-3 cubic feet, between 2-1 cubic feet, between 1-0.5 cubic feet, between 0.5-0.05 cubic feet, or between 0.05-0.01 cubic feet.

3. The seed treatment dispenser of claim 1, wherein the volume of the seed treatment reservoir is at least 5 volumetric ounces, between 10-300 volumetric ounces, between 10-25 volumetric ounces, between 15-30 volumetric ounces, at least 20 volumetric ounces, between 15-30 volumetric ounces, between 30-50 volumetric ounces, between 30-80 volumetric ounces, at least 50 volumetric ounces, between 45-75 volumetric ounces, at least 70 volumetric ounces, between 80-200 volumetric ounces, at least 100 volumetric ounces, between 10-200 volumetric ounces, or at least 200 ounces.

4. The seed treatment dispenser of claim 1, wherein the seed treatment dispenser comprises a plurality of reservoirs.

5. The seed treatment dispenser of claim 4, wherein each seed treatment reservoir is completely separated from all other reservoirs.

6. The seed treatment dispenser of claim 5, wherein completely separated means flow of seed treatments, flow of gases, and or flow of moisture between reservoirs is blocked.

7. The seed treatment dispenser of claim 1, wherein the seed treatment dispenser comprises a plurality of reservoirs, and each reservoir has the same volume.

8. The seed treatment dispenser of claim 1, wherein the seed treatment dispenser comprises a plurality of reservoirs, wherein at least one reservoir has a larger or smaller volume.

9. The seed treatment dispenser of claim 1, wherein the seed treatment dispenser comprises at least one seed treatment within at least one seed treatment reservoir.

10. The seed treatment dispenser of claim 9, wherein at least one seed treatment is a fertilizer, micronutrients, seed lubricant, insecticide, fungicide, herbicide, enzyme, flowability enhancer, biostimulant, living biological treatment, living biological treatments, non-living biological treatments such as a metabolite or by-product of a biological organism, or combination thereof.

11. The seed treatment dispenser of claim 9, wherein at least one seed treatment is a solid or liquid.

12. The seed treatment dispenser of claim 11, wherein the solid is a powder, granule, particulate, or pellet.

13. The seed treatment dispenser of claim 1, wherein the seed treatment dispenser comprises at least one activation indicator.

14. The seed treatment dispenser of claim 12, wherein at least one activation indicator is a colored compound.

15. The seed treatment dispenser of claim 1, wherein the seed treatment dispenser comprises at least one activation indicator within at least one seed treatment reservoir.

16. The seed treatment dispenser of claim 1, wherein the seed treatment dispenser comprises at least one activation indicator within at least one seed treatment reservoir and at least one seed treatment within at least one seed treatment reservoir.

17. The seed treatment dispenser of claim 16, wherein the activation indicator is dispensed after one or more seed treatment, such that detection of the activation indicator verifies that all of the one or more seed treatments have been dispensed.

18. The seed treatment dispenser of claim 4, wherein a single seed treatment is loaded into more than one reservoir.

19. The seed treatment dispenser of claim 4, wherein a different seed treatment or indicator is loaded into at least one seed treatment reservoir.

20. The seed treatment dispenser of claim 1, wherein the seed treatment reservoir comprises one or more polyesters, polyethylene, polystyrene, polyamides (nylon), polyacrylonitrile butadiene (ABS), polylactic acid, aluminum (e.g., foils or sheet), stainless steel, silicone, polylactic acid (PLA), bio-composite (for example, bio-composites comprising polylactic acid and microcrystalline cellulose, polylactic acid and cellulose nanocrystal, gelatin, etc.), cellulose-base bio-plastics, or combinations thereof.

21. The seed treatment dispenser of claim 1, wherein the seed treatment reservoir comprises one or more layers.

22. The seed treatment dispenser of claim 1, wherein the one or more layers are an adhesive laminated material having high oxygen and moisture barrier properties, metallized polyester, linear low-density polyethylene, polyester, aluminum foil, or tri-laminate plastic.

23. The seed treatment dispenser of claim 1, wherein the seed treatment reservoir is constructed from a material having a moisture vapor transmission rate (MVTR) 0.02 g per 100 sq. inches per 24 hours, or lower.

24. The seed treatment dispenser of claim 1, wherein the seed treatment reservoir is constructed from a material having an oxygen transmission rate of 0.06 cubic centimeters per 100 sq. inches per 24 hours, or lower.

25. The seed treatment dispenser of claim 9 or 16, wherein the seed treatment is in direct contact with a seed treatment reservoir.

26. The seed treatment dispenser of claim 9 or 16, wherein the seed treatment is located within a secondary container within the seed treatment reservoir.

27. The seed treatment dispenser of claim 1, wherein the seed treatment reservoir is removable from a seed treatment dispenser.

28. The seed treatment dispenser of claim 1, wherein the seed treatment dispenser is reusable.

29. The seed treatment dispenser of claim 1, wherein the seed treatment dispenser comprises a reusable seed treatment reservoir.

30. The seed treatment dispenser of claim 1, wherein the seed treatment dispenser is reusable and comprises a disposable seed treatment reservoir.

31. The seed treatment dispenser of claim 1, wherein the seed treatment reservoir comprises at least one exterior surface between 0.025-10 mm in thickness.

32. The seed treatment dispenser of claim 1, further comprising a lid to cover at least one opening through which seed treatment is dispensed.

33. The seed treatment dispenser of claim 32, wherein the lid extends beyond outer dimension of the seed treatment reservoir in at least one dimension.

34. The seed treatment dispenser of claim 32, where the activation mechanism is integral to the lid.

35. The seed treatment dispenser of claim 1, wherein the activation mechanism is triggered automatically by dispensing seeds from a seed storage container comprising a seed treatment dispenser.

36. The seed treatment dispenser of claim 35, where in the activation mechanism is triggered automatically by extension of a slide gate covering the opening through which seed treatment is dispensed from a seed storage container.

37. The seed treatment dispenser of claim 36, where in the slide gate is mechanically or electronically connected to the seed treatment dispenser.

38. The seed treatment dispenser of claim 36, where in the activation mechanism is triggered by the movement of seeds out of a seed storage container through an opening in the bottom of the seed storage container.

39. The seed treatment dispenser of claim 1, wherein the activation mechanism is the widest dimension of the seed treatment dispenser.

40. The seed treatment dispenser of claim 9, wherein the seed treatment dispenser comprises a lid to cover at least one opening through which seed treatment is dispensed, wherein the activation mechanism is integral to the lid, and the lid is extended beyond the outer dimension of the seed treatment reservoir in at least one dimension.

41. The seed treatment dispenser of claim 40, wherein the seed treatment dispenser is configured to release seed treatment from the seed treatment reservoir automatically by the downward force of flowing seeds on the portions of the lid which extend beyond the widest dimension of the seed treatment reservoir.

42. The seed treatment dispenser of claim 40, wherein the portion of the lid extending beyond the widest dimension of the seed dispenser is perforated to allow seed treatment to pass through.

43. The seed treatment dispenser of claim 32, wherein the lid is held open or closed by a spring-loaded mechanism.

44. The seed treatment dispenser of claim 40, wherein the lid comprises one or more segments capable of covering the opening through which seed treatments are dispensed.

45. The seed treatment dispenser of claim 1, additionally comprising a plunger unit connected to an activation mechanism.

46. The seed treatment dispenser of claim 45, wherein the plunger unit comprises one or more seal.

47. The seed treatment dispenser of claim 1, additionally comprising an abrasion resistant tether.

48. The seed treatment dispenser of claim 47, wherein the tether is connected to one or more surface of the seed treatment dispenser.

49. The seed treatment dispenser of claim 48, wherein the one or more surface of the seed treatment dispenser is an exterior surface.

50. The seed treatment dispenser of claim 48, wherein the one or more surface of the seed treatment dispenser is an interior surface.

51. The seed treatment dispenser of claim 48, wherein the one or more surface of the seed treatment dispenser is an interior and an exterior surface.

52. The seed treatment dispenser of claim 48, wherein the one or more surface of the seed treatment dispenser comprises two exterior surfaces.

53. The seed treatment dispenser of claim 52, wherein the surfaces are an exterior surface of a seed treatment reservoir and an activation mechanism.

54. The method of claim 53, wherein the activation mechanism is an integrated lid covering an opening through which seed treatment can be dispensed and an activation mechanism.

55. The seed treatment dispenser of claim 47, wherein the tether is connected to a hook or stopper.

56. The seed treatment dispenser of claim 55, wherein the hook will engage with the side of the seed storage container.

57. The seed treatment dispenser of claim 55, wherein the stopper is secured by tether running under the lid of a seed storage container.

58. The seed treatment dispenser of claim 1, wherein the activation mechanism is a pull cord.

59. The seed treatment dispenser of claim 58, wherein the pull cord comprises a first region wherein, in the inactivated state, the pull cord is integral to a surface of the seed treatment reservoir and a second region wherein the pull cord is not integral to a surface of a seed treatment reservoir.

60. The seed treatment dispenser of claim 59, wherein the second region of the pull cord is connected to a hook, handle, or stopper.

61. The seed treatment dispenser of claim 59, wherein the first and or second region of the pull cord can fit between a lid secured to a seed treatment container and an upper edge of an upper segment of a seed storage container.

62. The seed treatment dispenser of claim 59, wherein the first and second regions of the pull cord are adjacent and the cord continuous between the two regions.

63. The seed treatment dispenser of claim 59, wherein both ends of a second region of the pull cord are attached to the first region.

64. The seed treatment dispenser of claim 1, wherein the seed treatment dispenser comprising a hollow container in a rectangular, square, circular or shape, wherein the shape comprises a continuous perimeter having an empty center.

65. The seed treatment dispenser of claim 1, wherein the widest dimension of the seed treatment dispenser is larger than the largest opening between elements of a central support structure within as seed storage container.

66. The seed treatment dispenser of claim 1, wherein the largest opening is 24 inches or greater.

67. The seed treatment dispenser of claim 1, wherein the largest opening is 18 inches or greater.

68. The seed treatment dispenser of claim 1, wherein the largest opening is 12 inches or greater.

69. The seed treatment dispenser of claim 1, wherein the activation mechanism comprises discs that are attached to the bottom exterior surface of the seed treatment reservoir by a flexible cord or fixed rod wherein activation mechanisms extend at least 3 inches beyond a surface of the seed treatment reservoir, such that downward force exerted on the activation mechanisms by flow of seed out of the seed storage container in which the seed treatment container is positioned causes the separation of the bottom surface from the seed treatment reservoir and release of the seed treatment.

70. The seed treatment dispenser of claim 1, wherein at seed treatment dispenser comprises at least one component that is reusable.

71. The seed treatment dispenser of claim 1, wherein the seed treatment dispenser is reversibly attached to a seed storage container, by one or more of the following: a mechanical attachment or one or more adhesives.

72. The seed treatment dispenser of claim 71, wherein at least one component of the seed treatment dispenser is integral with the seed storage container.

73. The seed treatment dispenser of claim 72, wherein the least one component of the seed treatment dispenser is molded into a lid of a seed storage container.

74. The seed treatment dispenser of claim 72, wherein the least one component of the seed treatment dispenser is molded into a wall of a seed storage container.

75. The seed treatment dispenser of claim 74, wherein the wall is a side wall of a removeable upper segment of a seed storage container.

76. The seed treatment dispenser of claim 74, wherein the wall is a side wall of a base segment of a seed storage container.

77. The seed treatment dispenser of claim 72, wherein the least one component of the seed treatment dispenser is molded into the sides of an opening through which seed is dispensed.

78. The seed treatment dispenser of claim 1, wherein the activation mechanism is a levered arm that, when moved in a downward manner, pushes on the seed treatment reservoir causing it to release seed treatment.

79. The seed treatment dispenser of claim 78, wherein the bottom of the seed treatment reservoir is sealed with a material that when pushed against a sharp edge causes it to be cut open in order to release the seed treatment.

80. The seed treatment dispenser of claim 78, wherein the seed treatment reservoir consists of an outer container and an inner container with the inner container holding the seed treatment.

81. The seed treatment dispenser of claim 80, wherein the base of the inner container of the seed treatment reservoir is sealed with a material that, when pushed against a sharp edge, causes it to be cut open in order to release the seed treatment.

82. The seed treatment dispenser of claim 80, wherein the inner container of the seed treatment reservoir is on a pressure plate that keeps the bottom of the inner container at a pre-determined height above the base of the outer container of the seed treatment reservoir until downward pressure is applied on the inner container of the seed treatment reservoir causing the inner container and the pressure plate to move downward.

83. The seed treatment dispenser of claim 1, wherein the seed treatment dispenser has a safety clip that keeps the dispenser from releasing seed treatment until the safety clip is removed.

84. The seed treatment dispenser of claim 1, wherein the seed treatment reservoir has a section that is sealed with a material that opens to release the seed treatment when sufficient force is applied to it.

85. A method of preparing a treated seed comprising:
placing one or more of any of the seed treatment dispensers described herein inside an empty seed storage container, and
placing one or more seeds into the container.

86. A method of preparing a treated seed comprising:
placing one or more seeds into the container, and
placing one or more of any of the seed treatment dispensers described herein inside a seed storage container containing seeds.

87. A seed treatment system, comprising:
a seed container configured to hold seeds;
a seed treatment reservoir configured to hold seed treatment;
an output channel configured to allow treated seeds to flow out of the seed treatment system;
a coupling mechanism configured to couple the seed treatment reservoir to the seed container; and
an actuation mechanism configured to, when actuated, cause a release of seed treatment from the seed treatment reservoir into the seeds to produce the treated seeds.

88. The seed treatment system of claim 87, wherein the coupling mechanism couples the seed treatment reservoir to an interior of the seed container.

89. The seed treatment system of claim 88, wherein the seed treatment reservoir is entirely contained within the seed container.

90. The seed treatment system of claim 87, wherein the actuation mechanism is a lever, and wherein the lever is actuated by a flow of seeds through the seed container downward onto the lever.

91. The seed treatment system of claim 87, wherein the actuation mechanism is a lid covering an opening of the seed treatment reservoir, and wherein the lid is actuated by a flow of seeds through the seed container downward onto a portion of the lid.

92. The seed treatment system of claim 87, wherein a rate at which seed treatment is released from the seed treatment reservoir is based on a flow of seeds through the seed container.

93. The seed treatment system of claim 87, wherein the actuation mechanism comprises an electronic actuation mechanism.

94. The seed treatment system of claim 93, wherein the electronic actuation mechanism is activated in response to detecting a flow of seeds through the seed container.

95. The seed treatment system of claim 93, wherein the electronic actuation mechanism is activated in response to receiving a signal from a communication device or a controller.

96. The seed treatment system of claim 87, wherein the actuation mechanism comprises a manual actuation mechanism that causes the release of seed treatment from the seed treatment reservoir in response to a manual force applied to the manual actuation mechanism.

97. A seed treatment system, comprising:
a seed treatment reservoir configured to hold seed treatment;
a coupling mechanism configured to couple the seed treatment reservoir to a seed container;
an output channel through which seed treatment from the seed treatment reservoir is configured to flow; and
an actuation mechanism configured to actuate and release seed treatment from the seed treatment reservoir through the output channel and into the seed container.

98. The seed treatment system of claim 97, wherein the actuation mechanism is configured to actuate in response to seed flowing through the seed container.

99. The seed treatment system of claim 97, wherein the actuation mechanism is configured to actuate in response to pressure applied to the actuation mechanism by a flow of seed.

100. The seed treatment system of claim 97, wherein the actuation mechanism is located inside the seed container when the seed treatment reservoir is coupled to the seed container.

101. The seed treatment system of claim 97, wherein the actuation mechanism comprises a lever or lid configured to actuation in response to a flow of seed through the seed container and onto the lever or lid.

102. The seed treatment system of claim 97, wherein the actuation mechanism is configured to actuate without manual input from a user.

103. A seed treatment system, comprising:
a seed treatment housing including an output channel and a seed treatment chamber configured to receive a seed treatment container;
a spring mechanism located within the seed treatment housing; and
a manual actuation mechanism configured to, when actuated, apply a force that compresses the seed treatment container within the seed treatment chamber such that seed treatment is forced out of the seed treatment container and through the output channel of the seed treatment housing;
wherein the spring mechanism, when the manual actuation mechanism is actuated, applies a reciprocal force in a direction opposite a direction of the force applied by the manual actuation mechanism.

104. The seed treatment system of claim 103, wherein the manual actuation mechanism comprises a lever coupled to a top surface of the seed treatment housing that, when actuated, compresses downward and into the seed treatment container.

105. The seed treatment system of claim 104, wherein the seed treatment housing includes an opening in a top of a first side surface of the seed treatment housing opposite a second side surface of the seed treatment housing to which the manual actuation mechanism is coupled, the opening aligned with the manual actuation mechanism such that the manual actuation mechanism, when actuated, inserts into the opening.

106. The seed treatment system of claim 103, wherein the seed treatment container comprises a removable seed treatment pod with a first surface that, when the seed treatment pod is inserted into the seed treatment chamber, is configured to align with the output channel such that seed treatment from the seed treatment pod flows through the first surface and through the output channel.
